(19) United States
(12) Patent Application Publication
(10) Pub. No.: US 2014/0285407 A1
(43) Pub. Date: Sep. 25, 2014

(54) SYSTEM AND METHODS FOR EXTRACTION OF THRESHOLD AND MOBILITY PARAMETERS IN AMOLED DISPLAYS

(71) Applicant: Ignis Innovation Inc., Waterloo (CA)

(72) Inventors: Gholamreza Chaji, Waterloo (CA); Ricky Yik Hei Ngan, Richmond Hills (CA); Nino Zahirovic, Waterloo (CA); Yaser Azizi, Waterloo (CA); Arokia Nathan, Cambridge (GB); Peyman Servati, Vancouver (CA); Ali Ghadiri Bayekolaee, Kitchener (CA)

(73) Assignee: Ignis Innovation Inc., Waterloo (CA)

(21) Appl. No.: 14/261,755

(22) Filed: Apr. 25, 2014

Related U.S. Application Data
(63) Continuation-in-part of application No. 14/253,422, filed on Apr. 15, 2014.
Application No. 14/253,422 is a continuation-in-part of application No. 14/093,758, filed on Dec. 2, 2013.
Application No. 14/093,758 is a continuation-in-part of application No. 14/076,336, filed on Nov. 11, 2013.
Application No. 14/093,758 is a continuation-in-part of application No. 13/950,795, filed on Jul. 25, 2013.
Application No. 13/950,795 is a continuation of application No. 13/835,124, filed on Mar. 15, 2013, now Pat. No. 8,599,191.
Application No. 13/835,124 is a continuation-in-part of application No. 13/112,468, filed on May 20, 2011, now Pat. No. 8,576,217.
Application No. 13/112,468 is a continuation-in-part of application No. 14/175,493, filed on Feb. 7, 2014.
Application No. 14/175,493 is a continuation of application No. 14/157,031, filed on Jan. 16, 2014.
Application No. 14/157,031 is a continuation of application No. 13/568,784, filed on Aug. 7, 2012, now Pat. No. 8,736,524.
Application No. 13/568,784 is a continuation of application No. 12/571,968, filed on Oct. 1, 2009, now Pat. No. 8,259,044.
Application No. 12/571,968 is a continuation of application No. 11/304,162, filed on Dec. 15, 2005, now Pat. No. 7,619,597.
(60) Provisional application No. 61/869,327, filed on Aug. 23, 2013.
(60) Provisional application No. 61/859,963, filed on Jul. 30, 2013.

(30) Foreign Application Priority Data
Dec. 15, 2004 (CA) 2490860
Apr. 8, 2005 (CA) 2503237
Jun. 8, 2005 (CA) 2509201

(51) Int. Cl. G09G 3/32

(52) U.S. Cl. CPC G09G 3/3208
USPC 345/76

(57) ABSTRACT

A system extracts effective parameters from a pixel circuit that includes a light emitting device, a drive device to provide a programmable drive current to the light emitting device, a programming input, and a storage device to store a programming signal. The system measures the value of at least one operating parameter of the pixel circuit at a plurality of levels, and then extracts the value of at least one related parameter of the pixel circuit, based on the measured values of the at least one operating parameter. The measured values of the operating parameter are translated to effective values for driving the pixel circuit, based on the extracted value. Then effective parameters for driving effective devices in the pixel circuit are extracted, based on the translated values, and stored for use in compensating input signals to the pixel circuit.

### CROSS REFERENCE TO RELATED APPLICATIONS

This application is a continuation-in-part of U.S. patent application Ser. No. 14/253,422 [Attorney Docket No. 058161-000051USP4], which is a continuation-in-part of U.S. patent application Ser. No. 14/093,758, filed Dec. 2, 2013 [Attorney Docket No. 058161-000051USP2], which is a continuation-in-part of U.S. patent application Ser. No. 14/076,336, filed Nov. 11, 2013 [Attorney Docket No. 058161-000051USP3], which claims the benefit of U.S. Provisional Application No. 61/869,327, filed Aug. 23, 2013 [Attorney Docket No. 058161-000051PL02], and U.S. Provisional Application No. 61/859,963, filed Jul. 30, 2013 [Attorney Docket No. 058161-000051PL01]; U.S. patent application Ser. No. 14/093,758, filed Dec. 2, 2013 [Attorney Docket No. 058161-000051USP2] is a continuation-in-part of U.S. patent application Ser. No. 13/950,795, filed Jul. 25, 2013 [Attorney Docket No. 058161-000051USC1], which is a continuation of U.S. patent application Ser. No. 13/835,124, filed Mar. 15, 2013, now issued as U.S. Pat. No. 8,599,191 [Attorney Docket No. 058161-000051USP1], which is a continuation-in-part of U.S. patent application Ser. No. 13/112,468, filed May 20, 2011, now issued as U.S. Pat. No. 8,576,217 [Attorney Docket No. 058161-000051USPT], each of which is hereby incorporated by reference herein in their entirety.

This application is also a continuation-in-part of U.S. patent application Ser. No. 14/175,493, filed Feb. 7, 2014 [Attorney Docket No. 058161-000009USC4], which is a continuation of U.S. patent application Ser. No. 14/157,031, filed Jan. 16, 2014 [Attorney Docket No. 058161-9USC3], which is a continuation of U.S. patent application Ser. No. 13/568,784, filed Aug. 7, 2012, now allowed [Attorney Docket No. 058161-9USC2], which is a continuation of U.S. patent application Ser. No. 12/571,968, filed Oct. 1, 2009, now issued as U.S. Pat. No. 8,259,044 [Attorney Docket No. 058161-9USC1], which is a continuation of U.S. patent application Ser. No. 11/304,162, filed Dec. 15, 2005, now issued as U.S. Pat. No. 7,619,597 [Attorney Docket No. 058161-9USPT], which claims priority pursuant to 35 U.S.C. §119 to (1) Canadian Patent No. 2,490,860, filed Dec. 15, 2004, and to (2) Canadian Patent No. 2,503,237, filed Apr. 8, 2005, and to (3) Canadian Patent No. 2,509,201, filed Jun. 8, 2005, and to (4) Canadian Patent No. 2,521,986, filed Oct. 17, 2005, all of which are incorporated herein by reference in their respective entireties.

### FIELD OF INVENTION

The present invention relates generally to a method and system for programming, calibrating and driving a light emitting device display. In certain embodiments, the invention relates to active matrix organic light emitting device (AMOLED) displays, and particularly extracting parameters of the pixel circuits and light emitting devices in such displays.

### BACKGROUND

The advantages of active matrix organic light emitting device (“AMOLED”) displays include lower power consumption, manufacturing flexibility and faster refresh rate over conventional liquid crystal displays. In contrast to conventional liquid crystal displays, there is no backlighting in an AMOLED display, and thus each pixel consists of different colored OLEDs emitting light independently. The OLEDs emit light based on current supplied through drive transistors controlled by programming voltages. The power consumed in each pixel has a relation with the magnitude of the generated light in that pixel.

The quality of output in an OLED-based pixel is affected by the properties of the drive transistor, which is typically fabricated from materials including but not limited to amorphous silicon, polysilicon, or metal oxide, as well as the OLED itself. In particular, threshold voltage and mobility of the drive transistor tend to change as the pixel ages. In order to maintain image quality, changes in these parameters must be compensated for by adjusting the programming voltage. In order to do so, such parameters must be extracted from the driver circuit. The addition of components to extract such parameters in a simple driver circuit requires more space on a display substrate for the drive circuitry and thereby reduces the amount of aperture or area of light emission from the OLED.

When biased in saturation, the I-V characteristic of a thin film drive transistor depends on mobility and threshold voltage which are a function of the materials used to fabricate the transistor. Thus different thin film transistor devices implemented across the display panel may demonstrate non-uniform behavior due to aging and process variations in mobility and threshold voltage. Accordingly, for a constant voltage, each device may have a different drain current. An extreme example may be where one device could have low threshold-voltage and low mobility compared to a second device with high threshold-voltage and high mobility.

Thus with very few electronic components available to maintain a desired aperture, extraction of non-uniformity parameters (i.e. threshold voltage, Vₜₕ, and mobility, u) of the drive TFT and the OLED becomes challenging. It would be desirable to extract such parameters in a driver circuit for an OLED pixel with as few components as possible to maximize pixel aperture.

### SUMMARY

In accordance with one embodiment, a system and method are provided for extracting effective parameters from a pixel circuit that includes a light emitting device, a drive device to provide a programmable drive current to the light emitting device, a programming input, and a storage device to store a programming signal. The system measures the value of at least one operating parameter of the pixel circuit at a plurality of levels, and then extracts the value of at least one related parameter of the pixel circuit, based on the measured values of the at least one operating parameter. The measured values of the operating parameter are translated to effective values for driving the pixel circuit, based on the extracted value. Then effective parameters for driving effective devices in the pixel circuit are extracted, based on the translated values, and stored for use in compensating input signals to the pixel circuit.

Other aspects and features of the present invention will be readily apparent to those skilled in the art from a review of the following detailed description of preferred embodiments in conjunction with the accompanying drawings.

### BRIEF DESCRIPTION OF THE DRAWINGS

These and other features of the invention will become more apparent from the following description in which reference is made to the appended drawings wherein:

FIG. 1 is a flow chart showing a process for calibration-scheduling in accordance with an embodiment of the present invention;

FIG. 2 is a diagram showing an example of a system structure for implementing the calibration-scheduling of FIG. 1;

FIG. 3 is a diagram showing a system architecture for a voltage-extracting, programming and driving in accordance with an embodiment of the present invention;

FIG. 4 is a diagram showing an example of the extracting, programming and driving system of FIG. 3 and a pixel circuit;

FIG. 5 is a diagram showing a further example of the extracting, programming and driving system of FIG. 3 and a pixel circuit;

FIG. 6 is a diagram showing a further example of the extracting, programming and driving system of FIG. 3 and a pixel circuit;

FIG. 7 is a diagram showing a further example of the extracting, programming and driving system of FIG. 3 and a pixel circuit;

FIG. 8 is a diagram showing a pixel circuit to which a step-calibration driving in accordance with an embodiment of the present invention is applied;

FIG. 9 is a diagram showing an example of a driver and extraction block and the driving transistor of FIG. 8;

FIG. 10 is a diagram showing an example of an extraction algorithm implemented by a DPU block of FIG. 9;

FIG. 11 is a diagram showing a further example of the extraction algorithm implemented by the DPU block of FIG. 9;

FIG. 12 is a timing diagram showing an example of waveforms for the step-calibration driving;

FIG. 13 is a timing diagram showing a further example of waveforms for the step-calibration driving;

FIG. 14 is a diagram showing a pixel circuit to which the step-calibration driving is applicable;

FIG. 15 is a graph showing the results of simulation for the step-calibration driving;

FIG. 16 is a diagram showing an example of a system architecture for the step-calibration driving with a display array;

FIG. 17 is a timing diagram showing an example of waveforms applied to the system architecture of FIG. 16;

FIG. 18 is a timing diagram showing an example of waveforms for a voltage/current extraction;

FIG. 19 is a timing diagram showing a further example of waveforms for the voltage/current extraction;

FIG. 20 is a diagram showing a pixel circuit to which the voltage/current extraction of FIG. 19 is applicable;

FIG. 21 is a timing diagram showing a further example of waveforms for the voltage/current extraction;

FIG. 22 is a diagram showing a pixel circuit to which the voltage/current extraction of FIG. 21 is applicable;

FIG. 23 is a diagram showing a mirror based pixel circuit to which OLED removing in accordance with an embodiment of the present invention is applied;

FIG. 24 is a diagram showing a programming path of FIG. 23 when applying the OLED removing;

FIG. 25 is a diagram showing an example of a system architecture for the OLED removing; and

FIG. 26 is a graph showing the simulation result for the voltage on IDATA line for different threshold voltage.

FIG. 27 is a block diagram of an AMOLED display with compensation control;

FIG. 28 is a circuit diagram of a data extraction circuit for a two-transistor pixel in the AMOLED display in FIG. 27;

FIG. 29A is a signal timing diagram of the signals to the data extraction circuit to extract the threshold voltage and mobility of an n-type drive transistor in FIG. 28;

FIG. 29B is a signal timing diagram of the signals to the data extraction circuit to extract the characteristic voltage of the OLED in FIG. 28 with an n-type drive transistor;

FIG. 29C is a signal timing diagram of the signals to the data extraction circuit for a direct read to extract the threshold voltage of an n-type drive transistor in FIG. 28;

FIG. 30A is a signal timing diagram of the signals to the data extraction circuit to extract the threshold voltage and mobility of a p-type drive transistor in FIG. 28;

FIG. 30B is a signal timing diagram of the signals to the data extraction circuit to extract the characteristic voltage of the OLED in FIG. 28 with a p-type drive transistor;

FIG. 30C is a signal timing diagram of the signals to the data extraction circuit for a direct read to extract the threshold voltage of a p-type drive transistor in FIG. 28;

FIG. 30D is a signal timing diagram of the signals to the data extraction circuit for a direct read of the OLED turn-on voltage using either an n-type or p-type drive transistor in FIG. 28.

FIG. 31 is a circuit diagram of a data extraction circuit for a three-transistor drive circuit for a pixel in the AMOLED display in FIG. 27 for extraction of parameters;

FIG. 32A is a signal timing diagram of the signals to the data extraction circuit to extract the threshold voltage and mobility of the drive transistor in FIG. 31;

FIG. 32B is a signal timing diagram of the signals to the data extraction circuit to extract the characteristic voltage of the OLED in FIG. 31;

FIG. 32C is a signal timing diagram of the signals to the data extraction circuit for a direct read to extract the threshold voltage of the drive transistor in FIG. 31;

FIG. 32D is a signal timing diagram of the signals to the data extraction circuit for a direct read to extract the characteristic voltage of the OLED in FIG. 31;

FIG. 33 is a flow diagram of the extraction cycle to readout the characteristics of the drive transistor and the OLED of a pixel circuit in an AMOLED display;

FIG. 34 is a flow diagram of different parameter extraction cycles and final applications; and

FIG. 35 is a block diagram and chart of the components of a data extraction system.

FIG. 36 is a signal timing diagram of the signals to the data extraction circuit to extract the threshold voltage and mobility of the drive transistor in a modified version of the circuit in FIG. 31;

FIG. 37 is a signal timing diagram of the signals to the data extraction circuit to extract the characteristic voltage of the OLED in a modified version of the circuit in FIG. 5;

FIG. 38 is a circuit diagram of a data extraction circuit for reading the pixel charge from a drive circuit for a pixel in the AMOLED display in FIG. 27.

FIG. 39 is a signal timing diagram of the signals to the data extraction circuit of FIG. 38 for reading pixel status by initializing the nodes externally;

FIG. 40 is a flow diagram for reading the pixel status in the circuit of FIG. 38 by initializing the nodes externally;

FIG. 41 is a signal timing diagram of the signals to the data extraction circuit of FIG. 38 for reading pixel status by initializing the nodes internally;

FIG. 42 is a flow diagram for reading the pixel status in the circuit of FIG. 38 by initializing the nodes internally;

FIG. 43 is a circuit diagram of a pair of circuits like the circuit of FIG. 38 used with a common monitor line for reading the pixel charge from two different pixels in the AMOLED display in FIG. 27;

FIG. 44 is a signal timing diagram of the signals to the data extraction circuit of FIG. 17 for reading pixel charge when the monitor line is shared; and

FIG. 45 is a flow diagram for reading the pixel status of a pair of circuits like the circuit of FIG. 43, with a common monitor line.

FIG. 46A is a schematic circuit diagram of a modified pixel circuit.

FIG. 46B is a timing diagram illustrating the operation of the pixel circuit of FIG. 46A with charge-based compensation.

FIG. 47 is a timing diagram illustrating operation of the pixel circuit of FIG. 46A to obtain a readout of a parameter of the drive transistor.

FIG. 48 is a timing diagram illustrating operation of the pixel circuit of FIG. 46A to obtain a readout of a parameter of the OLED.

FIG. 49 is a timing diagram illustrating a modified operation of the pixel circuit of FIG. 46A to obtain a readout of a parameter of the OLED.

FIG. 50 is a diagrammatic illustration of a pixel circuit with current measurement capability.

FIG. 51 is a schematic circuit diagram of a pixel circuit that provides access to an internal node.

FIG. 52 is a diagrammatic illustration of an OLED display pixel circuit with charge readout capability.

FIG. 53 is a schematic diagram of an n-type 3T1C pixel circuit.

FIG. 54 is a flow chart of a pixel modeling procedure.

FIG. 55 is a pair of simulated curves of Iₘₒₙ and I_{oled} along with a curve fitted for Iₘₒₙ.

FIG. 56 is a pair of simulated and estimated OLED current curves.

### DETAILED DESCRIPTION OF THE PREFERRED EMBODIMENTS

Embodiments of the present invention are described using a pixel including a light emitting device and a plurality of transistors. The light emitting device may be an organic light emitting diode (OLED). It is noted that “pixel” and “pixel circuit” may be used interchangeably.

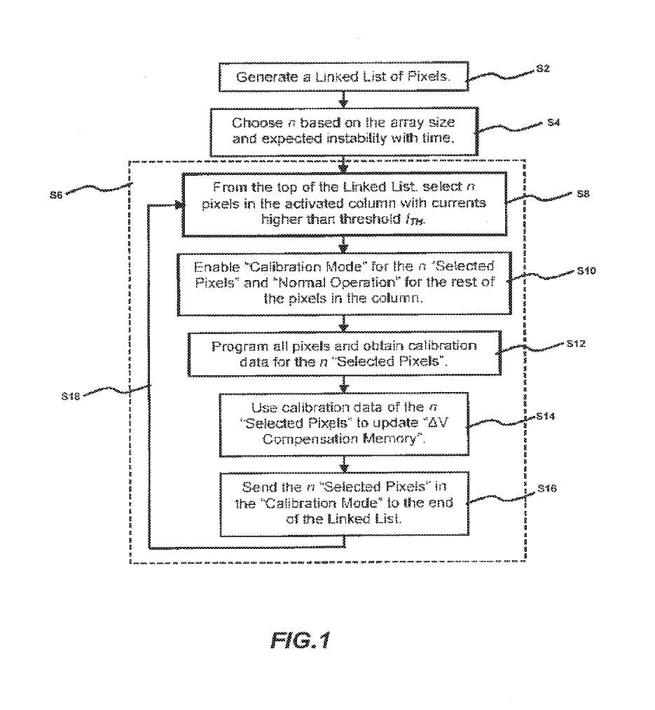

Real-time calibration-scheduling for a display array having a plurality of pixels is described in detail. FIG. 1 illustrates a process for a calibration-scheduling in accordance with an embodiment of the present invention. According to this technique, the pixels are calibrated based on their aging and/or usage during the normal operation of the display array.

A linked list of pixels is generated in step S2. The linked list contains an identification of a pixel with high brightness for calibration. The linked list is used to schedule the priority in calibration.

In step S4, “n” is chosen based on the display size and expected instability with time (e.g. shift in characteristics of transistors and light emitting device). “n” represents the number of pixels that are calibrated in each programming cycle. “n” may be one or more than one.

Then programming cycle starts at step S6. The step S6 includes steps S8-S16. The steps S8-S16 are implemented on a selected column of the display array.

In step S8, “n” pixels in the selected column are selected from the beginning of the linked list, hereinafter referred to as “Selected Pixels”.

In step S10, “Calibration Mode” is enabled for the Selected Pixels, and “Normal Operation Mode” is enabled for the rest of the pixels in the selected column of the display array.

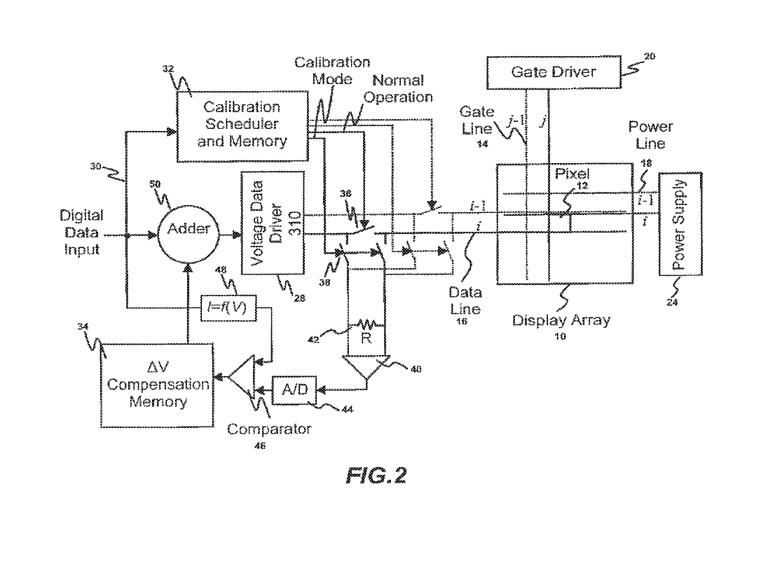

In step S12, all pixels in the selected column are programmed by a voltage source driver (e.g. 28 of FIG. 2) which is connected to a data line of the pixel.

For the Selected Pixels, current flowing through the data line is monitored during the programming cycle. For the pixels other than the Selected Pixels in the selected column, the corresponding programming voltage is boosted using data stored in a memory (e.g. 34 of FIG. 2), hereinafter referred to as “ΔV compensation memory”.

In step S14, the monitored current is compared with the expected current that must flow through the data line. Then, a calibration data curve for the Selected Pixels is generated. The ΔV compensation memory is updated based on the calibration data curve.

The calibration data curve stored in the ΔV compensation memory for a pixel will be used to boost programming voltage for that pixel in the next programming cycles when that pixel is in the Normal Operation Mode.

In step S16, the identifications of the Selected Pixels are sent to the end of the linked list. The Selected Pixels have the lowest priority in the linked list for calibration.

During display operation (S6-S16), the linked list will provide a sorted priority list of pixels that must be calibrated. It is noted that in the description, the term “linked list” and the term “priority list” may be used interchangeably.

The operation goes back (S18) to the step S8. The next programming cycle starts. A new column in the display array is activated (selected), and, new “n” pixels in the new activated column are selected from the top of the linked list. The ΔV compensation memory is updated using the calibration data obtained for the new Selected Pixels.

The number of the Selected Pixels, “n”, is now described in detail. As described above, the number “n” is determined based on the display size and expected instability in device characteristics with time. It is assumed that the total number of pixels N is N=3xm₁xm₂, where m1 and m2 are the number of rows and columns in the display, respectively.

The highest rate in characteristics shift is K (=ΔI·Δt·I). Each programming cycle takes t=1/f·m₂. The maximum expected shift in characteristics after the entire display is calibrated is ΔI/I=K·t·N/n<e, where e is the allowed error. After this the calibration can be redone from the beginning, and the error is eliminated. This shows that n>K·t·N/e or n>3·K·m₁/f·e. For instance, if K=1%/hr, m₁=1024, f=60 Hz, and e=0.1%, then n>0.14, which implies that it is needed to calibrate once in 5 programming cycles. This is achievable with one calibration unit, which operates only one time in 5 programming cycles. Each calibration unit enables calibration of one pixel at a programming cycle. If e=0.01%, n>1.4. This means that two calibration units calibrating two pixels in each programming cycle are required. This shows that it is feasible to implement this calibration system with very low cost.

The frequency of calibration can be reduced automatically as the display ages, since shifts in characteristics will become slower as the time progresses. In addition, the pixels that are selected for calibration can be programmed with different currents depending on display data. The only condition is that their programming current is larger than a reference current. Therefore, the calibration can be performed at multiple brightness levels for one pixel to achieve higher accuracy.

The linked list is described in detail. In the linked list, the pixels with high brightness for calibration are listed. The display data is used to determine the pixels with high brightness for calibration. Calibration at low currents is slow and often not accurate. In addition, maximum shift in characteristics occurs for pixels with high current. Thus, in order to improve the accuracy and speed of calibration, the pixels, which must be programmed with currents higher than a threshold current I_{TH}, are selected and stored in the linked list.

I_{TH} is a variable and may be “0”. For I_{TH}=0, all pixels are listed in the linked list, and the calibration is performed for all pixels irrespective of their programming current.

The calibration-scheduling technique described above is applicable to any current programmed pixels, for example, but not limited to, a current mirror based pixel.

FIG. 2 illustrates an example of a system structure for implementing the calibration-scheduling of FIG. 1. A system 30 of FIG. 2 for implementing calibration-scheduling algorithm is provided to a display array 10 having a plurality of pixel circuits 12. The pixel circuit 12 is a current programmed pixel circuit, such as, but not limited to a current mirror based pixel. The pixel circuits 12 are arranged in row and column.

The pixel circuit 12 may include an OLED and a plurality of transistors (e.g. TFTs). The transistor may be fabricated using amorphous silicon, nano/micro crystalline silicon, poly silicon, organic semiconductors technologies (e.g. organic TFT), NMOS/PMOS technology or CMOS technology (e.g. MOSFET). The display array 10 may be an AMOLED display array.

The pixel circuit 12 is operated by a gate line 14 connected to a gate driver 20, a data line 16 connected to a voltage data driver 28, and a power line connected to a power supply 24. In FIG. 2, two data lines, two gate lines and two power lines are shown as an example. It is apparent that more than two data lines, two gate lines and two power lines may be provided to the display array 10.

The system 30 includes a calibration scheduler and memory block 32 for controlling programming and calibration of the display array 10, and a ΔV compensation memory 34 for storing ΔV compensation voltage (value). In each programming cycle, a column of the display array 10 is selected. The calibration scheduler and memory block 32 enables Normal Operation Mode or Calibration Mode for the selected column (i.e., data line) during that programming cycle.

The system 30 further includes a monitoring system for monitoring and measuring a pixel current. The monitoring system includes switches 36 and 38 and a voltage sensor 40 with an accurate resistor 42. In FIG. 2, the switches 36 and 38 are provided for each data line as an example.

The system 30 further includes a generator for generating ΔV compensation voltage based on the monitoring result. The generator includes an analog/digital converter (A/D) 44, a comparator 46, and a translator 48. The A/D 44 converts the analog output of the voltage sensor 40 into a digital output. The comparator 46 compares the digital output to an output from the translator 48. The translator 48 implements function f(V) on a digital data input 52. The translator 48 converts the current data input 52 to the voltage data input through f(v). The result of the comparison by the comparator 46 is stored in the ΔV compensation memory 34.

The system 30 further includes an adder 50 for adding the digital data input 52 and the ΔV compensation voltage stored in the ΔV compensation memory 34. The voltage data driver 28 drives a data line based on the output of the adder 50. The programming data for the data line is adjusted by adding the ΔV compensation voltage.

When the calibration scheduler and memory block 32 enables the Normal Operation Mode for a selected data line, the switch 36 is activated. The voltage output from the voltage data driver 28 is directly applied to the pixel on that data line.

When the calibration scheduler and memory block 32 enables the Calibration Mode for that data line, the switch 38 is activated. The voltage is applied to the pixel on that data line through the accurate resistor 42. The voltage drop across the resistor 42 at the final stages of the programming time (i.e. when initial transients are finished) is measured by the voltage sensor 40. The voltage drop monitored by the voltage sensor 40 is converted to digital data by the A/D 44. The resulting value of the voltage drop is proportional to the current flowing through the pixel if the pixel is a current programmed pixel circuit. This value is compared by the comparator 46 to the expected value obtained by the translator 48.

The difference between the expected value and the measured value is stored in the AV compensation memory 34, and will be used for a subsequent programming cycle. The difference will be used to adjust the data voltage for programming of that pixel in future.

The calibration scheduler and memory block 32 may include the linked list described above. In the beginning, the linked list is generated automatically. It may be just a list of pixels. However, during the operation it is modified.

The calibration of the pixel circuits with high brightness guarantees the high speed and accurate calibration that is needed in large or small area displays.

Since the display array 10 is driven using a voltage programming technique, it is fast and can be used for high-resolution and large area displays.

Due to speed, accuracy, and ease of implementation, the applications of the calibration-scheduling technique ranges from electroluminescent devices used for cellphones, personal organizers, monitors, TVs, to large area display boards.

The system 30 monitors and measures voltage drop which depends on time dependent parameters of the pixel, and generates a desirable programming data. However, the time dependent parameters of the pixel may be extracted by any mechanisms other than that of FIG. 2.

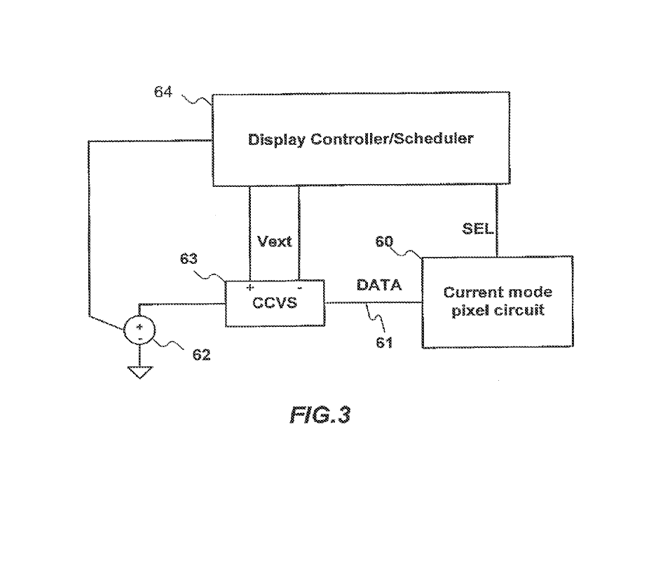

A further technique for programming, extracting time dependent parameters of a pixel and driving the pixel is described in detail with reference to FIGS. 3-7. This technique includes voltage-extracting for calibration. Programming data is calibrated with the extracted information, resulting in a stable pixel current over time. Using this technique, the aging of the pixel is extracted.

FIG. 3 illustrates a system architecture for implementing a voltage-extracting, programming and driving in accordance with an embodiment of the present invention. The system of FIG. 3 implements the voltage-extracting and programming to a current mode pixel circuit 60. The pixel circuit 60 includes a light emitting device and a plurality of transistors having a driving transistor (not shown). The transistors may be TFTs.

The pixel circuit 60 is selected by a select line SEL and is driven by DATA on a data line 61. A voltage source 62 is provided to write a programming voltage V_{P} into the pixel circuit 60. A current-controlled voltage source (CCVS) 63 having a positive node and a negative node is provided to convert the current on the data line 61 to a voltage Vext. A display controller and scheduler 64 operates the pixel circuit 60. The display controller and scheduler 64 monitors an extracted voltage Vext output from the CCVS 63 and then controls the voltage source 62.

The resistance of CCVS 63 is negligible. Thus the current on the data line 61 is written as:

I_{Line}=Iₚᵢₓₑₗ=β(V_{P}−V_{T})² (1)

where I_{Line} represents the current on the data line 61, Iₚᵢₓₑₗ represents a pixel current, V_{T} represents the threshold voltage of the driving transistor included in the pixel circuit 60, and β represents the gain parameter in the TFT characteristics.

As the threshold voltage of the driving TFT increases during the time, the current on the data line 61 decreases. By monitoring the extracted voltage Vext, the display controller and scheduler 64 determines the amount of shift in the threshold voltage.

The threshold voltage VT of the driving transistor can be calculate as:

V_{T}=V_{P}−(I_{Line}/β)^{0.5} (2)

The programming voltage V_{P} is modified with the extracted information. The extraction procedure can be implemented for one or several pixels during each frame time.

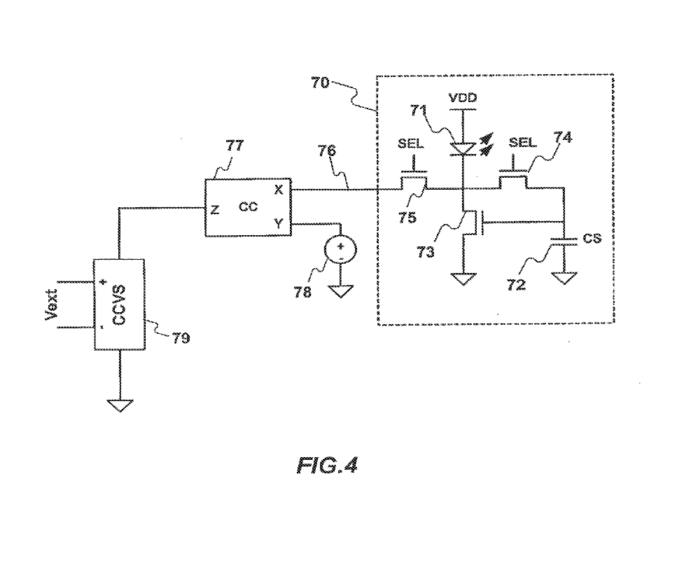

FIG. 4 illustrates an example of a system for the voltage-extracting, programming and driving of FIG. 3, which is employed with a top-emission current-cell pixel circuit 70. The pixel circuit 70 includes an OLED 71, a storage capacitor 72, a driving transistor 73 and switch transistors 74 and 75.

The transistors 73, 74 and 75 may be n-type TFTs. However, these transistors 73, 74 and 75 may be p-type transistors. The voltage-extracting and programming technique applied to the pixel circuit 70 is also applicable to a pixel circuit having p-type transistors.

The driving transistor 73 is connected to a data line 76 through the switch transistor 75, and is connected to the OLED 71, and also is connected to the storage capacitor 72 through the switch transistor 74. The gate terminal of the driving transistor 73 is connected to the storage capacitor 72. The gate terminals of the switch transistors 74 and 75 are connected to a select line SEL. The OLED 71 is connected to a voltage supply electrode or line _{VD}D. The pixel circuit 70 is selected by the select line SEL and is driven by DATA on the data line 76.

A current conveyor (CC) 77 has X, Y and Z terminals, and is used to extract a current on the data line 76 without loading it. A voltage source 78 applies programming voltage to the Y terminal of the CC 77. In the CC 77, the X terminal is forced by feedback to have the same voltage as that of the Y terminal. Also, the current on the X terminal is duplicated into the Z terminal of the CC 77. A current-controlled voltage source (CCVS) 79 has a positive node and a negative node. The CCVS 79 converts the current on the Z terminal of the CC 77 into a voltage Vext.

Vext is provided to the display controller and scheduler 64 of FIG. 3, where the threshold voltage of the driving transistor 73 is extracted. The display controller and scheduler 64 controls the voltage source 78 based on the extracted threshold voltage.

FIG. 5 illustrates a further example of a system for the voltage-extracting, programming, and driving of FIG. 3, which is employed with a bottom-emission current-cell pixel circuit 80. The pixel circuit 80 includes an OLED 81, a storage capacitor 82, a driving transistor 83, and switch transistors 84 and 85. The transistors 83, 84 and 85 may be n-type TFTs. However, these transistors 83, 84 and 85 may be p-type transistors.

The driving transistor 83 is connected to a data line 86 through the switch transistor 85, and is connected to the OLED 81, and also is connected to the storage capacitor 82. The gate terminal of the driving transistor 83 is connected to a voltage supply line VDD through the switch transistor 84. The gate terminals of the switch transistors 84 and 85 are connected to a select line SEL. The pixel circuit 80 is selected by the select line SEL and is driven by DATA on the data line 86.

A current conveyor (CC) 87 has X, Y and Z terminals, and is used to extract a current on the data line 86 without loading it. A voltage source 88 applies a negative programming voltage at the Y terminal of the CC 87. In the CC 87, the X terminal is forced by feedback to have the same voltage as that of the Y terminal. Also, the current on the X terminal is duplicated into the Z terminal of the CC 87. A current-controlled voltage source (CCVS) 89 has a positive node and a negative node. The CCVS 89 converts the current of the Z terminal of the CC 87 into a voltage Vext.

Vext is provided to the display controller and scheduler 64 of FIG. 3, where the threshold voltage of the driving transistor 83 is extracted. The display controller and scheduler 64 controls the voltage source 88 based on the extracted threshold voltage.

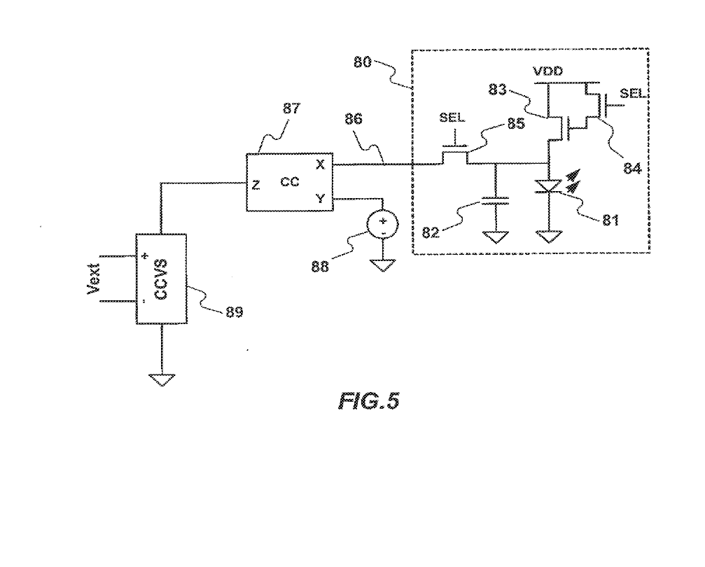

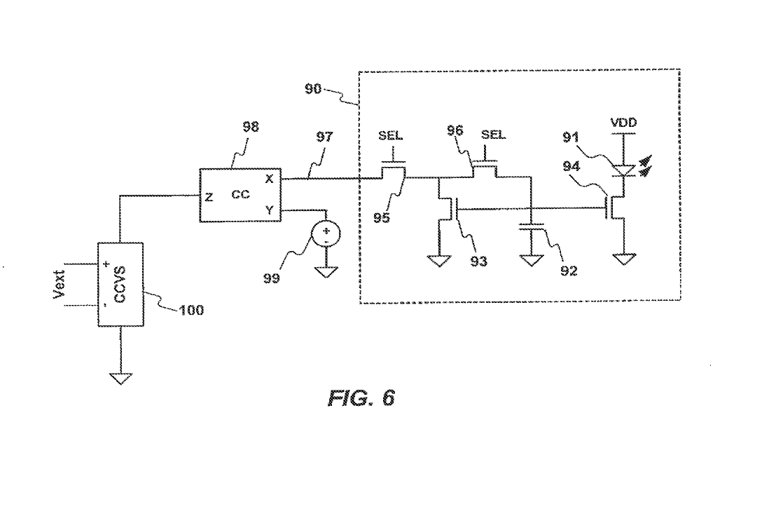

FIG. 6 illustrates a further example of a system for the voltage-extracting, programming and driving of FIG. 3, which is employed with a top-emission current-mirror pixel circuit 90. The pixel circuit 90 includes an OLED 91, a storage capacitor 92, mirror transistors 93 and 94, and switch transistors 95 and 96. The transistors 93, 94, 95 and 96 may be n-type TFTs. However, these transistors 93, 94, 95 and 96 may be p-type transistors.

The mirror transistor 93 is connected to a data line 97 through the switch transistor 95, and is connected to the storage capacitor 92 through the switch transistor 96. The gate terminals of the mirror transistors 93 and 94 are connected to the storage capacitor 92 and the switch transistor 96. The mirror transistor 94 is connected to a voltage supply electrode or line VDD through the OLED 91. The gate terminals of the switch transistors 85 and 86 are connected to a select line SEL. The pixel circuit 90 is selected by the select line SEL and is driven by DATA on the data line 97.

A current conveyor (CC) 98 has X, Y and Z terminals, and is used to extract the current of the data line 97 without loading it. A voltage source 99 applies a positive programming voltage at the Y terminal of the CC 98. In the CC 98, the X terminal is forced by feedback to have the same voltage as the voltage of the Y terminal. Also, the current on the X terminal is duplicated into the Z terminal of the CC 98. A current-controlled voltage source (CCVS) 100 has a positive node and a negative node. The CCVS 100 converts a current on the Z terminal of the CC 98 into a voltage Vext.

Vext is provided to the display controller and scheduler 64 of FIG. 3, where the threshold voltage of the driving transistor 93 is extracted. The display controller and scheduler 64 controls the voltage source 99 based on the extracted threshold voltage.

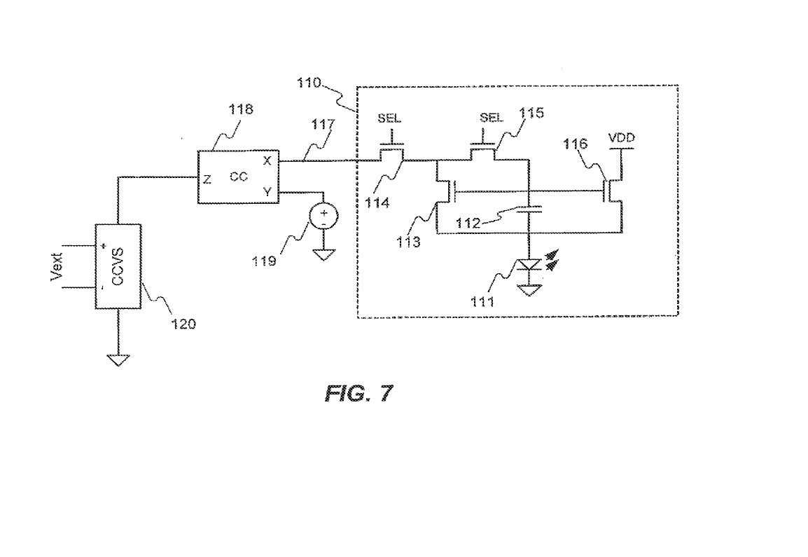

FIG. 7 illustrates a further example of a system for the voltage-extracting, programming and driving of FIG. 3, which is employed with a bottom-emission current-minor pixel circuit 110. The pixel circuit 110 includes an OLED 111, a storage capacitor 112, mirror transistors 113 and 116, and switch transistors 114 and 115. The transistors 113, 114, 115 and 116 may be n-type TFTs. However, these transistors 113, 114, 115 and 116 may be p-type transistors.

The mirror transistor 113 is connected to a data line 117 through the switch transistor 114, and is connected to the storage capacitor 112 through the switch transistor 115. The gate terminals of the mirror transistors 113 and 116 are connected to the storage capacitor 112 and the switch transistor 115. The minor transistor 116 is connected to a voltage supply line VDD. The mirror transistors 113, 116 and the storage capacitor 112 are connected to the OLED 111. The gate terminals of the switch transistors 114 and 115 are connected to a select line SEL. The pixel circuit 110 is selected by the select line SEL and is driven by DATA on the data line 117.

A current conveyor (CC) 118 has X, Y and Z terminals, and is used to extract the current of the data line 117 without loading it. A voltage source 119 applies a positive programming voltage at the Y terminal of the CC 118. In the CC 118, the X terminal is forced by feedback to have the same voltage as the voltage of the Y terminal of the CC 118. Also, the current on the X terminal is duplicated into the Z terminal of the CC 118. A current-controlled voltage source (CCVS) 120 has a positive node and a negative node. The 120 converts the current on the Z terminal of the CC 118 into a voltage Vext.

Vext is provided to the display controller and scheduler 64 of FIG. 3, where the threshold voltage of the driving transistor 113 is extracted. The display controller and scheduler 64 controls the voltage source 119 based on the extracted threshold voltage.

Referring to FIGS. 3-7, using the voltage-extracting technique, time dependent parameters of a pixel (e.g. threshold shift) can be extracted. Thus, the programming voltage can be calibrated with the extracted information, resulting in a stable pixel current over time. Since the voltage of the OLED (i.e. 71 of FIG. 4, 81 of FIG. 5, 91 of FIG. 6, 111 of FIG. 7) affects the current directly, the voltage-extracting driving technique described above can also be used to extract OLED degradation as well as the threshold shift.

The voltage-extracting technique described above can be used with any current-mode pixel circuit, including current-mirror and current-cell pixel circuit architectures, and are applicable to the display array 10 of FIG. 2. A stable current independent of pixel aging under prolonged display operation can be provided using the extracted information. Thus, the display operating lifetime is efficiently improved.

It is noted that the transistors in the pixel circuits of FIGS. 3-7 may be fabricated using amorphous silicon, nano/micro crystalline silicon, poly silicon, organic semiconductors technologies (e.g. organic TFT), NMOS/PMOS technology or CMOS technology (e.g. MOSFET). The pixel circuits of FIGS. 3-7 may form AMOLED display arrays.

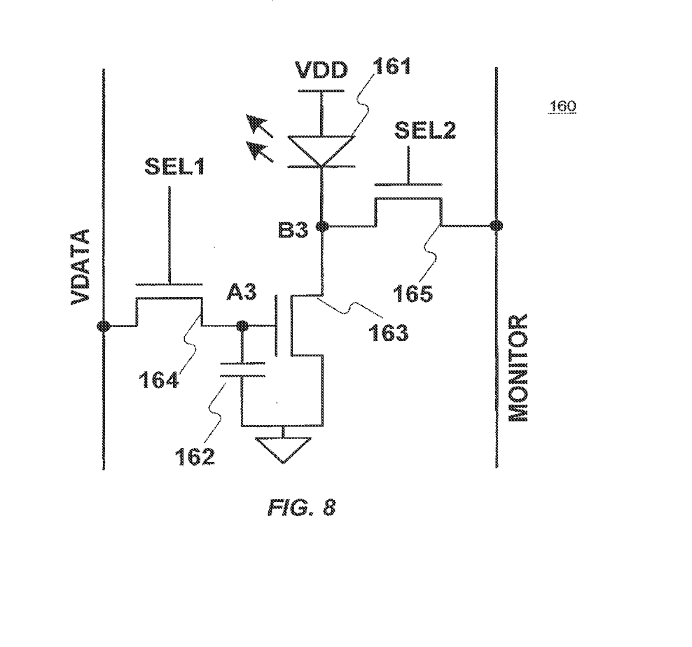

A further technique for programming, extracting time dependent parameters of a pixel and driving the pixel is described in detail with reference to FIGS. 8-17. The technique includes a step-calibration driving technique. In the step-calibration driving technique, information on the aging of a pixel (e.g. threshold shift) is extracted. The extracted information will be used to generate a stable pixel current/luminance. Despite using the one-bit extraction technique, the resolution of the extracted aging is defined by display drivers. Also, the dynamic effects are compensated since the pixel aging is extracted under operating condition, which is similar to the driving cycle.

FIG. 8 illustrates a pixel circuit 160 to which a step-calibration driving in accordance with an embodiment of the present invention is applied. The pixel circuit 160 includes an OLED 161, a storage capacitor 162, and a driving transistor 163 and switch transistors 164 and 165. The pixel circuit 160 is a current-programmed, 3-TFT pixel circuit. A plurality of the pixel circuits 160 may form an AMOLED display.

The transistors 163, 164 and 165 are n-type TFTs. However, the transistors 163, 164 and 165 may be p-type TFTs. The step-calibration driving technique applied to the pixel circuit 160 is also applicable to a pixel circuit having p-type transistors. The transistors 163, 164 and 165 may be fabricated using amorphous silicon, nano/micro crystalline silicon, poly silicon, organic semiconductors technologies (e.g. organic TFT), NMOS/PMOS technology or CMOS technology (e.g. MOSFET).

The gate terminal of the driving transistor 163 is connected to a signal line VDATA through the switch transistor 164, and also connected to the storage capacitor 162. The source terminal of the driving transistor 163 is connected to a common ground. The drain terminal of the driving transistor 163 is connected to a monitor line MONITOR through the switch transistor 165, and also is connected to the cathode electrode of the OLED 161.

The gate terminal of the switch transistor 164 is connected to a select line SELL. The source terminal of the switch transistor 164 is connected to the gate terminal of the driving transistor 163, and is connected to the storage capacitor 162. The drain terminal of the switch transistor 164 is connected to VDATA.

The gate terminal of the switch transistor 165 is connected to a select line SEL2. The source terminal of the switch transistor 165 is connected to MONITOR. The drain terminal of the switch transistor 165 is connected to the drain terminal of the driving transistor 163 and the cathode electrode of the OLED 161. The anode electrode of the OLED 161 is connected to a voltage supply electrode or line VDD.

The transistors 163 and 164 and the storage capacitor 162 are connected at node A3. The transistors 163 and 165 and the OLED 161 are connected at node B3.

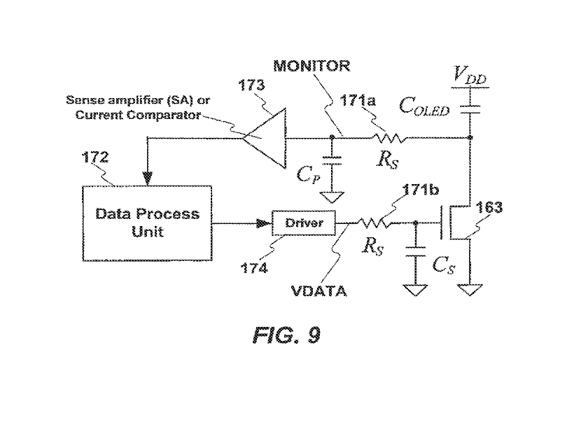

FIG. 9 illustrates an example of a driver and extraction block 170 along with the driving transistor 163 of FIG. 8. In FIG. 9, each of Rs 171a and Rs 171b represents the ON resistance of the switch transistors (e.g. 164, 165 of FIG. 8). Cs represents the storage capacitor of the pixel, C_{OLED} represents the OLED capacitance, and CP represents the line parasitic capacitance. In FIG. 9, the OLED is presented as a capacitance.

A block 173 is used to extract the threshold voltage of the driving transistor, during the extraction cycle. The block 173 may be a current sense amplifier (SA) or a current comparator. In the description, the block 173 is referred to as “SA block 173”.

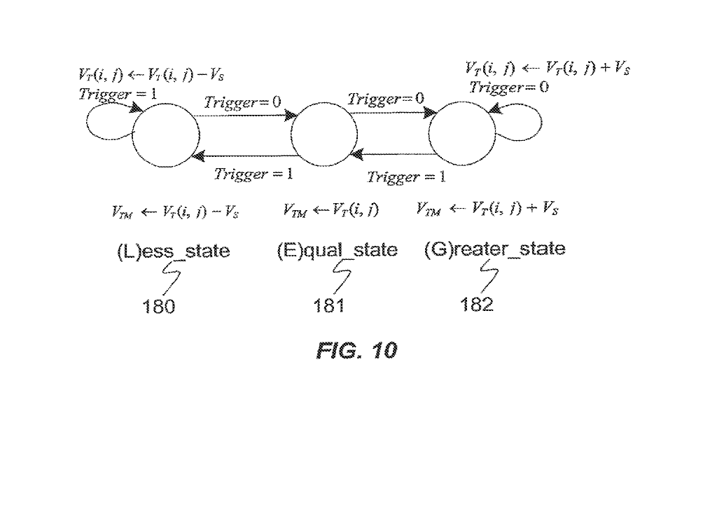

If the current of the MONITOR line is higher than a reference current (IREF), the output of the SA block 173 (i.e. Triggers of FIG. 10, 11) becomes one. If the current of the MONITOR line is less than the reference current (IREF), the output of the SA block 173 becomes zero.

It is noted that the SA block 173 can be shared between few columns result in less overhead. Also, the calibration of the pixel circuit can be done one at a time, so the extraction circuits can be shared between the all columns.

A data process unit (DPU) block 172 is provided to control the programming cycle, contrast, and brightness, to perform the calibration procedure and to control the driving cycle. The DPU block 172 implements extraction algorithm to extract (estimate) the threshold voltage of the driving transistor based on the output from the SA block 173, and controls a driver 174 which is connected to the driving transistor 163.

FIG. 10 illustrates an example of the extraction algorithm implemented by the DPU block 172 of FIG. 9. The algorithm of FIG. 10 is in a part of the DPU block 172. In FIG. 10, V_{T}(i,j) represents the extracted threshold voltage for the pixel (i,j) at the previous extraction cycle, V_{S} represents the resolution of the driver 174, “i” represents a row of a pixel array and “j” represents a column of a pixel array. Trigger conveys the comparison results of the SA block 173 of FIG. 9. Less_state 180 determines the situation in which the actual V_{T} of the pixel is less than the predicted V_{T}(V_{TM}), Equal_state 181 determines the situation in which the predicted V_{T}(V_{TM}) and the actual V_{T} of the pixel are equal, and Great state 182 determines the situation in which the actual V_{T} of the pixel is greater than the predicted V_{T}(V_{TM}).

The DPU block 172 of FIG. 9 determines an intermediate threshold voltage V_{TM} as follows:

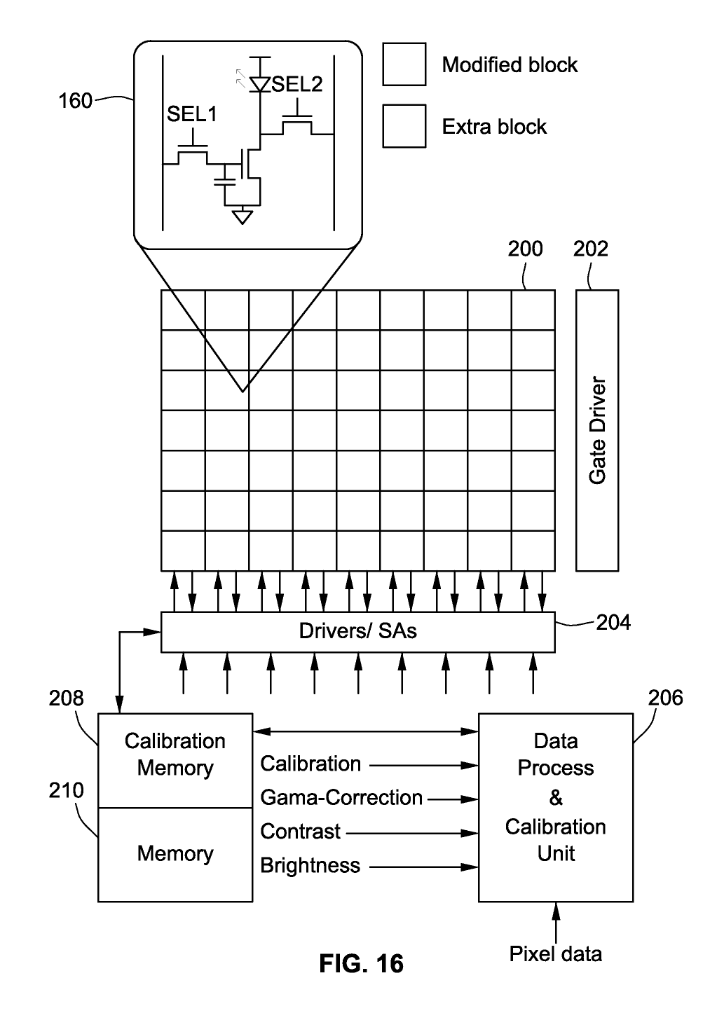

(A1) When s(i,j)Less_state (180), the actual threshold voltage is less than V_{T}(i,j), V_{TM} is set to (V_{T}(i,j)−V_{S}).
(A2) When s(i,j)=Equal_state (181), the actual threshold voltage is equal to VT(i,j), VTM is set to VT(i,j).
(A3) When s(i,j)=Greater_state (182), the actual threshold voltage is greater than V_{T}(i,j), V_{TM} is set to (V_{T}(i,j)±V_{S}).
where s(i,j) represents the previous state of the pixel (i,j) stored in a calibration memory (e.g. 208 of FIG. 16).

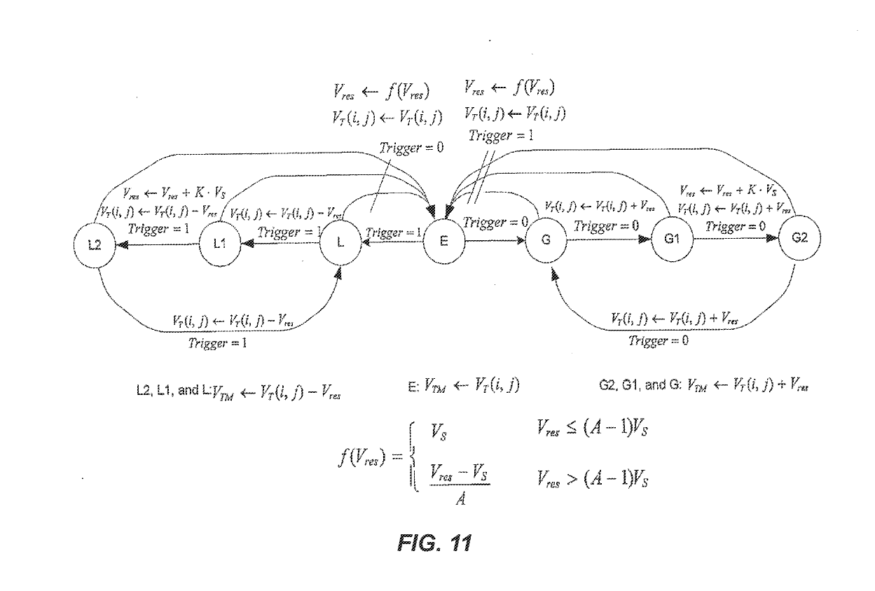

FIG. 11 illustrates a further example of the extraction algorithm implemented by the DPU block 172 of FIG. 9. The algorithm of FIG. 11 is in a part of the DPU block 172 of FIG. 9. In FIG. 11, V_{T}(i,j) represents the extracted threshold voltage for the pixel (i,j) at the previous extraction cycle, V_{S} represents the resolution of the driver 174, “i” represents a row of a pixel array and “j” represents a column of a pixel array. Trigger conveys the comparison results of the SA block 173.

Further, in FIG. 11, Vres represents the step that will be added/subtracted to the predicted V_{T}(V_{TM}) in order achieve the actual V_{T} of the pixel, A represents the reduction gain of a prediction step, and K represents the increase gain of the prediction step.

The operation of FIG. 11 is the same as that of FIG. 10, except that it has gain extra states L2 and G2 for rapid extraction of abrupt changes. In the gain states, the step size is increased to follow the changes more rapidly. L1 and G1 are the transition states which define the V_{T} change is abrupt or normal.

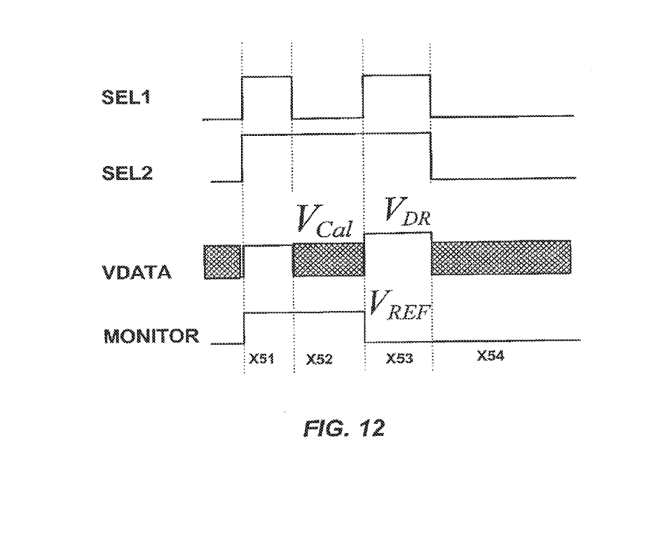

FIG. 12 illustrates an example of waveforms applied to the pixel circuit 160 of FIG. 8. In FIG. 12, V_{call}=V_{B}+V_{TM}, and V_{DR}=V_{P}+V_{T}(i,j)+V_{REF}, where V_{B} represents the bias voltage during the extraction cycle, V_{TM} is defined based on the algorithm shown in FIG. 10 or 11, V_{P} represents a programming voltage, V_{T}(i,j) represents the extracted threshold voltage at the previous extraction cycle, V_{REF} represents the source voltage of the driving transistor during the programming cycle.

Referring to FIGS. 8-12, the operation of the pixel circuit 160 includes operating cycles X51, X52, X53, and X54. In FIG. 12, an extraction cycle is separated from a programming cycle. The extraction cycle includes X51 and X52, and the programming cycle includes X53. X54 is a driving cycle. At the end of the programming cycle, node A3 is charged to (V_{P}+V_{T}) where V_{P} is a programming voltage and V_{T} is the threshold voltage of the driving transistor 163.

In the first operating cycle X51: SEL1 and SEL 2 are high. Node A3 is charged to V_{cal}, and node B3 is charged to V_{REF}. V_{cal} is V_{B}±V_{TM} in which V_{B} is a bias voltage, and V_{TM} the predicted V_{T}, and V_{REF} should be larger than V_{DD}−V_{OLED0} where V_{OLED0} is the ON voltage of the OLED 161.

In the second operating cycle X52: SEL1 goes to zero. The gate-source voltage of the driving transistor 163 is given by:

VGS=V_{B}=V_{TM}+ΔV_{B}+ΔV_{TM}−ΔV_{T2}−ΔV_{H}

where VGS represents the gate-source voltage of the driving transistor 163, ΔV_{B}, ΔV_{TM}, ΔV_{T2} and ΔV_{H} are the dynamic effects depending on V_{B}, V_{TM}, V_{T2} and V_{H}, respectively. V_{T2} represents the threshold voltage of the switch transistor 164, and V_{H} represents the change in the voltage of SEL1 at the beginning of second operating cycle X52 when it goes to zero.

The SA block 173 is tuned to sense the current larger than β(V_{B})², so that the gate-source voltage of the driving transistor 163 is larger than (V_{B}+V_{T}), where β is the gain parameter in the I-V characteristic of the driving transistor 163.

As a result, after few iterations, V_{TM} and the extracted threshold voltage V_{T}(i,j) for the pixel (i,j) converge to:

$${V}_{TM} = {V}_{T} - γ \cdot ( {V}_{B} + {V}_{T} + {V}_{T 2} - {V}_{H} )$$

$$γ = \frac{{C}_{g 2} / ( 2 \cdot {C}_{S} )}{1 + {C}_{g 2} / ( 2 \cdot {C}_{S} )}$$

where C_{g2} represents the gate capacitance of the switch transistor 164.

In the third operating cycle X53: SEL1 is high. VDATA goes to V_{DR}. Node A3 is charged to [V_{P}+V_{T}(i,j)−γ(V_{P}−V_{B})].

In the fourth operating cycle X54: SEL1 and SEL2 go to zero. Considering the dynamic effects, the gate-source voltage of the driving transistor 163 can be written as:

VGS=V_{P}+V_{T}

Therefore, the pixel current becomes independent of the static and dynamic effects of the threshold voltage shift.

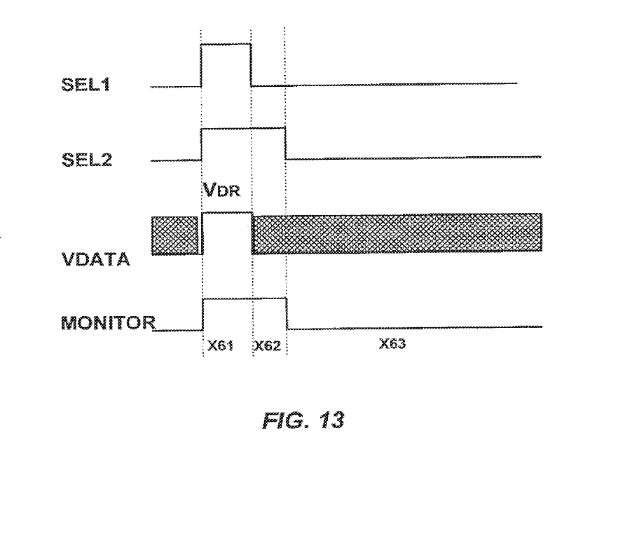

In FIG. 12, the extraction cycle and the programming cycle are shown as separated cycles. However, the extraction cycle and the programming cycle may be merged as shown in FIG. 13. FIG. 13 illustrates a further example of waveforms applied to the pixel circuit 160 of FIG. 8.

Referring to FIGS. 8-11 and 13, the operation of the pixel circuit 160 includes operating cycles X61, X62 and X63. Programming and extraction cycles are merged into the operating cycles X61 and X62. The operating cycle X63 is a driving cycle.

During the programming cycle, the pixel current is compared with the desired current, and the threshold voltage of the driving transistor is extracted with the algorithm of FIG. 10 or 11. The pixel circuit 160 is programmed with V_{DR}=VP+V_{T}(i,j)+V_{REF} during the operating cycle X61. Then the pixel current is monitored through the MONITOR line, and is compared with the desired current. Based on the comparison result and using the extraction algorithm of FIG. 10 or 11, the threshold voltage V_{T}(i,j) is updated.

In FIG. 8, two select lines SEL1 and SEL2 are shown. However, a signal select line (e.g. SEL1) can be used as a common select line to operate the switch transistors 164 and 165. When using the common select line, SEL1 of FIG. 12 stays at high in the second operating cycle X52, and the VGS remains at (V_{B}+V_{TM}). Therefore, the dynamic effects are not detected.

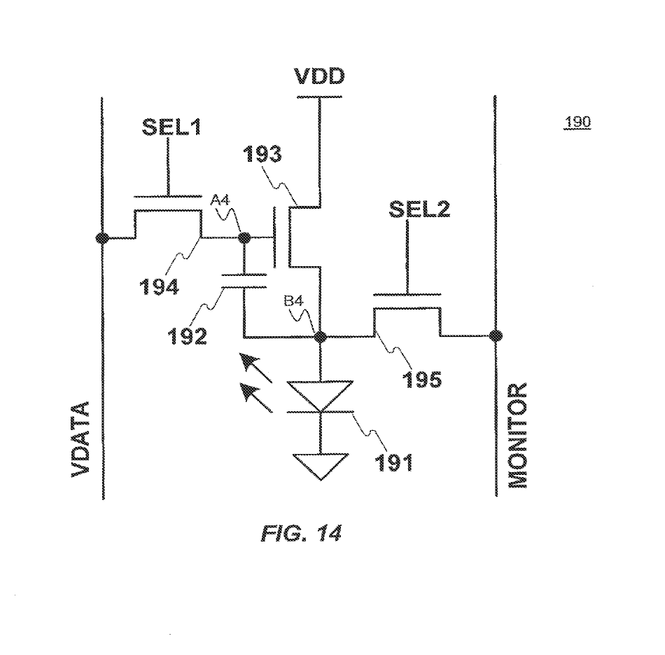

The step-calibration driving technique described above is applicable to the pixel circuit 190 of FIG. 14. The pixel circuit 190 includes an OLED 191, a storage capacitor 192, and a driving transistor 193 and switch transistors 194 and 195. The pixel circuit 190 is a current-programmed, 3-TFT pixel circuit. A plurality of the pixel circuits 190 may form an AMOLED display.

The transistors 193, 194 and 195 are n-type TFTs. However, the transistors 193, 194 and 195 may be p-type TFTs. The step-calibration driving technique applied to the pixel circuit 190 is also applicable to a pixel circuit having p-type transistors. The transistors 193, 194 and 195 may be fabricated using amorphous silicon, nano/micro crystalline silicon, poly silicon, organic semiconductors technologies (e.g. organic TFT), NMOS/PMOS technology or CMOS technology (e.g. MOSFET).

The gate terminal of the driving transistor 193 is connected to a signal line VDATA through the switch transistor 194, and also connected to the storage capacitor 192. The source terminal of the driving transistor 193 is connected to the anode electrode of the OLED 191, and is connected to a monitor line MONITOR through the switch transistor 195. The drain terminal of the driving transistor 193 is connected to a voltage supply line VDD. The gate terminals of the transistors 194 and 195 are connected to select lines SEL1 and SEL2, respectively.

The transistors 193 and 194 and the storage capacitor 192 are connected at node A4. The transistor 195, the OLED 191 and the storage capacitor 192 are connected at node B4.

The structure of the pixel circuit 190 is similar to that of FIG. 8, except that the OLED 191 is at the source terminal of the driving transistor 193. The operation of the pixel circuit 190 is the same as that of FIG. 12 or 13.

Since the source terminal of the drive TFT 193 is forced to VREF during the extraction cycle (X51 and X52 or X62), the extracted data is independent of the ground bouncing. Also, during the programming cycle (X53 or X61), the source terminal of the drive TFT is forced to VREF, the gate-source voltage of the drive TFT becomes independent of the ground bouncing. As a result of these conditions, the pixel current is independent of ground bouncing.

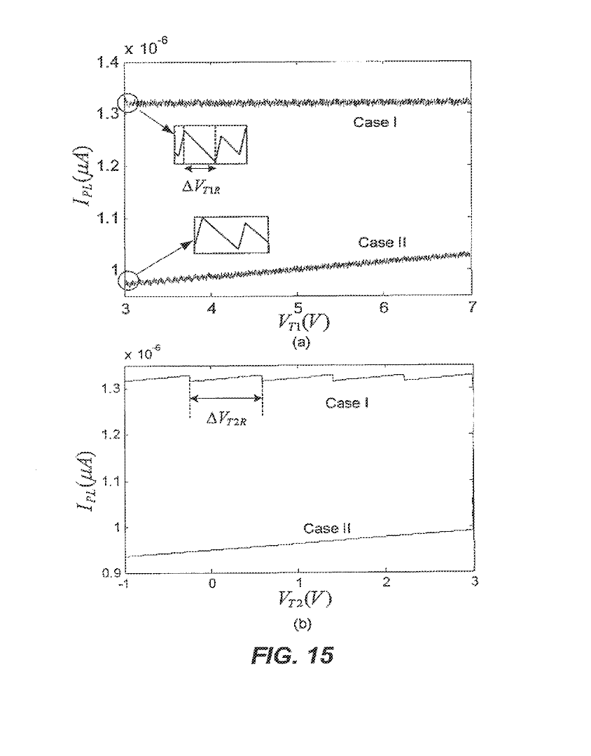

FIG. 15 illustrates the results of simulation for the step-calibration driving technique. In FIG. 15, “Case I” represents an operation of FIG. 8 where SEL1 goes to zero in the second operating cycle (X52 of FIG. 12); “Case II” represents an operation of FIG. 8 where SEL1 stays at high in the second operating cycle.

In FIG. 15, ΔV_{TR} is the minimum detectable shift in the threshold voltage of the driving transistor (e.g. 163 of FIG. 8), ΔV_{T2R} is the minimum detectable shift in the threshold voltage of the switch transistor (e.g. 164 of FIG. 8), and In is the pixel current of the pixel during the driving cycle.

The pixel current of Case II is smaller than that of Case I for a given programming voltage due to the dynamic effects of the threshold voltage shift. Also, the pixel current of Case II increases as the threshold voltage of the driving transistor increases (a), and decreases as the threshold voltage of the switch transistor decreases (b). However, the pixel current of Case I is stable. The maximum error induced in the pixel current is less than %0.5 for any shift in the threshold voltage of the driving and switch TFTs. It is obvious that ΔV_{T2R} is larger than ΔV_{TR} because the effect of a shift in VT on the pixel current is dominant. These two parameters are controlled by the resolution (V_{S}) of the driver (e.g. 174 of FIG. 9), and the SNR of the SA block (e.g. 193 of FIG. 9). Since a shift smaller than ΔV_{TR} cannot be detected, and also the time constant of threshold-shift is large, the extraction cycles (e.g. X51, X52 of FIG. 12) can be done after a long time interval consisting of several frames, leading to lower power consumption. Also, the major operating cycles become the other programming cycle (e.g. X53 of FIG. 12) and the driving cycle (e.g. X54 of FIG. 12). As a result, the programming time reduces significantly, providing for high-resolution, large-area AMOLED displays where a high-speed programming is prerequisite.

FIG. 16 illustrates an example of a system architecture for the step-calibration driving with a display array 200. The display array 200 includes a plurality of the pixel circuits (e.g. 160 of FIG. 8 or 190 of FIG. 14).

A gate driver 202 for selecting the pixel circuits, a drivers/SAs block 204, and a data process and calibration unit block 206 are provided to the display array 200. The drivers/SAs block 204 includes the driver 174 and the SA block 173 of FIG. 9. The data process and calibration unit block 206 includes the DPU block 172 of FIG. 9. “Calibration” in FIG. 16 includes the calibration data from a calibration memory 208, and may include some user defined constants for setting up calibration data processing. The contrast and the brightness inputs are used to adjust the contrast and the brightness of the panel by the user. Also, gamma-correction data is defined based on the OLED characteristic and human eye. The gamma-correction input is used to adjust the pixel luminance for human eyes.

The calibration memory 208 stores the extracted threshold voltage V_{T}(i,j) and the state s(i,j) of each pixel. A memory 210 stores the other required data for the normal operation of a display including gamma correction, resolution, contrast, and etc. The DPU block performs the normal tasks assigned to a controller and scheduler in a display. Besides, the algorithm of FIG. 10 or 11 is added to it to perform the calibration.

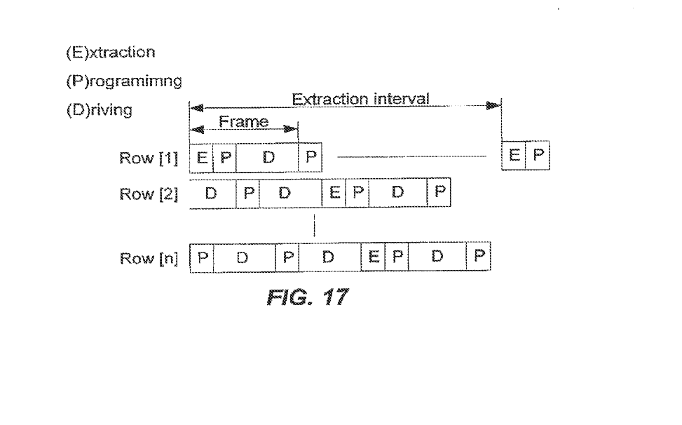

FIG. 17 illustrates an example of waveforms applied to the system architecture of FIG. 16. In FIG. 17, each of ROW[1], ROW[2], and ROW[3] represents a row of the display array 200, “E” represents an extraction operation, “P” represents a programming operation and “D” represents a driving operation. It is noted that the extraction cycles (E) are not required to be done for all the frame cycle. Therefore, after a long time interval (extraction interval), the extraction is repeated for a pixel.

As shown in FIG. 17, only one extraction procedure occurs during a frame time. Also, the VT extraction of the pixel circuits at the same row is preformed at the same time.

Therefore, the maximum time required to refresh a frame is:

τ_{F}=n·τ_{P}+τ_{E}

where τ_{F}. represents the frame time, τ_{P} represents the time required to write the pixel data into the storage capacitor (e.g. 162 of FIG. 8), τ_{E} represents the extraction time, and n represents the number of row in the display array (e.g. 200 of FIG. 16).

Assuming τ_{E}=m·τ_{P}, the frame time τ_{F} can be written as:

τ_{F}=(n+m)·τ_{P}

where m represents the timing required for the extraction cycles in the scale of programming cycle timing (τ_{P}).

For example, for a Quarter Video Graphics Array (QVGA) display (240×320) with frame rate of 60 Hz, if m=10, the programming time of each row is 6611 s, and the extraction time is 0.66 ms.

It is noted that the step-calibration driving technique described above is applicable to any current-programmed pixel circuit other than those of FIGS. 8 and 14.

Using the step-calibration driving technique, the time dependent parameter(s) of a pixel, such as threshold shift, is extracted. Then, the programming-voltage is calibrated with the extracted information, resulting in a stable pixel current over time. Further, a stable current independent of the pixel aging under prolonged display operation can be is provided to the pixel circuit, which efficiently improves the display operating lifetime.

A technique for programming, extracting time dependent parameters of a pixel and driving the pixel in accordance with a further embodiment of the present invention is described in detail. The technique includes extracting information on the aging of a pixel (e.g. OLED luminance) by monitoring OLED voltage or OLED current, and generating luminance. The programming voltage is calibrated with the extracted information, resulting in stable brightness over time.

Since the OLED voltage/current has been reported to be correlated with the brightness degradation in the OLED (e.g. 161 of FIG. 8, 191 of FIG. 14), the programming voltage can be modified by the OLED voltage/current to provide a constant brightness.

For example, during the driving cycle, the voltage/current of the OLED (161 of FIG. 8 or 191 of FIG. 14) is extracted while SEL2 is high. Since the OLED voltage or current has been reported to be correlated with the brightness degradation in the OLED, the programming voltage can be modified by the OLED voltage to provide a constant brightness.

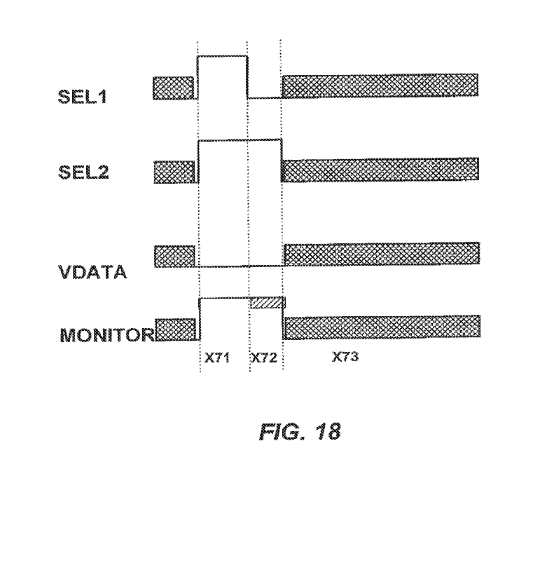

FIG. 18 illustrates an example of waveforms for the voltage/current extraction. The waveforms of FIG. 18 are applicable to the pixel circuit 160 of FIG. 8 and the pixel circuit 190 of FIG. 14 to extract OLED voltage/current. The operation of FIG. 18 includes operating cycles X71, X72 and X73. The operating cycles X71 and X72 are an OLED extraction cycle. The operating cycle X73 is one of the operating cycles shown in FIGS. 12 and 13.

During the first operating cycle X71, SEL1 and SEL2 are high, and VDATA is zero. The gate-source voltage of the driving transistor (e.g. 163 of FIG. 8) becomes zero. A current or voltage is applied to the OLED (161 of FIG. 8) through the MONITOR line.

During the second operating cycle X72, SEL2 is high and SELL is low. The OLED voltage or current is extracted through the MONITOR line using the algorithm presented in FIG. 10 or 11. This waveform can be combined with any other driving waveform.

In the above description, the algorithm of FIGS. 10 and 11 is used to predict the aging data, i.e. V_{T} shift, based on the comparison results (current with current or voltage with voltage). However, the algorithm of FIGS. 10 and 11 is applicable to predict the shift in the OLED voltage V_{OLED} by replacing V_{T} with the V_{OLED} and the comparison result of OLED current/voltage with a reference current/voltage. In the description above, the system architecture shown in FIG. 9 is used to compensate for the threshold shift. However, it is understood that the OLED data is also extracted when the architecture of FIG. 9, i.e. DPU 172, block 173, driver 174, is used. This data can be used to compensate for the OLED shift.

The operating cycle X73 can be any operating cycle including the programming cycle. This depends on the status of the panel after OLED extraction. If it is during the operation, then X73 is the programming cycle of the waveforms in FIGS. 12 and 13. The OLED voltage can be extracted during the driving cycle X55/X63 of FIG. 12/13. During the driving cycle X55/X63, the SEL2 of FIG. 8 or 14 goes to a high voltage, and so the voltage of the OLED can be read back through the MONITOR for a specific pixel current.

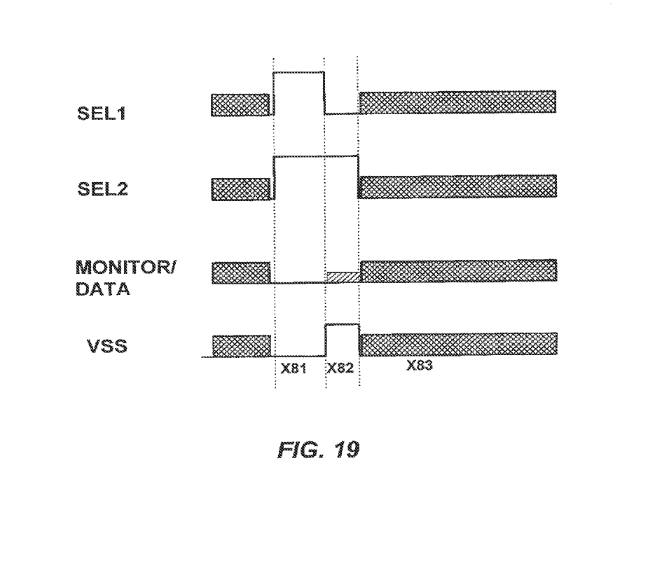

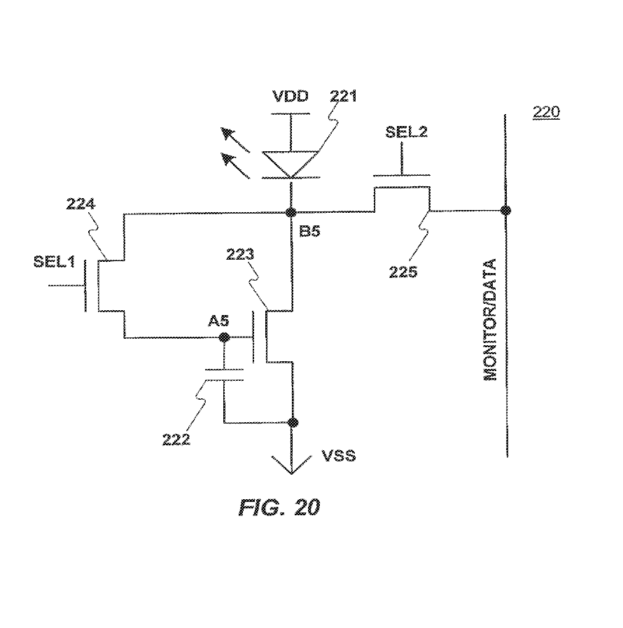

FIG. 19 illustrates a further example of waveforms for the voltage/current extraction. FIG. 20 illustrates a pixel circuit 220 to which the voltage/current extraction of FIG. 19 is applied.

Referring to FIG. 20, the pixel circuit 220 includes an OLED 221, a storage capacitor 222, and a driving transistor 223 and switch transistors 224 and 225. A plurality of the pixel circuits 220 may form an AMOLED display.

The transistors 223, 224 and 225 are n-type TFTs. However, the transistors 223, 224 and 225 may be p-type TFTs. The voltage/current extraction technique applied to the pixel circuit 220 is also applicable to a pixel circuit having p-type transistors. The transistors 223, 224 and 225 may be fabricated using amorphous silicon, nano/micro crystalline silicon, poly silicon, organic semiconductors technologies (e.g. organic TFT), NMOS/PMOS technology or CMOS technology (e.g. MOSFET).

The gate terminal of the driving transistor 223 is connected to the source terminal of the switch transistor 224, and also connected to the storage capacitor 222. The one terminal of the driving transistor 223 is connected to a common ground. The other terminal of the driving transistor 223 is connected to a monitor and data line MONITOR/DATA through the switch transistor 235, and is also connected to the cathode electrode of the OLED 221.

The gate terminal of the switch transistor 224 is connected to a select line SEL1. The one terminal of the switch transistor 224 is connected to the gate terminal of the driving transistor 223, and is connected to the storage capacitor 222. The other terminal of the switch transistor 224 is connected to the cathode electrode of the OLED 221.

The gate terminal of the switch transistor 225 is connected to a select line SEL2. The one terminal of the switch transistor 225 is connected to MONITOR/DATA. The other terminal of the switch transistor 225 is connected to the driving transistor 223 and the cathode electrode of the OLED 221. The anode electrode of the OLED 221 is connected to a voltage supply electrode or line VDD.

The transistors 223 and 224 and the storage capacitor 222 are connected at node A5. The transistors 223 and 225 and the OLED 221 are connected at node B5.

The pixel circuit 220 is similar to the pixel circuit 160 of FIG. 8. However, in the pixel circuit 220, the MONITOR/DATA line is used for monitoring and programming purpose.

Referring to FIGS. 19-20, the operation of the pixel circuit 220 includes operating cycles X81, X82 and X83.

During the first operating cycle X81, SEL1 and SEL2 are high and MONITOR/DATA is zero. The gate-source voltage of the driving transistor (223 of FIG. 20) becomes zero.

During the second operating cycle X82, a current or voltage is applied to the OLED through the MONITOR/DATA line, and its voltage or current is extracted. As described above, the shift in the OLED voltage is extracted using the algorithm presented in FIG. 10 or 11 based on the monitored voltage or current. This waveform can be combined with any driving waveform.

The operating cycle X83 can be any operating cycle including the programming cycle. This depends on the status of the panel after OLED extraction.

The OLED voltage/current can be extracted during the driving cycle of the pixel circuit 220 of FIG. 20 after it is programmed for a constant current using any driving technique. During the driving cycle the SEL2 goes to a high voltage, and so the voltage of the OLED can be read back through the MONITOR/DATA line for a specific pixel current.

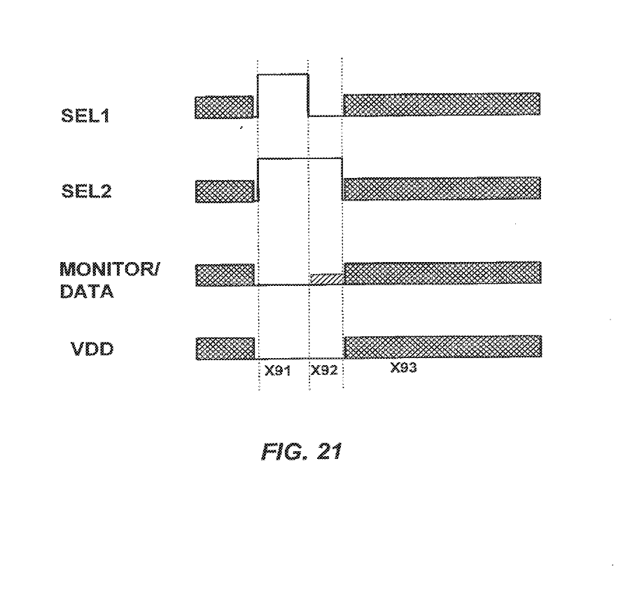

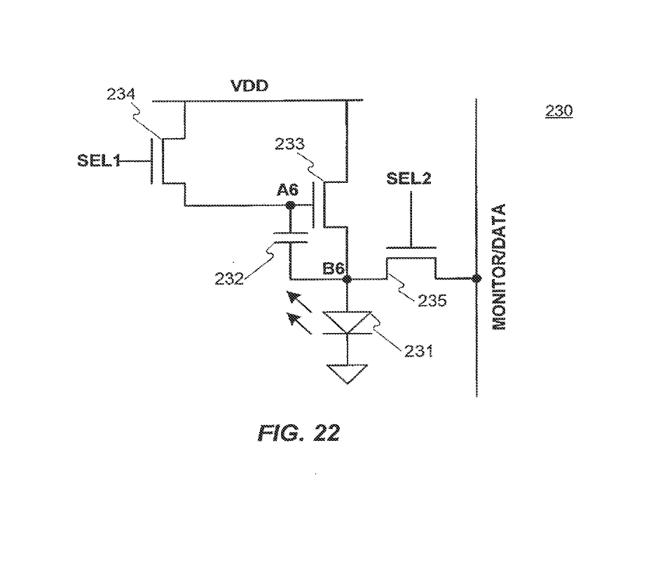

FIG. 21 illustrates a further example of waveforms for the voltage/current extraction technique. FIG. 22 illustrates a pixel circuit 230 to which the voltage/current extraction of FIG. 21 is applied. The waveforms of FIG. 21 is also applicable to the pixel circuit 160 of FIG. 8 to extract OLED voltage/current.

Referring to FIG. 22, the pixel circuit 230 includes an OLED 231, a storage capacitor 232, and a driving transistor 233 and switch transistors 234 and 235. A plurality of the pixel circuits 230 may form an AMOLED display.

The transistors 233, 234 and 235 are n-type TFTs. However, the transistors 233, 234 and 235 may be p-type TFTs. The voltage/current extraction technique applied to the pixel circuit 230 is also applicable to a pixel circuit having p-type transistors. The transistors 233, 234 and 235 may be fabricated using amorphous silicon, nano/micro crystalline silicon, poly silicon, organic semiconductors technologies (e.g. organic TFT), NMOS/PMOS technology or CMOS technology (e.g. MOSFET).

The gate terminal of the driving transistor 233 is connected to the source terminal of the switch transistor 234, and also connected to the storage capacitor 232. The one terminal of the driving transistor 233 is connected to a voltage supply line VDD. The other terminal of the driving transistor 233 is connected to a monitor and data line MONITOR/DATA through the switch transistor 235, and is also connected to the anode electrode of the OLED 231.

The gate terminal of the switch transistor 234 is connected to a select line SEL1. The one terminal of the switch transistor 234 is connected to the gate terminal of the driving transistor 233, and is connected to the storage capacitor 232. The other terminal of the switch transistor 234 is connected to VDD.

The gate terminal of the switch transistor 225 is connected to a select line SEL2. The one terminal of the switch transistor 235 is connected to MONITOR/DATA. The other terminal of the switch transistor 235 is connected to the driving transistor 233 and the anode electrode of the OLED 231. The anode electrode of the OLED 231 is connected to VDD.

The transistors 233 and 234 and the storage capacitor 232 are connected at node A6. The transistors 233 and 235 and the OLED 231 are connected at node B5.

The pixel circuit 230 is similar to the pixel circuit 190 of FIG. 14. However, in the pixel circuit 230, the MONITOR/DATA line is used for monitoring and programming purpose.

Referring to FIGS. 21-22, the operation of FIG. 22 includes operating cycles X91, X92 and X93.

During the first operating cycle X91, SEL1 and SEL2 are high and VDD goes to zero. The gate-source voltage of the driving transistor (e.g. 233 of FIG. 21) becomes zero.

During the second operating cycle X92, a current (voltage) is applied to the OLED (e.g. 231 of FIG. 21) through the MONITOR/DATA line, and its voltage (current) is extracted. As described above, the shift in the OLED voltage is extracted using the algorithm presented in FIG. 10 or 11 based on the monitored voltage or current. This waveform can be combined with any other driving waveform.

The operating cycle X93 can be any operating cycle including the programming cycle. This depends on the status of the panel after OLED extraction.

The OLED voltage can be extracted during the driving cycle of the pixel circuit 230 of FIG. 21 after it is programmed for a constant current using any driving technique. During the driving cycle the SEL2 goes to a high voltage, and so the voltage of the OLED can be read back through the MONITOR/DATA line for a specific pixel current.

As reported, the OLED characteristics improve under negative bias stress. As a result, a negative bias related to the stress history of the pixel, extracted from the OLED voltage/current, can be applied to the OLED during the time in which the display is not operating. This method can be used for any pixel circuit presented herein.

Using the OLED voltage/current extraction technique, a pixel circuit can provide stable brightness that is independent of pixel aging under prolonged display operation, to efficiently improve the display operating lifetime.

A technique for reducing the unwanted emission in a display array having a light emitting device in accordance with an embodiment of the present invention is described in detail. This technique includes removing OLED from a programming path during a programming cycle. This technique can be adopted in hybrid driving technique to extract information on the precise again of a pixel, e.g. the actual threshold voltage shift/mismatch of the driving transistor. The light emitting device is turned off during the programming/calibration cycle so that it prevents the unwanted emission and effect of the light emitting device on the pixel aging. This technique can be applied to any current mirror pixel circuit fabricated in any technology including poly silicon, amorphous silicon, crystalline silicon, and organic materials.

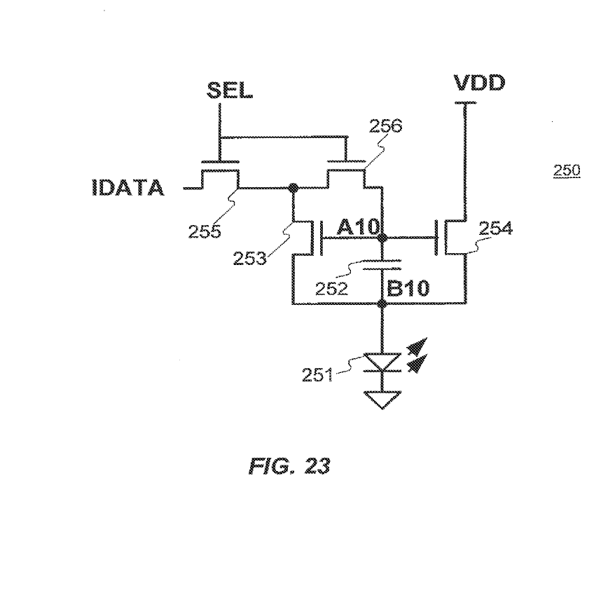

FIG. 23 illustrates a mirror based pixel circuit 250 to which a technique for removing OLED from a programming path during a programming cycle is applied. The pixel circuit 250 includes an OLED 251, a storage capacitor 252, a programming transistor 253, a driving transistor 254, and switch transistors 255 and 256. The gate terminals of the transistors 253 and 254 are connected to IDATA through the switch transistors 255 and 256.

The transistors 253, 254, 255 and 256 are n-type TFTs. However, the transistors 253, 254, 255 and 256 may be p-type TFTs. The OLED removing technique applied to the pixel circuit 250 is also applicable to a pixel circuit having p-type transistors. The transistors 253, 254, 255 and 256 may be fabricated using amorphous silicon, nano/micro crystalline silicon, poly silicon, organic semiconductors technologies (e.g. organic TFT), NMOS/PMOS technology or CMOS technology (e.g. MOSFET).

The transistors 253, 254 and 256 and the storage capacitor 252 are connected at node A10. The transistors 253 and 254, the OLED 251 and the storage capacitor 252 are connected at node B10.

In the conventional current programming, SEL goes high, and a programming current (IP) is applied to IDATA. Considering that the width of the mirror transistor 253 is “m” times larger than the width of the mirror transistor 254, the current flowing through the OLED 251 during the programming cycle is (m+1)IP. When “m” is large to gain significant speed improvement, the unwanted emission may become considerable.

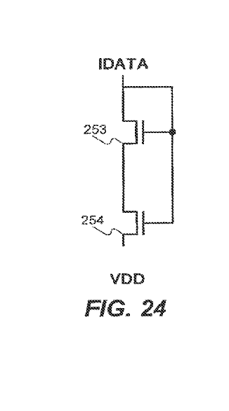

By contrast, according to the OLED removing technique, VDD is brought into a lower voltage. This ensures the OLED 251 to be removed from a programming path as shown in FIG. 24.

During a programming cycle, SEL is high and VDD goes to a reference voltage (Vref) in which the OLED 251 is reversely biased. Therefore, the OLED 251 is removed from the current path during the programming cycle.

During the programming cycle, the pixel circuit 250 may be programmed with scaled current through IDATA without experiencing unwanted emission.

During the programming cycle, the pixel circuit 250 may be programmed with current and using one of the techniques describe above. The voltage of the IDATA line is read back to extract the threshold voltage of the mirror transistor 253 which is the same as threshold voltage of the driving transistor 254.

Also, during the programming cycle, the pixel circuit 250 may be programmed with voltage through the IDATA line, using one of the techniques describe above. The current of the IDATA line is read back to extract the threshold voltage of the mirror transistor 253 which is the same as threshold voltage of the driving transistor 254.

The reference voltage Vref is chosen so that the voltage at node B10 becomes smaller than the ON voltage of the OLED 251. As a result, the OLED 251 turns off and the unwanted emission is zero. The voltage of the IDATA line includes

V_{P}+V_{T}+ΔVT (3)

where V_{P} includes the drain-source voltage of the driving transistor 254 and the gate-source voltage of the transistor 253, V_{T} is the threshold voltage of the transistor 253 (254), and ΔV_{T} is the V_{T} shift/mismatch.

At the end of the programming cycle, VDD goes to its original value, and so voltage at node B10 goes to the OLED voltage VOLED. At the driving cycle, SEL is low. The gate voltage of the transistor 254/253 is fixed and stored in the storage capacitor 252, since the switch transistors 255 and 256 are off. Therefore, the pixel current during the driving cycle becomes independent of the threshold voltage V_{T}.

The OLED removing technique can be adopted in hybrid driving technique to extract the V_{T}-shift or V_{T}-mismatch. From (3), if the pixel is programmed with the current, the only variant parameter in the voltage of the DATA line is the V_{T} shift/mismatch (ΔV_{T}). Therefore, ΔV_{T} can be extracted and the programming data can be calibrated with ΔV_{T}.

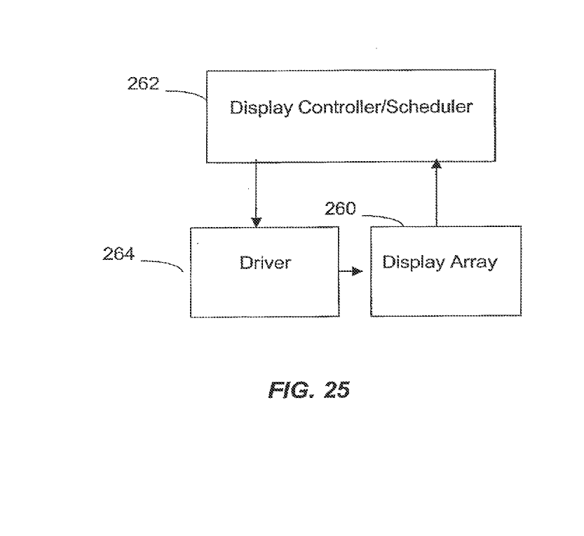

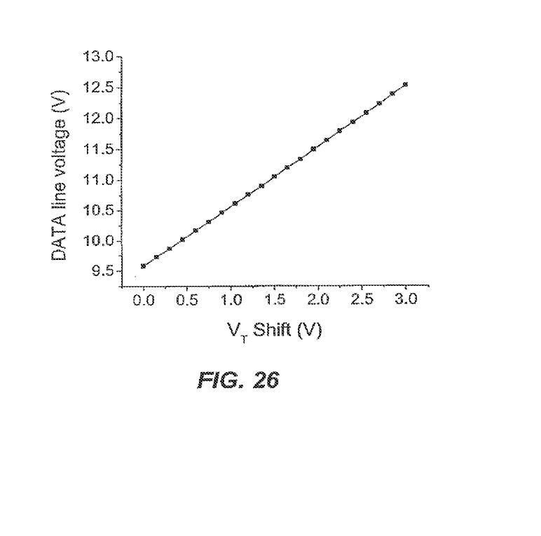

FIG. 25 illustrates an example of a system architecture for implementing the OLED removing technique. A display array 260 includes a plurality of pixel circuits, e.g. pixel circuit 250 of FIG. 26. A display controller and scheduler 262 controls and schedules the operation of the display array 260. A driver 264 provides operation voltages to the pixel circuit. The driver provides the operation voltage(s) to the pixel circuit based on instructions/commands from the display controller and scheduler 262 such that the OLED is removed from a programming path of the pixel circuit, as described above.

The controller and scheduler 262 may include functionality of the display controller and scheduler 64 of FIG. 3, or may include functionality of the data process and calibration unit 206 of FIG. 16. The system of FIG. 25 may have any of these functionalities, the calibration-scheduling described above, the voltage/current extraction described above, or combinations thereof.

The simulation result for the voltage on IDATA line for different V_{T} is illustrated in FIG. 26. Referring to FIGS. 23-26, the voltage of the IDATA line includes the shift in the threshold voltage of the transistors 253 and 254. The programming current is 1 μA.

The unwanted emission is reduced significantly resulting in a higher resolution. Also, individual extraction of circuit aging and light emitting device aging become possible, leading in a more accurate calibration.

It is noted that each of the transistors shown in FIGS. 4-8,14, 20, 21, 23 and 24 can be replaced with a p-type transistor using the concept of complementary circuits.

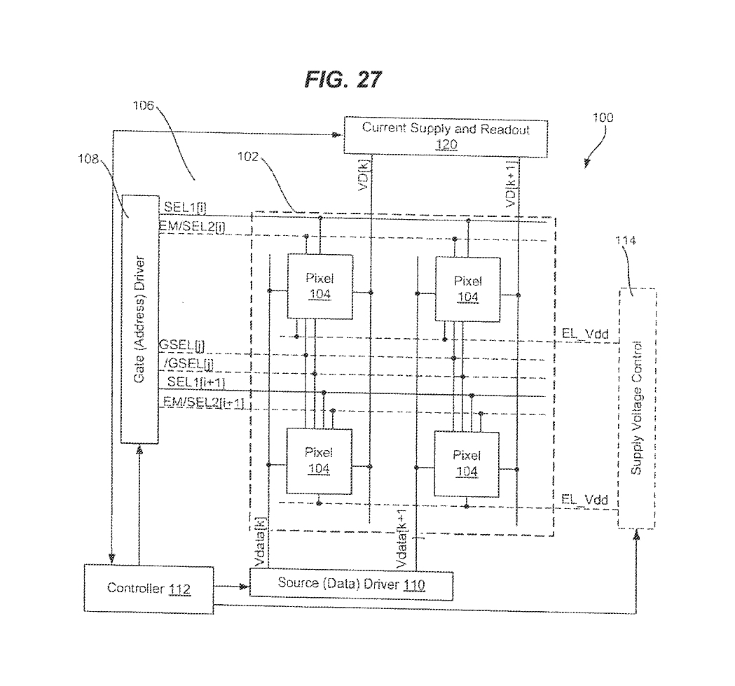

FIG. 27 is an electronic display system 100 having an active matrix area or pixel array 102 in which an n×m array of pixels 104 are arranged in a row and column configuration. For ease of illustration, only two rows and two columns are shown. External to the active matrix area of the pixel array 102 is a peripheral area 106 where peripheral circuitry for driving and controlling the pixel array 102 are disposed. The peripheral circuitry includes an address or gate driver circuit 108, a data or source driver circuit 110, a controller 112, and an optional supply voltage (e.g., Vdd) driver 114. The controller 112 controls the gate, source, and supply voltage drivers 108, 110, 114. The gate driver 108, under control of the controller 112, operates on address or select lines SEL[i], SEL[i+1], and so forth, one for each row of pixels 104 in the pixel array 102. In pixel sharing configurations described below, the gate or address driver circuit 108 can also optionally operate on global select lines GSEL[j] and optionally /GSEL[j], which operate on multiple rows of pixels 104 in the pixel array 102, such as every two rows of pixels 104. The source driver circuit 110, under control of the controller 112, operates on voltage data lines Vdata[k], Vdata[k+1], and so forth, one for each column of pixels 104 in the pixel array 102. The voltage data lines carry voltage programming information to each pixel 104 indicative of the brightness of each light emitting device in the pixel 104. A storage element, such as a capacitor, in each pixel 104 stores the voltage programming information until an emission or driving cycle turns on the light emitting device. The optional supply voltage driver 114, under control of the controller 112, controls a supply voltage (EL_Vdd) line, one for each row or column of pixels 104 in the pixel array 102.

The display system 100 further includes a current supply and readout circuit 120, which reads output data from data output lines, VD [k], VD [k+1], and so forth, one for each column of pixels 104 in the pixel array 102.

As is known, each pixel 104 in the display system 100 needs to be programmed with information indicating the brightness of the light emitting device in the pixel 104. A frame defines the time period that includes: (i) a programming cycle or phase during which each and every pixel in the display system 100 is programmed with a programming voltage indicative of a brightness; and (ii) a driving or emission cycle or phase during which each light emitting device in each pixel is turned on to emit light at a brightness commensurate with the programming voltage stored in a storage element. A frame is thus one of many still images that compose a complete moving picture displayed on the display system 100. There are at least schemes for programming and driving the pixels: row-by-row, or frame-by-frame. In row-by-row programming, a row of pixels is programmed and then driven before the next row of pixels is programmed and driven. In frame-by-frame programming, all rows of pixels in the display system 100 are programmed first, and all rows of pixels are driven at once. Either scheme can employ a brief vertical blanking time at the beginning or end of each frame during which the pixels are neither programmed nor driven.

The components located outside of the pixel array 102 may be disposed in a peripheral area 106 around the pixel array 102 on the same physical substrate on which the pixel array 102 is disposed. These components include the gate driver 108, the source driver 110, the optional supply voltage driver 114, and a current supply and readout circuit 120. Alternately, some of the components in the peripheral area 106 may be disposed on the same substrate as the pixel array 102 while other components are disposed on a different substrate, or all of the components in the peripheral area can be disposed on a substrate different from the substrate on which the pixel array 102 is disposed. Together, the gate driver 108, the source driver 110, and the supply voltage driver 114 make up a display driver circuit. The display driver circuit in some configurations can include the gate driver 108 and the source driver 110 but not the supply voltage control 114.

When biased in saturation, the first order I-V characteristic of a metal oxide semiconductor (MOS) transistor (a thin film transistor in this case of interest) is modeled as:

$${I}_{D} = \frac{1}{2} μ {C}_{ox} \frac{W}{L} {( {V}_{GS} - {V}_{th} )}^{2}$$

where I_{D} is the drain current and V_{GS} is the voltage difference applied between gate and source terminals of the transistor. The thin film transistor devices implemented across the display system 100 demonstrate non-uniform behavior due to aging and process variations in mobility (μ) and threshold voltage (Vₜₕ). Accordingly, for a constant voltage difference applied between gate and source, V_{GS}, each transistor on the pixel matrix 102 may have a different drain current based on a non-deterministic mobility and threshold voltage:

Error! Objects cannot be created from editing field codes.

where i and j are the coordinates (row and column) of a pixel in an n×m array of pixels such as the array of pixels 102 in FIG. 27.

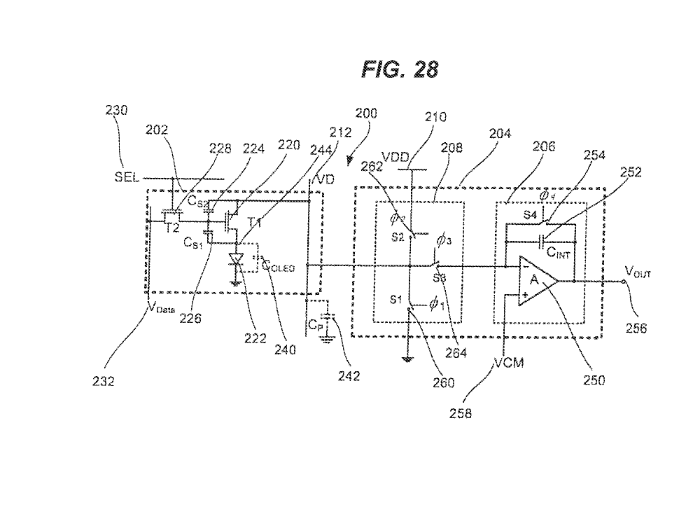

FIG. 28 shows a data extraction system 200 including a two-transistor (2T) driver circuit 202 and a readout circuit 204. The supply voltage control 114 is optional in a display system with 2T pixel circuit 104. The readout circuit 204 is part of the current supply and readout circuit 120 and gathers data from a column of pixels 104 as shown in FIG. 27. The readout circuit 204 includes a charge pump circuit 206 and a switch-box circuit 208. A voltage source 210 provides the supply voltage to the driver circuit 202 through the switch-box circuit 208. The charge-pump and switch-box circuits 206 and 208 are implemented on the top or bottom side of the array 102 such as in the voltage drive 114 and the current supply and readout circuit 120 in FIG. 27. This is achieved by either direct fabrication on the same substrate as the pixel array 102 or by bonding a microchip on the substrate or a flex as a hybrid solution.

The driver circuit 202 includes a drive transistor 220, an organic light emitting device 222, a drain storage capacitor 224, a source storage capacitor 226, and a select transistor 228. A supply line 212 provides the supply voltage and also a monitor path (for the readout circuit 204) to a column of driver circuits such as the driver circuit 202. A select line input 230 is coupled to the gate of the select transistor 228. A programming data input 232 is coupled to the gate of the drive transistor 220 through the select transistor 228. The drain of the drive transistor 220 is coupled to the supply voltage line 212 and the source of the drive transistor 220 is coupled to the OLED 222. The select transistor 228 controls the coupling of the programming input 230 to the gate of the drive transistor 220. The source storage capacitor 226 is coupled between the gate and the source of the drive transistor 220. The drain storage capacitor 224 is coupled between the gate and the drain of the drive transistor 220. The OLED 222 has a parasitic capacitance that is modeled as a capacitor 240. The supply voltage line 212 also has a parasitic capacitance that is modeled as a capacitor 242. The drive transistor 220 in this example is a thin film transistor that is fabricated from amorphous silicon. Of course other materials such as polysilicon or metal oxide may be used. A node 244 is the circuit node where the source of the drive transistor 220 and the anode of the OLED 222 are coupled together. In this example, the drive transistor 220 is an n-type transistor. The system 200 may be used with a p-type drive transistor in place of the n-type drive transistor 220 as will be explained below.

The readout circuit 204 includes the charge-pump circuit 206 and the switch-box circuit 208. The charge-pump circuit 206 includes an amplifier 250 having a positive and negative input. The negative input of the amplifier 250 is coupled to a capacitor 252 (Cᵢₙₜ) in parallel with a switch 254 in a negative feedback loop to an output 256 of the amplifier 250. The switch 254 (S4) is utilized to discharge the capacitor 252 Cᵢₙₜ during the pre-charge phase. The positive input of the amplifier 250 is coupled to a common mode voltage input 258 (VCM). The output 256 of the amplifier 250 is indicative of various extracted parameters of the drive transistor 220 and OLED 222 as will be explained below.

The switch-box circuit 208 includes several switches 260, 262 and 264 (S1, S2 and S3) to steer current to and from the pixel driver circuit 202. The switch 260 (S1) is used during the reset phase to provide a discharge path to ground. The switch 262 (S2) provides the supply connection during normal operation of the pixel 104 and also during the integration phase of readout. The switch 264 (S3) is used to isolate the charge-pump circuit 206 from the supply line voltage 212 (VD).

The general readout concept for the two transistor pixel driver circuit 202 for each of the pixels 104, as shown in FIG. 28, comes from the fact that the charge stored on the parasitic capacitance represented by the capacitor 240 across the OLED 222 has useful information of the threshold voltage and mobility of the drive transistor 220 and the turn-on voltage of the OLED 222. The extraction of such parameters may be used for various applications. For example, such parameters may be used to modify the programming data for the pixels 104 to compensate for pixel variations and maintain image quality. Such parameters may also be used to pre-age the pixel array 102. The parameters may also be used to evaluate the process yield for the fabrication of the pixel array 102.

Assuming that the capacitor 240 (C_{OLED}) is initially discharged, it takes some time for the capacitor 240 (C_{OLED}) to charge up to a voltage level that turns the drive transistor 220 off. This voltage level is a function of the threshold voltage of the drive transistor 220. The voltage applied to the programming data input 232 (V_{Data}) must be low enough such that the settled voltage of the OLED 222 (V_{OLED}) is less than the turn-on threshold voltage of the OLED 222 itself. In this condition, V_{Data}−V_{OLED} is a linear function of the threshold voltage (Vₜₕ) of the drive transistor 220. In order to extract the mobility of a thin film transistor device such as the drive transistor 220, the transient settling of such devices, which is a function of both the threshold voltage and mobility, is considered. Assuming that the threshold voltage deviation among the TFT devices such as the drive transistor 220 is compensated, the voltage of the node 244 sampled at a constant interval after the beginning of integration is a function of mobility only of the TFT device such as the drive transistor 220 of interest.

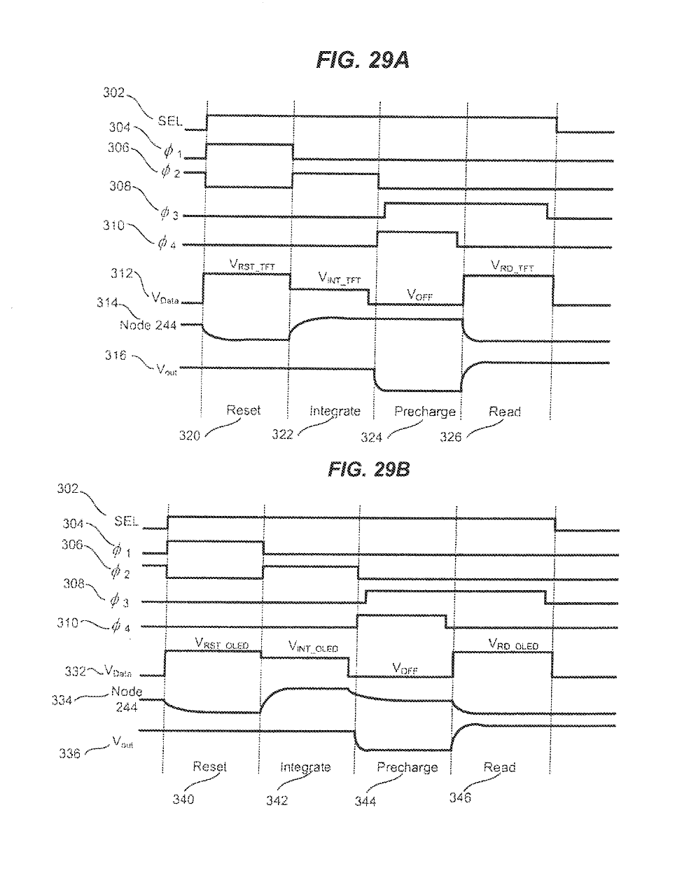

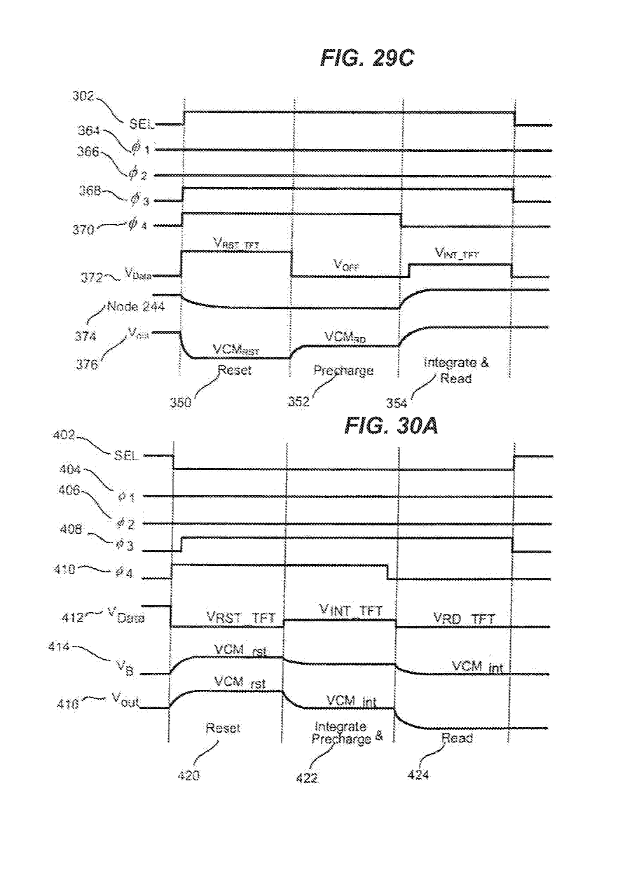

FIG. 29A-3C are signal timing diagrams of the control signals applied to the components in FIG. 28 to extract parameters such as voltage threshold and mobility from the drive transistor 220 and the turn on voltage of the OLED 222 in the drive circuit 200 assuming the drive transistor 220 is an n-type transistor. Such control signals could be applied by the controller 112 to the source driver 110, the gate driver 108 and the current supply and readout circuit 120 in FIG. 27. FIG. 29A is a timing diagram showing the signals applied to the extraction circuit 200 to extract the threshold voltage and mobility from the drive transistor 220. FIG. 29A includes a signal 302 for the select input 230 in FIG. 28, a signal 304 (φ₁) to the switch 260, a signal 306 (φ₂) for the switch 262, a signal 308 (φ₃) for the switch 264, a signal 310 (φ₄) for the switch 254, a programming voltage signal 312 for the programming data input 232 in FIG. 28, a voltage 314 of the node 244 in FIG. 28 and an output voltage signal 316 for the output 256 of the amplifier 250 in FIG. 28.

FIG. 29A shows the four phases of the readout process, a reset phase 320, an integration phase 322, a pre-charge phase 324 and a read phase 326. The process starts by activating a high select signal 302 to the select input 230. The select signal 302 will be kept high throughout the readout process as shown in FIG. 29A.

During the reset phase 320, the input signal 304 (φ₁) to the switch 260 is set high in order to provide a discharge path to ground. The signals 306, 308 and 310 (φ₂, φ₃, φ₄) to the switches 262, 264 and 250 are kept low in this phase. A high enough voltage level (V_{RST}_{_{—}}_{TFT}) is applied to the programming data input 232 (V_{Data}) to maximize the current flow through the drive transistor 220. Consequently, the voltage at the node 244 in FIG. 28 is discharged to ground to get ready for the next cycle.

During the integration phase 322, the signal 304 (φ₂) to the switch 262 stays high which provides a charging path from the voltage source 210 through the switch 262. The signals 304, 308 and 310 (φ₁, φ₃, φ₄) to the switches 260, 264 and 250 are kept low in this phase. The programming voltage input 232 (V_{Data}) is set to a voltage level (V_{INT}_{_{—}}_{TFT}) such that once the capacitor 240 (C_{oled}) is fully charged, the voltage at the node 244 is less than the turn-on voltage of the OLED 222. This condition will minimize any interference from the OLED 222 during the reading of the drive transistor 220. Right before the end of integration time, the signal 312 to the programming voltage input 232 (V_{Data}) is lowered to V_{OFF} in order to isolate the charge on the capacitor 240 (C_{oled}) from the rest of the circuit.

When the integration time is long enough, the charge stored on capacitor 240 (C_{oled}) will be a function of the threshold voltage of the drive transistor 220. For a shortened integration time, the voltage at the node 244 will experience an incomplete settling and the stored charge on the capacitor 240 (C_{oled}) will be a function of both the threshold voltage and mobility of the drive transistor 220. Accordingly, it is feasible to extract both parameters by taking two separate readings with short and long integration phases.

During the pre-charge phase 324, the signals 304 and 306 (φ₁, φ₂) to switches 260 and 262 are set low. Once the input signal 310 (φ₄) to the switch 254 is set high, the amplifier 250 is set in a unity feedback configuration. In order to protect the output stage of the amplifier 250 against short-circuit current from the supply voltage 210, the signal 308 (φ₃) to the switch 264 goes high when the signal 306 (φ₂) to the switch 262 is set low. When the switch 264 is closed, the parasitic capacitance 242 of the supply line is precharged to the common mode voltage, VCM. The common mode voltage, VCM, is a voltage level which must be lower than the ON voltage of the OLED 222. Right before the end of pre-charge phase, the signal 310 (φ₄) to the switch 254 is set low to prepare the charge pump amplifier 250 for the read cycle.

During the read phase 336, the signals 304, 306 and 310 (φ₁, φ₂, φ₄) to the switches 260, 262 and 254 are set low. The signal 308 (φ₃) to the switch 264 is kept high to provide a charge transfer path from the drive circuit 202 to the charge-pump amplifier 250. A high enough voltage 312 (V_{RD}_{_{—}}_{TFT}) is applied to the programming voltage input 232 (V_{Data}) to minimize the channel resistance of the drive transistor 220. If the integration cycle is long enough, the accumulated charge on the capacitor 252 (Cᵢₙₜ) is not a function of integration time. Accordingly, the output voltage of the charge-pump amplifier 250 in this case is equal to:

$${V}_{out} = - \frac{{C}_{oled}}{{C}_{int}} ( {V}_{Data} - {V}_{th} )$$

For a shortened integration time, the accumulated charge on the capacitor 252 (Cᵢₙₜ) is given by:

$${Q}_{int} = {\int }^{{T}_{int}} {i}_{D} ( {V}_{GS} , {V}_{th} , μ ) \cdot d t$$

Consequently, the output voltage 256 of the charge-pump amplifier 250 at the end of read cycle equals:

$${V}_{out} = - \frac{1}{{C}_{int}} \cdot {\int }^{{T}_{int}} {i}_{D} ( {V}_{GS} , {V}_{th} , μ ) \cdot d t$$

Hence, the threshold voltage and the mobility of the drive transistor 220 may be extracted by reading the output voltage 256 of the amplifier 250 in the middle and at the end of the read phase 326.

FIG. 29B is a timing diagram for the reading process of the threshold turn-on voltage parameter of the OLED 222 in FIG. 28. The reading process of the OLED 222 also includes four phases, a reset phase 340, an integration phase 342, a pre-charge phase 344 and a read phase 346. Just like the reading process for the drive transistor 220 in FIG. 29A, the reading process for OLED starts by activating the select input 230 with a high select signal 302. The timing of the signals 304, 306, 308, and 310 (φ₁, φ₂, φ₃, φ₄) to the switches 260, 262, 264 and 254 is the same as the read process for the drive transistor 220 in FIG. 29A. A programming signal 332 for the programming input 232, a signal 334 for the node 244 and an output signal 336 for the output of the amplifier 250 are different from the signals in FIG. 29A.

During the reset phase 340, a high enough voltage level 332 (V_{RST}_{_{—}}_{OLED}) is applied to the programming data input 232 (V_{Data}) to maximize the current flow through the drive transistor 220. Consequently, the voltage at the node 244 in FIG. 28 is discharged to ground through the switch 260 to get ready for the next cycle.

During the integration phase 342, the signal 306 (φ₂) to the switch 262 stays high which provides a charging path from the voltage source 210 through the switch 262. The programming voltage input 232 (V_{Data}) is set to a voltage level 332 (V_{INT}_{_{—}}_{OLED}) such that once the capacitor 240 (C_{oled}) is fully charged, the voltage at the node 244 is greater than the turn-on voltage of the OLED 222. In this case, by the end of the integration phase 342, the drive transistor 220 is driving a constant current through the OLED 222.

During the pre-charge phase 344, the drive transistor 220 is turned off by the signal 332 to the programming input 232. The capacitor 240 (C_{oled}) is allowed to discharge until it reaches the turn-on voltage of OLED 222 by the end of the pre-charge phase 344.

During the read phase 346, a high enough voltage 332 (V_{INT}_{_{—}}_{OLED}) is applied to the programming voltage input 232 (V_{Data}) to minimize the channel resistance of the drive transistor 220. If the pre-charge phase is long enough, the settled voltage across the capacitor 252 (Cᵢₙₜ) will not be a function of pre-charge time. Consequently, the output voltage 256 of the charge-pump amplifier 250 at the end of the read phase is given by:

$${V}_{out} = - \frac{{C}_{oled}}{{C}_{int}} \cdot {V}_{ON , oled}$$

The signal 308 (φ₃) to the switch 264 is kept high to provide a charge transfer path from the drive circuit 202 to the charge-pump amplifier 250. Thus the output voltage signal 336 may be used to determine the turn-on voltage of the OLED 220.

FIG. 29C is a timing diagram for the direct reading of the drive transistor 220 using the extraction circuit 200 in FIG. 28. The direct reading process has a reset phase 350, a pre-charge phase 352 and an integrate/read phase 354. The readout process is initiated by activating the select input 230 in FIG. 28. The select signal 302 to the select input 230 is kept high throughout the readout process as shown in FIG. 29C. The signals 364 and 366 (φ₁, φ₂) for the switches 260 and 262 are inactive in this readout process.

During the reset phase 350, the signals 368 and 370 (φ₃, φ₄) for the switches 264 and 254 are set high in order to provide a discharge path to virtual ground. A high enough voltage 372 (V_{RST}_{_{—}}_{TFT}) is applied to the programming input 232 (V_{Data}) to maximize the current flow through the drive transistor 220. Consequently, the node 244 is discharged to the common-mode voltage 374 (VCM_{RST}) to get ready for the next cycle.

During the pre-charge phase 354, the drive transistor 220 is turned off by applying an off voltage 372 (V_{OFF}) to the programming input 232 in FIG. 28. The common-mode voltage input 258 to the positive input of the amplifier 250 is raised to VCM_{RD} in order to precharge the line capacitance. At the end of the pre-charge phase 354, the signal 370 (φ₄) to the switch 254 is turned off to prepare the charge-pump amplifier 250 for the next cycle.

At the beginning of the read/integrate phase 356, the programming voltage input 232 (V_{Data}) is raised to V_{INT}_{_{—}}_{TFT} 372 to turn the drive transistor 220 on. The capacitor 240 (C_{OLED}) starts to accumulate the charge until V_{Data} minus the voltage at the node 244 is equal to the threshold voltage of the drive transistor 220. In the meantime, a proportional charge is accumulated in the capacitor 252 (C_{INT}). Accordingly, at the end of the read cycle 356, the output voltage 376 at the output 256 of the amplifier 250 is a function of the threshold voltage which is given by:

$${V}_{out} = \frac{{C}_{oled}}{{C}_{int}} \cdot ( {V}_{Data} - {V}_{th} )$$

As indicated by the above equation, in the case of the direct reading, the output voltage has a positive polarity. Thus, the threshold voltage of the drive transistor 220 may be determined by the output voltage of the amplifier 250.

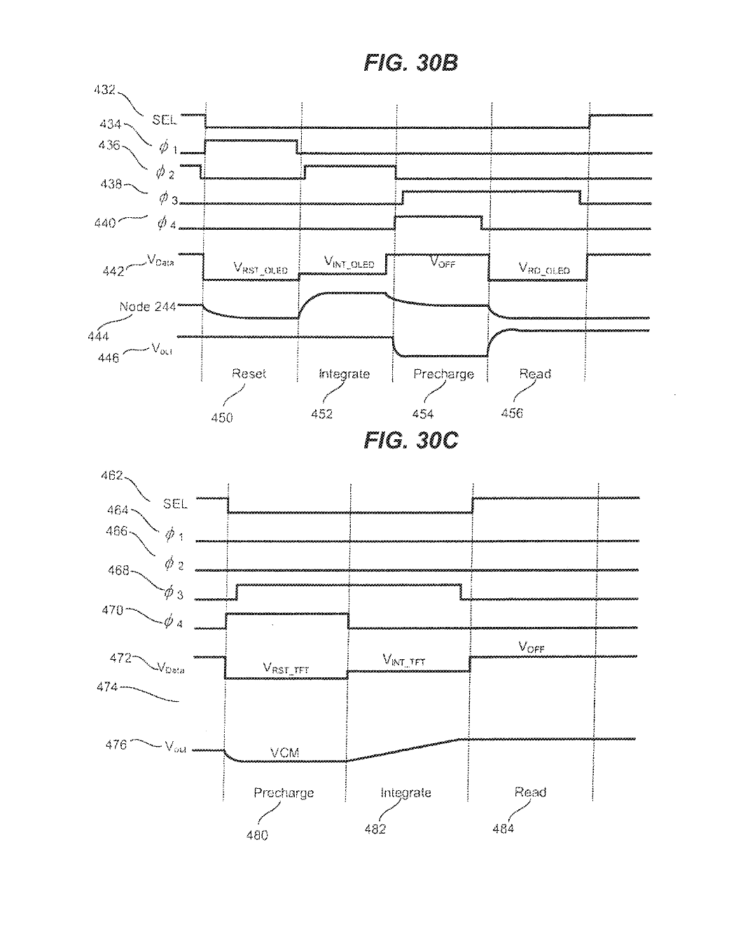

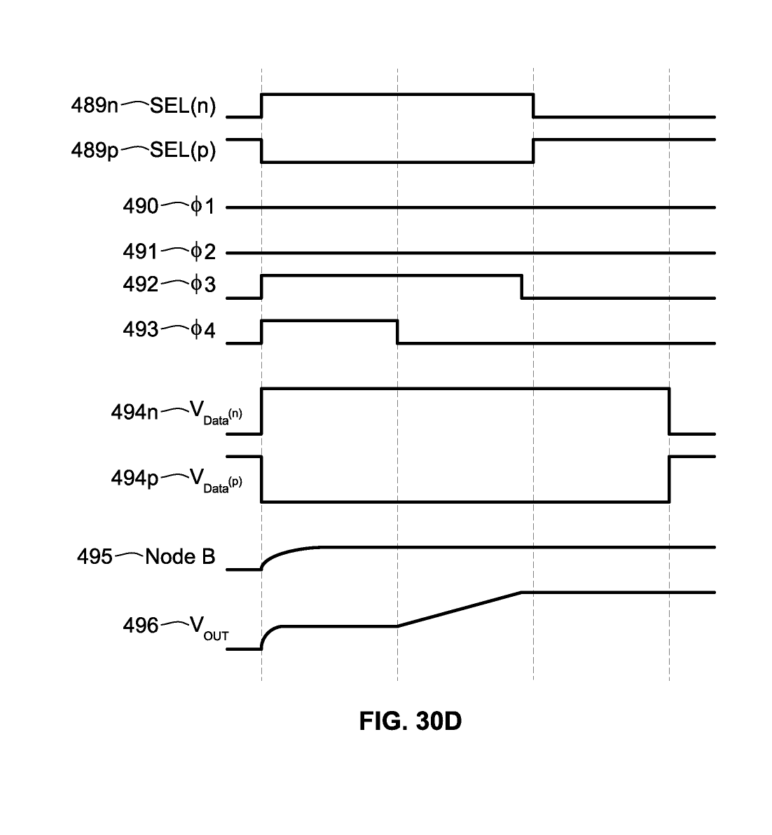

As explained above, the drive transistor 220 in FIG. 28 may be a p-type transistor. FIG. 30A-4C are signal timing diagrams of the signals applied to the components in FIG. 28 to extract voltage threshold and mobility from the drive transistor 220 and the OLED 222 when the drive transistor 220 is a p-type transistor. In the example where the drive transistor 220 is a p-type transistor, the source of the drive transistor 220 is coupled to the supply line 212 (VD) and the drain of the drive transistor 220 is coupled to the OLED 222. FIG. 30A is a timing diagram showing the signals applied to the extraction circuit 200 to extract the threshold voltage and mobility from the drive transistor 220 when the drive transistor 220 is a p-type transistor. FIG. 30A shows voltage signals 402-416 for the select input 232, the switches 260, 262, 264 and 254, the programming data input 230, the voltage at the node 244 and the output voltage 256 in FIG. 28. The data extraction is performed in three phases, a reset phase 420, an integrate/pre-charge phase 422, and a read phase 424.

As shown in FIG. 30A, the select signal 402 is active low and kept low throughout the readout phases 420, 422 and 424. Throughout the readout process, the signals 404 and 406 (φ₁, φ₂) to the switches 260 and 262 are kept low (inactive). During the reset phase, the signals 408 and 410 (φ₃, φ₄) at the switches 264 and 254 are set to high in order to charge the node 244 to a reset common mode voltage level VCMᵣₛₜ. The common-mode voltage input 258 on the charge-pump input 258 (VCMᵣₛₜ) should be low enough to keep the OLED 222 off. The programming data input 232 V_{Data} is set to a low enough value 412 (V_{RST}_{_{—}}_{TFT}) to provide maximum charging current through the driver transistor 220.

During the integrate/pre-charge phase 422, the common-mode voltage on the common voltage input 258 is reduced to VCMᵢₙₜ and the programming input 232 (V_{Data}) is increased to a level 412 (V_{INT}_{_{—}}_{TFT}) such that the drive transistor 220 will conduct in the reverse direction. If the allocated time for this phase is long enough, the voltage at the node 244 will decline until the gate to source voltage of the drive transistor 220 reaches the threshold voltage of the drive transistor 220. Before the end of this cycle, the signal 410 (φ₄) to the switch 254 goes low in order to prepare the charge-pump amplifier 250 for the read phase 424.

The read phase 424 is initiated by decreasing the signal 412 at the programming input 232 (V_{Data}) to V_{RD}_{_{—}}_{TFT} so as to turn the drive transistor 220 on. The charge stored on the capacitor 240 (C_{OLED}) is now transferred to the capacitor 254 (C_{INT}). At the end of the read phase 424, the signal 408 (φ₃) to the switch 264 is set to low in order to isolate the charge-pump amplifier 250 from the drive circuit 202. The output voltage signal 416 Vₒᵤₜ from the amplifier output 256 is now a function of the threshold voltage of the drive transistor 220 given by:

$${V}_{out} = - \frac{{C}_{oled}}{{C}_{int}} ( {V}_{INT\_TFT} - {V}_{th} )$$

FIG. 30B is a timing diagram for the in-pixel extraction of the threshold voltage of the OLED 222 in FIG. 28 assuming that the drive transistor 220 is a p-type transistor. The extraction process is very similar to the timing of signals to the extraction circuit 200 for an n-type drive transistor in FIG. 29A. FIG. 30B shows voltage signals 432-446 for the select input 230, the switches 260, 262, 264 and 254, the programming data input 232, the voltage at the node 244 and the amplifier output 256 in FIG. 28. The extraction process includes a reset phase 450, an integration phase 452, a pre-charge phase 454 and a read phase 456. The major difference in this readout cycle in comparison to the readout cycle in FIG. 30A is the voltage levels of the signal 442 to the programming data input 232 (V_{Data}) that are applied to the driver circuit 210 in each readout phase. For a p-type thin film transistor that may be used for the drive transistor 220, the select signal 430 to the select input 232 is active low. The select input 232 is kept low throughout the readout process as shown in FIG. 30B.

The readout process starts by first resetting the capacitor 240 (C_{OLED}) in the reset phase 450. The signal 434 (φ₁) to the switch 260 is set high to provide a discharge path to ground. The signal 442 to the programming input 232 (V_{Data}) is lowered to V_{RST}_{_{—}}_{OLED} in order to turn the drive transistor 220 on.

In the integrate phase 452, the signals 434 and 436 (φ₁, φ₂) to the switches 260 and 262 are set to off and on states respectively, to provide a charging path to the OLED 222. The capacitor 240 (C_{OLED}) is allowed to charge until the voltage 444 at node 244 goes beyond the threshold voltage of the OLED 222 to turn it on. Before the end of the integration phase 452, the voltage signal 442 to the programming input 232 (V_{Data}) is raised to V_{OFF} to turn the drive transistor 220 off.

During the pre-charge phase 454, the accumulated charge on the capacitor 240 (C_{OLED}) is discharged into the OLED 222 until the voltage 444 at the node 244 reaches the threshold voltage of the OLED 222. Also, in the pre-charge phase 454, the signals 434 and 436 (φ₁, φ₂) to the switches 260 and 262 are turned off while the signals 438 and 440 (φ₃, φ₄) to the switches 264 and 254 are set on. This provides the condition for the amplifier 250 to precharge the supply line 212 (VD) to the common mode voltage input 258 (VCM) provided at the positive input of the amplifier 250. At the end of the pre-charge phase, the signal 430 (φ₄) to the switch 254 is turned off to prepare the charge-pump amplifier 250 for the read phase 456.

The read phase 456 is initiated by turning the drive transistor 220 on when the voltage 442 to the programming input 232 (V_{Data}) is lowered to V_{RD}_{_{—}}_{OLED}. The charge stored on the capacitor 240 (C_{OLED}) is now transferred to the capacitor 254 (C_{INT}) which builds up the output voltage 446 at the output 256 of the amplifier 250 as a function of the threshold voltage of the OLED 220.

FIG. 30C is a signal timing diagram for the direct extraction of the threshold voltage of the drive transistor 220 in the extraction system 200 in FIG. 28 when the drive transistor 220 is a p-type transistor. FIG. 30C shows voltage signals 462-476 for the select input 230, the switches 260, 262, 264 and 254, the programming data input 232, the voltage at the node 244 and the output voltage 256 in FIG. 28. The extraction process includes a pre-charge phase 480 and an integration phase 482. However, in the timing diagram in FIG. 30C, a dedicated final read phase 484 is illustrated which may be eliminated if the output of charge-pump amplifier 250 is sampled at the end of the integrate phase 482.

The extraction process is initiated by simultaneous pre-charging of the drain storage capacitor 224, the source storage capacitor 226, the capacitor 240 (C_{OLED}) and the capacitor 242 in FIG. 28. For this purpose, the signals 462, 468 and 470 to the select line input 230 and the switches 264 and 254 are activated as shown in FIG. 30C. Throughout the readout process, the signals 404 and 406 (φ₁, φ₂) to the switches 260 and 262 are kept low. The voltage level of common mode voltage input 258 (VCM) determines the voltage on the supply line 212 and hence the voltage at the node 244. The common mode voltage (VCM) should be low enough such that the OLED 222 does not turn on. The voltage 472 to the programming input 232 (V_{Data}) is set to a level (V_{RST}_{_{—}}_{TFT}) low enough to turn the transistor 220 on.

At the beginning of the integrate phase 482, the signal 470 (φ₄) to the switch 254 is turned off in order to allow the charge-pump amplifier 250 to integrate the current through the drive transistor 220. The output voltage 256 of the charge-pump amplifier 250 will incline at a constant rate which is a function of the threshold voltage of the drive transistor 220 and its gate-to-source voltage. Before the end of the integrate phase 482, the signal 468 (φ₃) to the switch 264 is turned off to isolate the charge-pump amplifier 250 from the driver circuit 220. Accordingly, the output voltage 256 of the amplifier 250 is given by:

$${V}_{out} = {I}_{TFT} \cdot \frac{{T}_{int}}{{C}_{int}}$$

where I_{TFT} is the drain current of the drive transistor 220 which is a function of the mobility and (V_{CM}−V_{Data}−|Vₜₕ|). Tᵢₙₜ is the length of the integration time. In the optional read phase 484, the signal 468 (φ₃) to the switch 264 is kept low to isolate the charge-pump amplifier 250 from the driver circuit 202. The output voltage 256, which is a function of the mobility and threshold voltage of the drive transistor 220, may be sampled any time during the read phase 484.

FIG. 30D is a timing diagram for the direct reading of the OLED 222 in FIG. 28. When the drive transistor 220 is turned on with a high enough gate-to-source voltage it may be utilized as an analog switch to access the anode terminal of the OLED 222. In this case, the voltage at the node 244 is essentially equal to the voltage on the supply line 212 (VD). Accordingly, the drive current through the drive transistor 220 will only be a function of the turn-on voltage of the OLED 222 and the voltage that is set on the supply line 212. The drive current may be provided by the charge-pump amplifier 250. When integrated over a certain time period, the output voltage 256 of the integrator circuit 206 is a measure of how much the OLED 222 has aged.

FIG. 30D is a timing diagram showing the signals applied to the extraction circuit 200 to extract the turn-on voltage from the OLED 222 via a direct read. FIG. 30D shows the three phases of the readout process, a pre-charge phase 486, an integrate phase 487 and a read phase 488. FIG. 30D includes a signal 489n or 489p for the select input 230 in FIG. 28, a signal 490 (φ₁) to the switch 260, a signal 491 (φ₂) for the switch 262, a signal 492 (φ₃) for the switch 264, a signal 493 (φ₄) for the switch 254, a programming voltage signal 494n or 494p for the programming data input 232 in FIG. 28, a voltage 495 of the node 244 in FIG. 28 and an output voltage signal 496 for the output 256 of the amplifier 250 in FIG. 28.

The process starts by activating the select signal corresponding to the desired row of pixels in array 102. As illustrated in FIG. 30D, the select signal 489n is active high for an n-type select transistor and active low for a p-type select transistor. A high select signal 489n is applied to the select input 230 in the case of an n-type drive transistor. A low signal 489p is applied to the select input 230 in the case of a p-type drive transistor for the drive transistor 220.

The select signal 489n or 489p will be kept active during the pre-charge and integrate cycles 486 and 487. The φ₁ and φ₂ inputs 490 and 491 are inactive in this readout method. During the pre-charge cycle, the switch signals 492 φ₃ and 493 φ₄ are set high in order to provide a signal path such that the parasitic capacitance 242 of the supply line (Cₚ) and the voltage at the node 244 are pre-charged to the common-mode voltage (VCM_{OLED}) provided to the non-inverting terminal of the amplifier 250. A high enough drive voltage signal 494n or 494p (V_{ON}_{_{—}}_{nTFT} or V_{ON}_{_{—}}_{pTFT}) is applied to the data input 232 (V_{Data}) to operate the drive transistor 220 as an analog switch. Consequently, the supply voltage 212 VD and the node 244 are pre-charged to the common-mode voltage (VCM_{OLED}) to get ready for the next cycle. At the beginning of the integrate phase 487, the switch input 493 φ₄ is turned off in order to allow the charge-pump module 206 to integrate the current of the OLED 222. The output voltage 496 of the charge-pump module 206 will incline at a constant rate which is a function of the turn-on voltage of the OLED 222 and the voltage 495 set on the node 244, i.e. VCM_{OLED}. Before the end of the integrate phase 487, the switch signal 492 φ₃ is turned off to isolate the charge-pump module 206 from the pixel circuit 202. From this instant beyond, the output voltage is constant until the charge-pump module 206 is reset for another reading. When integrated over a certain time period, the output voltage of the integrator is given by:

$${V}_{out} = {I}_{OLED} \frac{{T}_{int}}{{C}_{int}}$$

which is a measure of how much the OLED has aged. Tᵢₙₜ in this equation is the time interval between the falling edge of the switch signal 493 (φ₄) to the falling edge of the switch signal 492 (φ₃).

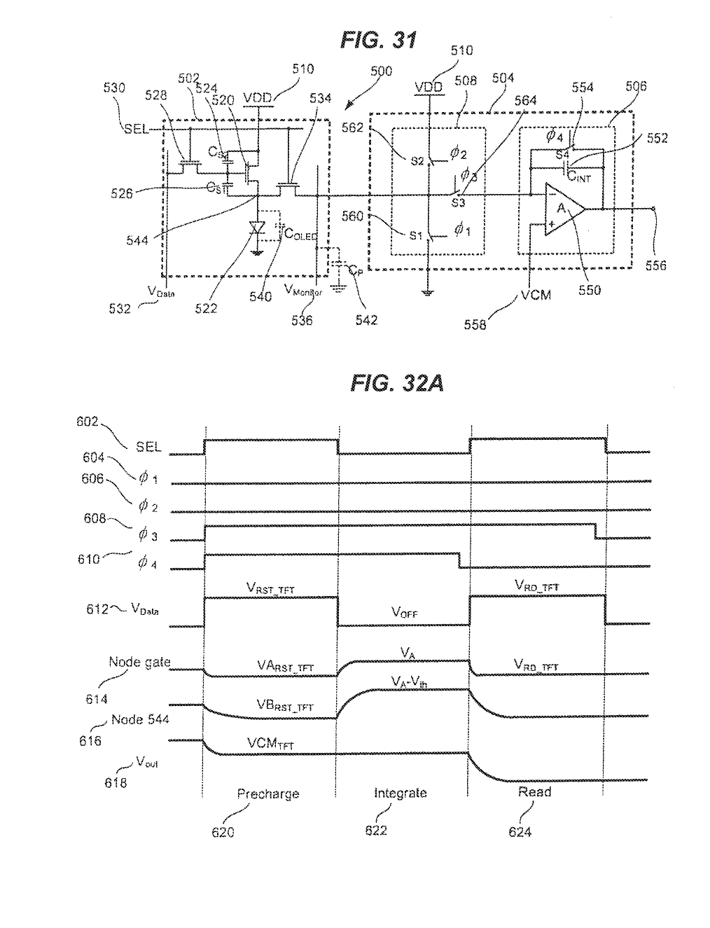

Similar extraction processes of a two transistor type driver circuit such as that in FIG. 28 may be utilized to extract non-uniformity and aging parameters such as threshold voltages and mobility of a three transistor type driver circuit as part of the data extraction system 500 as shown in FIG. 31. The data extraction system 500 includes a drive circuit 502 and a readout circuit 504. The readout circuit 504 is part of the current supply and readout circuit 120 and gathers data from a column of pixels 104 as shown in FIG. 27 and includes a charge pump circuit 506 and a switch-box circuit 508. A voltage source 510 provides the supply voltage (VDD) to the drive circuit 502. The charge-pump and switch-box circuits 506 and 508 are implemented on the top or bottom side of the array 102 such as in the voltage drive 114 and the current supply and readout circuit 120 in FIG. 27. This is achieved by either direct fabrication on the same substrate as for the array 102 or by bonding a microchip on the substrate or a flex as a hybrid solution.

The drive circuit 502 includes a drive transistor 520, an organic light emitting device 522, a drain storage capacitor 524, a source storage capacitor 526 and a select transistor 528. A select line input 530 is coupled to the gate of the select transistor 528. A programming input 532 is coupled through the select transistor 528 to the gate of the drive transistor 220. The select line input 530 is also coupled to the gate of an output transistor 534. The output transistor 534 is coupled to the source of the drive transistor 520 and a voltage monitoring output line 536. The drain of the drive transistor 520 is coupled to the supply voltage source 510 and the source of the drive transistor 520 is coupled to the OLED 522. The source storage capacitor 526 is coupled between the gate and the source of the drive transistor 520. The drain storage capacitor 524 is coupled between the gate and the drain of the drive transistor 520. The OLED 522 has a parasitic capacitance that is modeled as a capacitor 540. The monitor output voltage line 536 also has a parasitic capacitance that is modeled as a capacitor 542. The drive transistor 520 in this example is a thin film transistor that is fabricated from amorphous silicon. A voltage node 544 is the point between the source terminal of the drive transistor 520 and the OLED 522. In this example, the drive transistor 520 is an n-type transistor. The system 500 may be implemented with a p-type drive transistor in place of the drive transistor 520.

The readout circuit 504 includes the charge-pump circuit 506 and the switch-box circuit 508. The charge-pump circuit 506 includes an amplifier 550 which has a capacitor 552 (Cᵢₙₜ) in a negative feedback loop. A switch 554 (S4) is utilized to discharge the capacitor 552 Cᵢₙₜ during the pre-charge phase. The amplifier 550 has a negative input coupled to the capacitor 552 and the switch 554 and a positive input coupled to a common mode voltage input 558 (VCM). The amplifier 550 has an output 556 that is indicative of various extracted factors of the drive transistor 520 and OLED 522 as will be explained below.

The switch-box circuit 508 includes several switches 560, 562 and 564 to direct the current to and from the drive circuit 502. The switch 560 is used during the reset phase to provide the discharge path to ground. The switch 562 provides the supply connection during normal operation of the pixel 104 and also during the integration phase of the readout process. The switch 564 is used to isolate the charge-pump circuit 506 from the supply line voltage source 510.

In the three transistor drive circuit 502, the readout is normally performed through the monitor line 536. The readout can also be taken through the voltage supply line from the supply voltage source 510 similar to the process of timing signals in FIG. 29A-3C. Accurate timing of the input signals (φ₁-φ₄) to the switches 560, 562, 564 and 554, the select input 530 and the programming voltage input 532 (V_{Data}) is used to control the performance of the readout circuit 500. Certain voltage levels are applied to the programming data input 532 (V_{Data}) and the common mode voltage input 558 (VCM) during each phase of readout process.

The three transistor drive circuit 502 may be programmed differentially through the programming voltage input 532 and the monitoring output 536. Accordingly, the reset and pre-charge phases may be merged together to form a reset/pre-charge phase and which is followed by an integrate phase and a read phase.

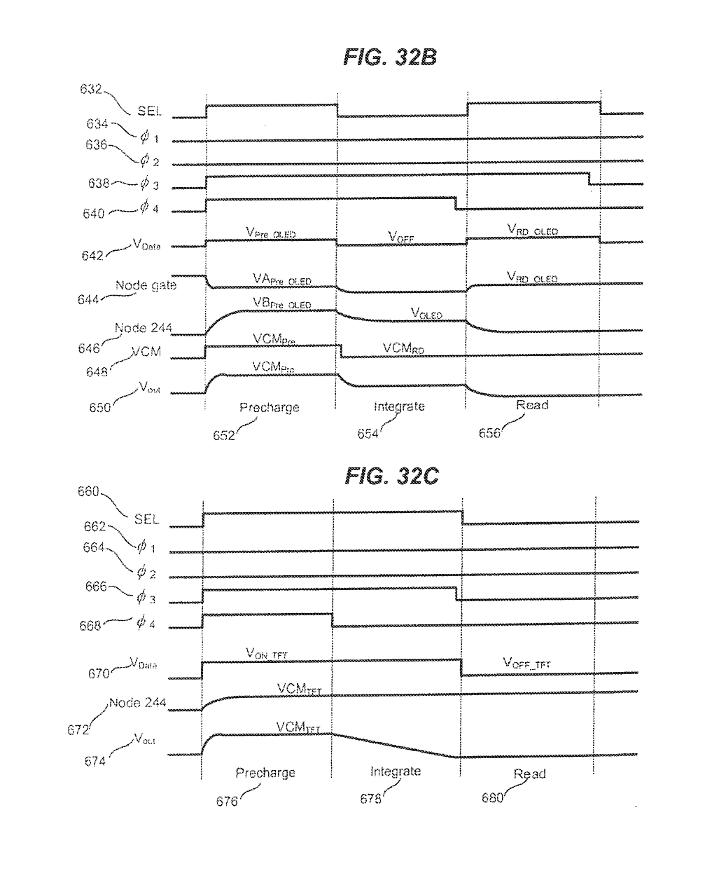

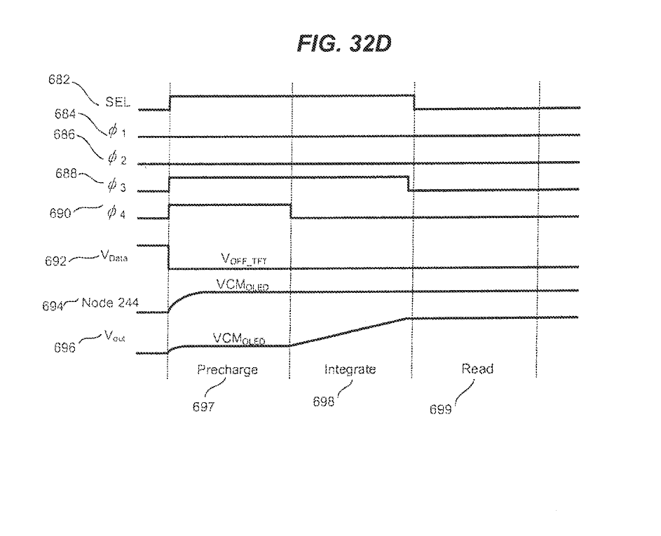

FIG. 32A is a timing diagram of the signals involving the extraction of the threshold voltage and mobility of the drive transistor 520 in FIG. 31. The timing diagram includes voltage signals 602-618 for the select input 530, the switches 560, 562, 564 and 554, the programming voltage input 532, the voltage at the gate of the drive transistor 520, the voltage at the node 544 and the output voltage 556 in FIG. 31. The readout process in FIG. 32A has a pre-charge phase 620, an integrate phase 622 and a read phase 624. The readout process initiates by simultaneous precharging of the drain capacitor 524, the source capacitor 526, and the parasitic capacitors 540 and 542. For this purpose, the select line voltage 602 and the signals 608 and 610 (φ₃, φ₄) to the switches 564 and 554 are activated as shown in FIG. 32A. The signals 604 and 606 (φ₁, φ₂) to the switches 560 and 562 remain low throughout the readout cycle.

The voltage level of the common mode input 558 (VCM) determines the voltage on the output monitor line 536 and hence the voltage at the node 544. The voltage to the common mode input 558 (VCM_{TFT}) should be low enough such that the OLED 522 does not turn on. In the pre-charge phase 620, the voltage signal 612 to the programming voltage input 532 (V_{Data}) is high enough (V_{RST}_{_{—}}_{TFT}) to turn the drive transistor 520 on, and also low enough such that the OLED 522 always stays off.

At the beginning of the integrate phase 622, the voltage 602 to the select input 530 is deactivated to allow a charge to be stored on the capacitor 540 (C_{OLED}). The voltage at the node 544 will start to rise and the gate voltage of the drive transistor 520 will follow that with a ratio of the capacitance value of the source capacitor 526 over the capacitance of the source capacitor 526 and the drain capacitor 524 [C_{S1}/(C_{S1}+C_{S2})]. The charging will complete once the difference between the gate voltage of the drive transistor 520 and the voltage at node 544 is equal to the threshold voltage of the drive transistor 520. Before the end of the integration phase 622, the signal 610 (φ₄) to the switch 554 is turned off to prepare the charge-pump amplifier 550 for the read phase 624.

For the read phase 624, the signal 602 to the select input 530 is activated once more. The voltage signal 612 on the programming input 532 (V_{RD}_{_{—}}_{TFT}) is low enough to keep the drive transistor 520 off. The charge stored on the capacitor 240 (C_{OLED}) is now transferred to the capacitor 254 (C_{INT}) and creates an output voltage 618 proportional to the threshold voltage of the drive transistor 520:

$${V}_{out} = - \frac{{C}_{oled}}{{C}_{int}} ( {V}_{G} - {V}_{th} )$$

Before the end of the read phase 624, the signal 608 (φ₃) to the switch 564 turns off to isolate the charge-pump circuit 506 from the drive circuit 502.

FIG. 32B is a timing diagram for the input signals for extraction of the turn-on voltage of the OLED 522 in FIG. 31. FIG. 32B includes voltage signals 632-650 for the select input 530, the switches 560, 562, 564 and 554, the programming voltage input 532, the voltage at the gate of the drive transistor 520, the voltage at the node 544, the common mode voltage input 558, and the output voltage 556 in FIG. 31. The readout process in FIG. 32B has a pre-charge phase 652, an integrate phase 654 and a read phase 656. Similar to the readout for the drive transistor 220 in FIG. 32A, the readout process starts with simultaneous precharging of the drain capacitor 524, the source capacitor 526, and the parasitic capacitors 540 and 542 in the pre-charge phase 652. For this purpose, the signal 632 to the select input 530 and the signals 638 and 640 (φ₃, φ₄) to the switches 564 and 554 are activated as shown in FIG. 32B. The signals 634 and 636 (φ₁, φ₂) remain low throughout the readout cycle. The input voltage 648 (VCM_{Pre}) to the common mode voltage input 258 should be high enough such that the OLED 522 is turned on. The voltage 642 (V_{Pre}_{_{—}}_{OLED}) to the programming input 532 (V_{Data}) is low enough to keep the drive transistor 520 off.

At the beginning of the integrate phase 654, the signal 632 to the select input 530 is deactivated to allow a charge to be stored on the capacitor 540 (C_{OLED}). The voltage at the node 544 will start to fall and the gate voltage of the drive transistor 520 will follow with a ratio of the capacitance value of the source capacitor 526 over the capacitance of the source capacitor 526 and the drain capacitor 524 [C_{S1}/(C_{S1}+C_{S2})]. The discharging will complete once the voltage at node 544 reaches the ON voltage (V_{OLED}) of the OLED 522. Before the end of the integration phase 654, the signal 640 (φ₄) to the switch 554 is turned off to prepare the charge-pump circuit 506 for the read phase 656.

For the read phase 656, the signal 632 to the select input 530 is activated once more. The voltage 642 on the (V_{RD}_{_{—}}_{OLED}) programming input 532 should be low enough to keep the drive transistor 520 off. The charge stored on the capacitor 540 (C_{OLED}) is then transferred to the capacitor 552 (C_{INT}) creating an output voltage 650 at the amplifier output 556 proportional to the ON voltage of the OLED 522.

$${V}_{out} = - \frac{{C}_{oled}}{{C}_{int}} \cdot {V}_{ON , oled}$$

The signal 638 (φ₃) turns off before the end of the read phase 656 to isolate the charge-pump circuit 508 from the drive circuit 502.

As shown, the monitor output transistor 534 provides a direct path for linear integration of the current for the drive transistor 520 or the OLED 522. The readout may be carried out in a pre-charge and integrate cycle. However, FIG. 32C shows timing diagrams for the input signals for an additional final read phase which may be eliminated if the output of charge-pump circuit 508 is sampled at the of the integrate phase. FIG. 32C includes voltage signals 660-674 for the select input 530, the switches 560, 562, 564 and 554, the programming voltage input 532, the voltage at the node 544, and the output voltage 556 in FIG. 31. The readout process in FIG. 32C therefore has a pre-charge phase 676, an integrate phase 678 and an optional read phase 680.

The direct integration readout process of the n-type drive transistor 520 in FIG. 31 as shown in FIG. 32C is initiated by simultaneous precharging of the drain capacitor 524, the source capacitor 526, and the parasitic capacitors 540 and 542. For this purpose, the signal 660 to the select input 530 and the signals 666 and 668 (φ₃, φ₄) to the switches 564 and 554 are activated as shown in FIG. 32C. The signals 662 and 664 (φ₁, φ₂) to the switches 560 and 562 remain low throughout the readout cycle. The voltage level of the common mode voltage input 558 (VCM) determines the voltage on the monitor output line 536 and hence the voltage at the node 544. The voltage signal (VCM_{TFT}) of the common mode voltage input 558 is low enough such that the OLED 522 does not turn on. The signal 670 (V_{ON}_{_{—}}_{TFT}) to the programming input 532 (V_{Data}) is high enough to turn the drive transistor 520 on.

At the beginning of the integrate phase 678, the signal 668 (φ₄) to the switch 554 is turned off in order to allow the charge-pump amplifier 550 to integrate the current from the drive transistor 520. The output voltage 674 of the charge-pump amplifier 550 declines at a constant rate which is a function of the threshold voltage, mobility and the gate-to-source voltage of the drive transistor 520. Before the end of the integrate phase, the signal 666 (φ₃) to the switch 564 is turned off to isolate the charge-pump circuit 508 from the drive circuit 502. Accordingly, the output voltage is given by:

$${V}_{out} = - {I}_{TFT} \cdot \frac{{T}_{int}}{{C}_{int}}$$

where I_{TFT} is the drain current of drive transistor 520 which is a function of the mobility and (V_{Data}−V_{CM}−Vₜₕ). Tᵢₙₜ is the length of the integration time. The output voltage 674, which is a function of the mobility and threshold voltage of the drive transistor 520, may be sampled any time during the read phase 680.

FIG. 32D shows a timing diagram of input signals for the direct reading of the on (threshold) voltage of the OLED 522 in FIG. 31. FIG. 32D includes voltage signals 682-696 for the select input 530, the switches 560, 562, 564 and 554, the programming voltage input 532, the voltage at the node 544, and the output voltage 556 in FIG. 31. The readout process in FIG. 32C has a pre-charge phase 697, an integrate phase 698 and an optional read phase 699.

The readout process in FIG. 32D is initiated by simultaneous precharging of the drain capacitor 524, the source capacitor 526, and the parasitic capacitors 540 and 542. For this purpose, the signal 682 to the select input 530 and the signals 688 and 690 (φ₃, φ₄) to the switches 564 and 554 are activated as shown in FIG. 32D. The signals 684 and 686 (φ₁, φ₂) remain low throughout the readout cycle. The voltage level of the common mode voltage input 558 (VCM) determines the voltage on the monitor output line 536 and hence the voltage at the node 544. The voltage signal (VCM_{OLED}) of the common mode voltage input 558 is high enough such to turn the OLED 522 on. The signal 692 (V_{OFF}_{_{—}}_{TFT}) of the programming input 532 (V_{Data}) is low enough to keep the drive transistor 520 off.

At the beginning of the integrate phase 698, the signal 690 (φ₄) to the switch 552 is turned off in order to allow the charge-pump amplifier 550 to integrate the current from the OLED 522. The output voltage 696 of the charge-pump amplifier 550 will incline at a constant rate which is a function of the threshold voltage and the voltage across the OLED 522.

Before the end of the integrate phase 698, the signal 668 (φ₃) to the switch 564 is turned off to isolate the charge-pump circuit 508 from the drive circuit 502. Accordingly, the output voltage is given by:

$${V}_{out} = {I}_{OLED} \cdot \frac{{T}_{int}}{{C}_{int}}$$

where I_{OLED} is the OLED current which is a function of (V_{CM}−Vₜₕ), and Tᵢₙₜ is the length of the integration time. The output voltage, which is a function of the threshold voltage of the OLED 522, may be sampled any time during the read phase 699.

The controller 112 in FIG. 27 may be conveniently implemented using one or more general purpose computer systems, microprocessors, digital signal processors, micro-controllers, application specific integrated circuits (ASIC), programmable logic devices (PLD), field programmable logic devices (FPLD), field programmable gate arrays (FPGA) and the like, programmed according to the teachings as described and illustrated herein, as will be appreciated by those skilled in the computer, software and networking arts.

In addition, two or more computing systems or devices may be substituted for any one of the controllers described herein. Accordingly, principles and advantages of distributed processing, such as redundancy, replication, and the like, also can be implemented, as desired, to increase the robustness and performance of controllers described herein. The controllers may also be implemented on a computer system or systems that extend across any network environment using any suitable interface mechanisms and communications technologies including, for example telecommunications in any suitable form (e.g., voice, modem, and the like), Public Switched Telephone Network (PSTNs), Packet Data Networks (PDNs), the Internet, intranets, a combination thereof, and the like.

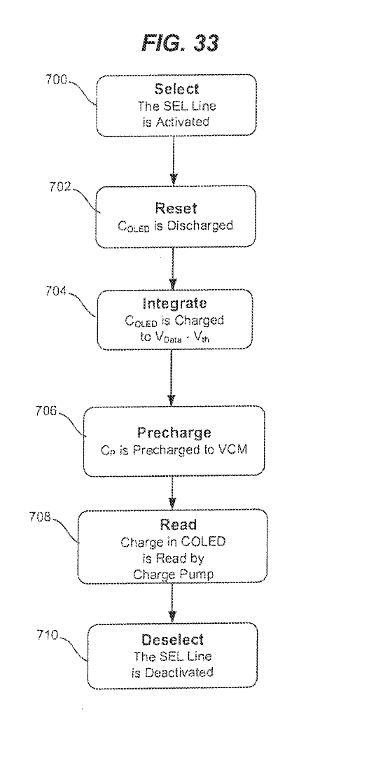

The operation of the example data extraction process, will now be described with reference to the flow diagram shown in FIG. 33. The flow diagram in FIG. 33 is representative of example machine readable instructions for determining the threshold voltages and mobility of a simple driver circuit that allows maximum aperture for a pixel 104 in FIG. 27. In this example, the machine readable instructions comprise an algorithm for execution by: (a) a processor, (b) a controller, and/or (c) one or more other suitable processing device(s). The algorithm may be embodied in software stored on tangible media such as, for example, a flash memory, a CD-ROM, a floppy disk, a hard drive, a digital video (versatile) disk (DVD), or other memory devices, but persons of ordinary skill in the art will readily appreciate that the entire algorithm and/or parts thereof could alternatively be executed by a device other than a processor and/or embodied in firmware or dedicated hardware in a well known manner (e.g., it may be implemented by an application specific integrated circuit (ASIC), a programmable logic device (PLD), a field programmable logic device (FPLD), a field programmable gate array (FPGA), discrete logic, etc.). For example, any or all of the components of the extraction sequence could be implemented by software, hardware, and/or firmware. Also, some or all of the machine readable instructions represented by the flowchart of FIG. 33 may be implemented manually. Further, although the example algorithm is described with reference to the flowchart illustrated in FIG. 33, persons of ordinary skill in the art will readily appreciate that many other methods of implementing the example machine readable instructions may alternatively be used. For example, the order of execution of the blocks may be changed, and/or some of the blocks described may be changed, eliminated, or combined.

A pixel 104 under study is selected by turning the corresponding select and programming lines on (700). Once the pixel 104 is selected, the readout is performed in four phases. The readout process begins by first discharging the parasitic capacitance across the OLED (C_{oled}) in the reset phase (702). Next, the drive transistor is turned on for a certain amount of time which allows some charge to be accumulated on the capacitance across the OLED C_{oled} (704). In the integrate phase, the select transistor is turned off to isolate the charge on the capacitance across the OLED C_{oled} and then the line parasitic capacitance (C_{P}) is precharged to a known voltage level (706). Finally, the drive transistor is turned on again to allow the charge on the capacitance across the OLED C_{oled} to be transferred to the charge-pump amplifier output in a read phase (708). The amplifier's output represent a quantity which is a function of mobility and threshold voltage. The readout process is completed by deselecting the pixel to prevent interference while other pixels are being calibrated (710).

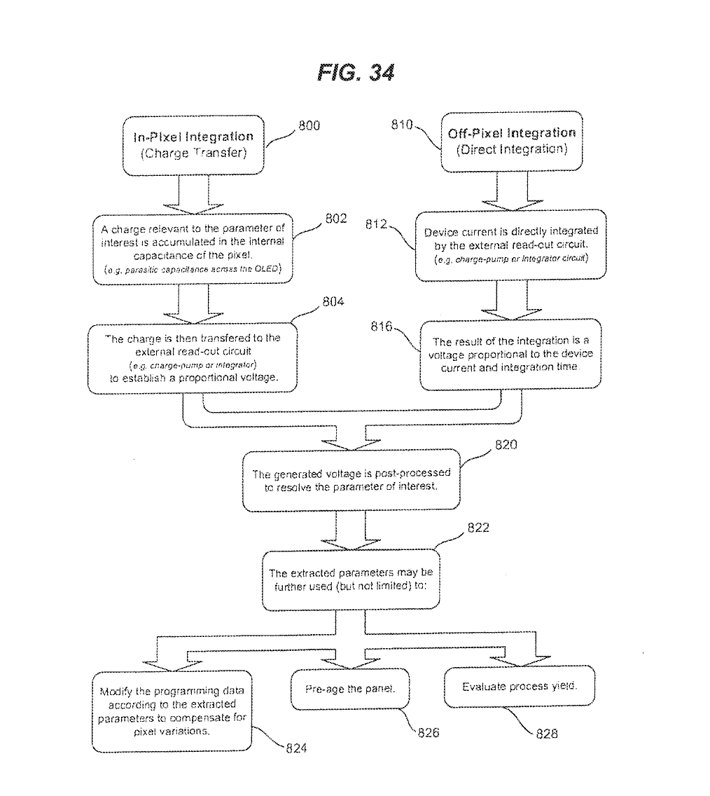

FIG. 34 is a flow diagram of different extraction cycles and parameter applications for pixel circuits such as the two transistor circuit in FIG. 28 and the three transistor circuit in FIG. 31. One process is an in-pixel integration that involves charge transfer (800). A charge relevant to the parameter of interest is accumulated in the internal capacitance of the pixel (802). The charge is then transferred to the external read-out circuit such as the charge-pump or integrator to establish a proportional voltage (804). Another process is an off-pixel integration or direct integration (810). The device current is directly integrated by the external read-out circuit such as the charge-pump or integrator circuit (812).

In both processes, the generated voltage is post-processed to resolve the parameter of interest such as threshold voltage or mobility of the drive transistor or the turn-on voltage of the OLED (820). The extracted parameters may be then used for various applications (822). Examples of using the parameters include modifying the programming data according to the extracted parameters to compensate for pixel variations (824). Another example is to pre-age the panel of pixels (826). Another example is to evaluate the process yield of the panel of pixels after fabrication (828).

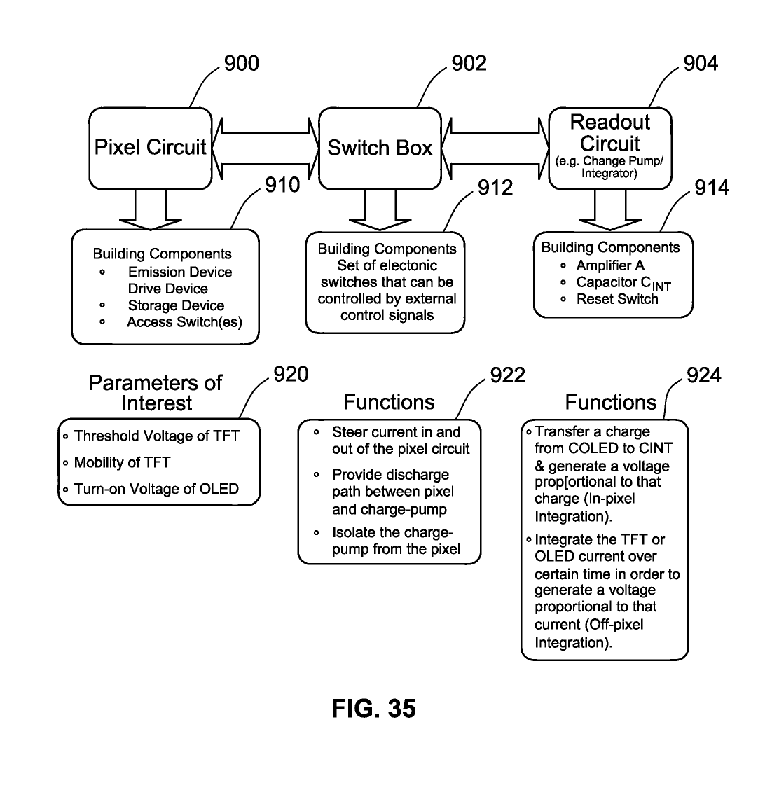

FIG. 35 is a block diagram and chart of the components of a data extraction system that includes a pixel circuit 900, a switch box 902 and a readout circuit 904 that may be a charge pump/integrator. The building components (910) of the pixel circuit 900 include an emission device such as an OLED, a drive device such as a drive transistor, a storage device such as a capacitor and access switches such as a select switch. The building components 912 of the switch box 902 include a set of electronic switches that may be controlled by external control signals. The building components 914 of the readout circuit 904 include an amplifier, a capacitor and a reset switch.

The parameters of interest may be stored as represented by the box 920. The parameters of interest in this example may include the threshold voltage of the drive transistor, the mobility of the drive transistor and the turn-on voltage of the OLED. The functions of the switch box 902 are represented by the box 922. The functions include steering current in and out of the pixel circuit 900, providing a discharge path between the pixel circuit 900 and the charge-pump of the readout circuit 904 and isolating the charge-pump of the readout circuit 904 from the pixel circuit 900. The functions of the readout circuit 904 are represented by the box 924. One function includes transferring a charge from the internal capacitance of the pixel circuit 900 to the capacitor of the readout circuit 904 to generate a voltage proportional to that charge in the case of in-pixel integration as in steps 800-804 in FIG. 34. Another function includes integrating the current of the drive transistor or the OLED of the pixel circuit 900 over a certain time in order to generate a voltage proportional to the current as in steps 810-814 of FIG. 34.

FIG. 36 is a timing diagram of the signals involving the extraction of the threshold voltage and mobility of the drive transistor 520 in a modified version of the circuit of FIG. 31 in which the output transistor 534 has its gate connected to a separate control signal line RD rather than the SEL line. The readout process in FIG. 36 has a pre-charge phase 1001, an integrate phase 1002 and a read phase 1003. During the pre-charge phase 1001, the voltages V_{A} and V_{B} at the gate and source of the drive transistor 520 are reset to initial voltages by having both the SEL and RD signals high.

During the integrate phase 1002, the signal RD goes low, the gate voltage V_{A} remains at Vᵢₙᵢₜ, and the voltage V_{B} at the source (node 544) is charged back to a voltage which is a function of TFT characteristics (including mobility and threshold voltage), e.g., (Vᵢₙᵢₜ−V_{T}). If the integrate phase 1002 is long enough, the voltage V_{B} will be a function of threshold voltage (V_{T}) only.

During the read phase 1003, the signal SEL is low, V_{A} drops to (Vᵢₙᵢₜ+Vb−Vt) and V_{B} drops to Vb. The charge is transferred from the total capacitance C_{T} at node 544 to the integrated capacitor (Cᵢₙₜ) 552 in the readout circuit 504. The output voltage Vₒᵤₜ can be read using an Analog-to-Digital Convertor (ADC) at the output of the charge amplifier 550. Alternatively, a comparator can be used to compare the output voltage with a reference voltage while adjusting Vᵢₙᵢₜ until the two voltages become the same. The reference voltage may be created by sampling the line without any pixel connected to the line during one phase and sampling the pixel charge in another phase.

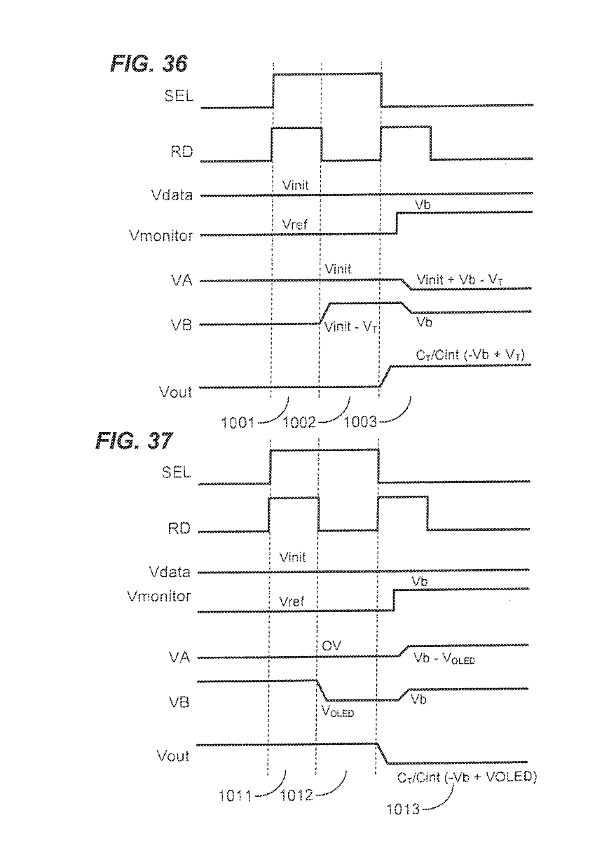

FIG. 37 is a timing diagram for the input signals for extraction of the turn-on voltage of the OLED 522 in the modified version of the circuit of FIG. 31.

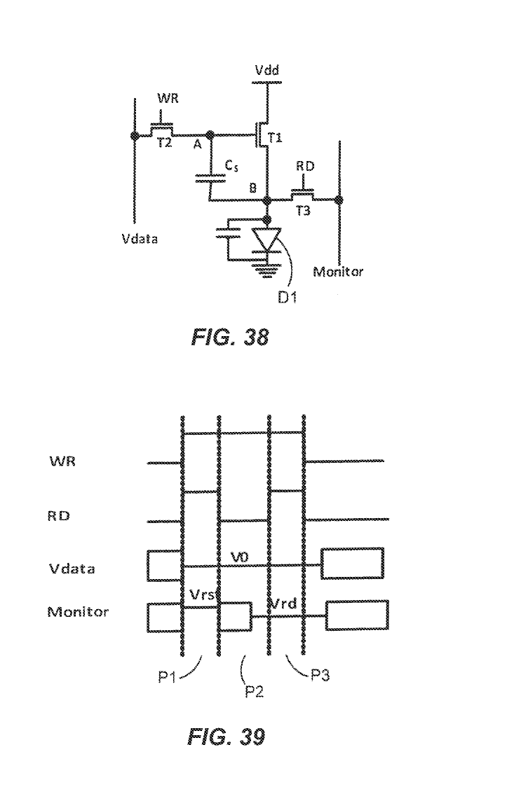

FIG. 38 is a circuit diagram of a pixel circuit for reading the pixel status by initializing the nodes externally. The drive transistor T1 has a drain connected to a supply voltage Vdd, a source connected to an OLED D1, and a gate connected to a Vdata line via a switching transistor T2. The gate of the transistor T2 is connected to a write line WR. A storage capacitor Cs is connected between a node A (between the gate of the drive transistor T1 and the transistor T2) and a node B (between the source of the drive transistor T1 and the OLED). A read transistor T3 couples the node B to a Monitor line and is controlled by the signal on a read line RD.

FIG. 39 is a timing diagram that illustrates an operation of the circuit of FIG. 38 that initializes the nodes externally. During a first phase P1, the drive transistor T1 is programmed with an OFF voltage V0, and the OLED voltage is set externally to Vrst via the Monitor line. During a second phase P2, the read signal RD turns off the transistor T3, and so the OLED voltage is discharged through the OLED D1 until the OLED turns off (creating the OLED on voltage threshold). During a third phase P3, the OFF voltage of the OLED is transferred to an external readout circuit (e.g., using a charge amplifier) via the Monitor line.

FIG. 40 is a flow chart illustrating the reading of the pixel status by initializing the nodes externally. In the first step, the internal nodes are reset so that at least one pixel component is ON. The second step provides time for the internal/external nodes to settle to a desired state, e.g., the OFF state. The third step reads the OFF state values of the internal nodes.

FIG. 41 is a timing diagram that illustrates a modified operation of the circuit of FIG. 38, still initializing the nodes internally. During a first phase P1, the drive transistor T1 is programmed with an ON voltage V1. Thus, the OLED voltage rises to a voltage higher than its ON voltage threshold. During a second phase P2, the drive transistor T1 is programmed with an OFF voltage V0, and so the OLED voltage is discharged through the OLED D1 until the OLED turns off (creating the OLED ON voltage threshold). During a third phase P3, the OLED ON voltage threshold is transferred to an external readout circuit (e.g., using a charge amplifier).

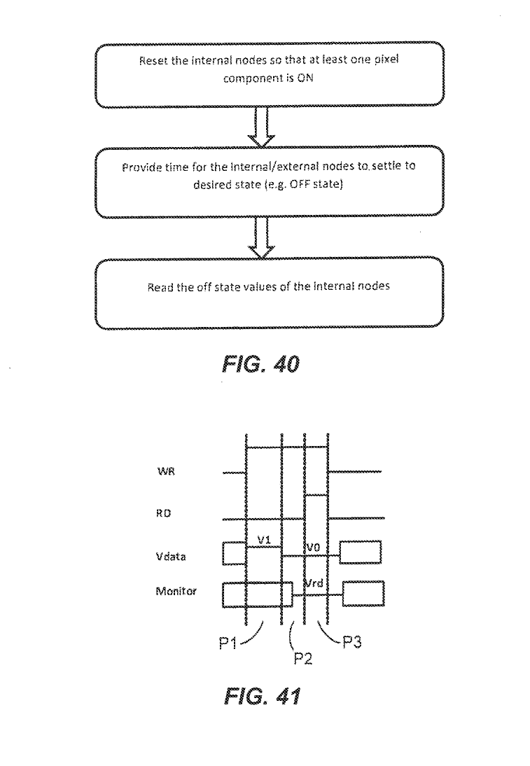

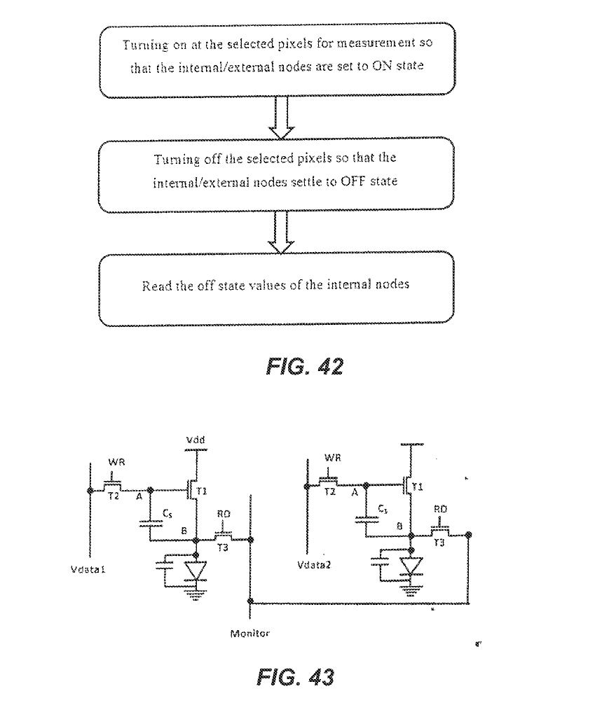

FIG. 42 is a flow chart illustrating the reading of the pixel status by initializing the nodes internally. The first step turns on the selected pixels for measurement so that the internal/external nodes settle to the ON state. The second step turns off the selected pixels so that the internal/external nodes settle to the OFF state. The third step reads the OFF state values of the internal nodes.

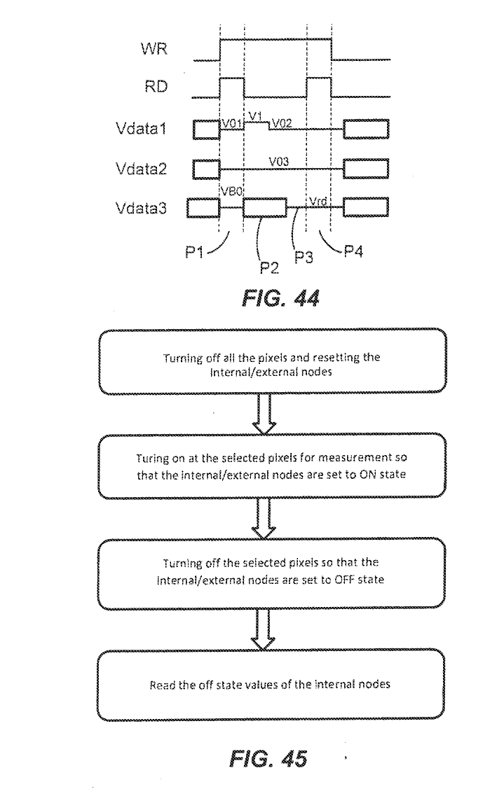

FIG. 43 is a circuit diagram illustrating two of the pixel circuits shown in FIG. 38 connected to a common Monitor line via the respective read transistors T3 of the two circuits, and FIG. 44 is a timing diagram illustrating the operation of the combined circuits for reading the pixel charges with the shared Monitor line. During a first phase P1, the pixels are programmed with OFF voltages V01 and V03, and the OLED voltage is reset to VB0. During a second phase P2, the read signal RD is OFF, and the pixel intended for measurement is programmed with an ON voltage V1 while the other pixel stays in an OFF state. Therefore, the OLED voltage of the pixel selected for measurement is higher than its ON threshold voltage, while the other pixel connected to the Monitor line stays in the reset state. During a third phase P3, the pixel programmed with an ON voltage is also turned off by being programmed with an OFF voltage V02. During this phase, the OLED voltage of the selected pixel discharges to its ON threshold voltage. During a fourth phase P4, the OLED voltage is read back.

FIG. 45 is a flow chart illustrating the reading of the pixel status with a shared Monitor line. The first step turns off all the pixels and resets the internal/external nodes. The second step turns on the selected pixels for measurement so that the internal/external nodes are set to an ON state. The third step turns off the selected pixels so that the internal/external nodes settle to an OFF state. The fourth step reads the OFF state values of the internal nodes.

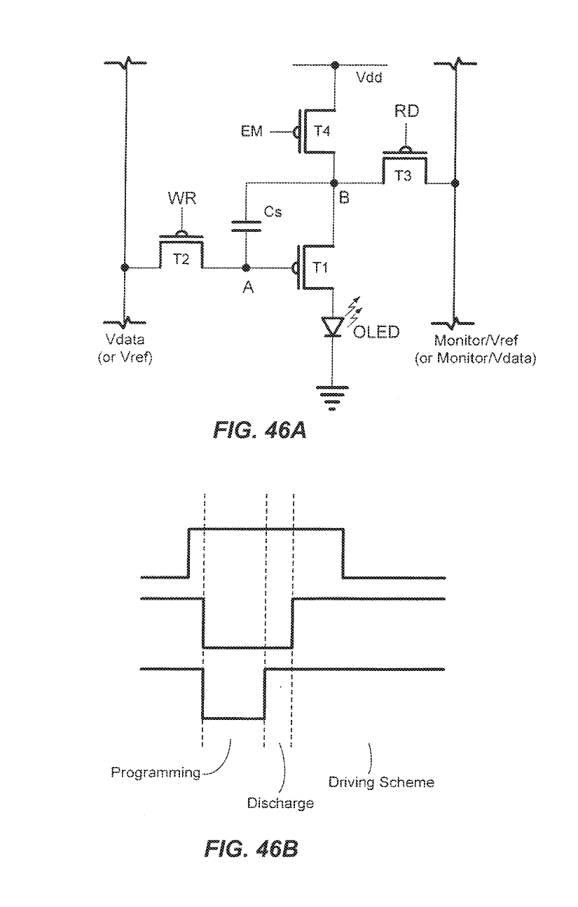

FIG. 46A illustrates a pixel circuit in which a line Vdata is coupled to a node A via a switching transistor T2, and a line Monitor/Vref is coupled to a node B via a readout transistor T3. Node A is connected to the gate of a drive transistor T1 and to one side of a storage capacitor Cs. FIG. 46B is a timing diagram for operation of the circuit of FIG. 46A using charge-based compensation. Node B is connected to the source of the drive transistor T1 and to the other side of the capacitor Cs, as well as the drain of a switching transistor T4 connected between the source of the drive transistor and a supply voltage source Vdd. The operation in this case is as follows:
1. During a programming cycle, the pixel is programmed with a programming voltage V_{P} supplied to node A from the line Vdata via the transistor T2, and node B is connected to a reference voltage Vref from line VMonitor/Vref via the transistor T3.
2. During a discharge cycle, a read signal RD turns off the transistor T3, and so the voltage at node B is adjusted to partially compensate for variation (or aging) of the drive transistor T1.
3. During a driving phase, a write signal WR turns off the transistor T2, and after a delay (that can be zero), a signal EM turns on the transistor T4 to connect the supply voltage Vdd to the drive transistor T1. Thus, the current of the drive transistor T1 is controlled by the voltage stored in a capacitor C_{S}, and the same current goes to the OLED.

In another configuration, a reference voltage Vref is supplied to node A from the line Vdata via the switching transistor T2, and node B is supplied with a programming voltage V_{P} from the Monitor/Vdata line via the read transistor T3. The operation in this case is as follows:
1. During the programming cycle, the node A is charged to the reference voltage Vref supplied from the line Vdata via the transistor T2, and node B is supplied with a programming voltage V_{P} from the line monitor/Vref via the transistor T3.
2. During the discharge cycle, the read signal RD turns off the transistor T3, and so the voltage at node B is adjusted to partially compensate for variation (or aging) of the drive transistor T1.
3. During the drive phase, the write signal WR turns off the transistor T2, and after a delay (that can be zero), the signal EM turns on the transistor T4 to connect the supply voltage Vdd to the drive transistor T1. Thus, the current of the drive transistor T1 is controlled by the voltage stored in the storage capacitor C_{S}, and the same current goes to the OLED.

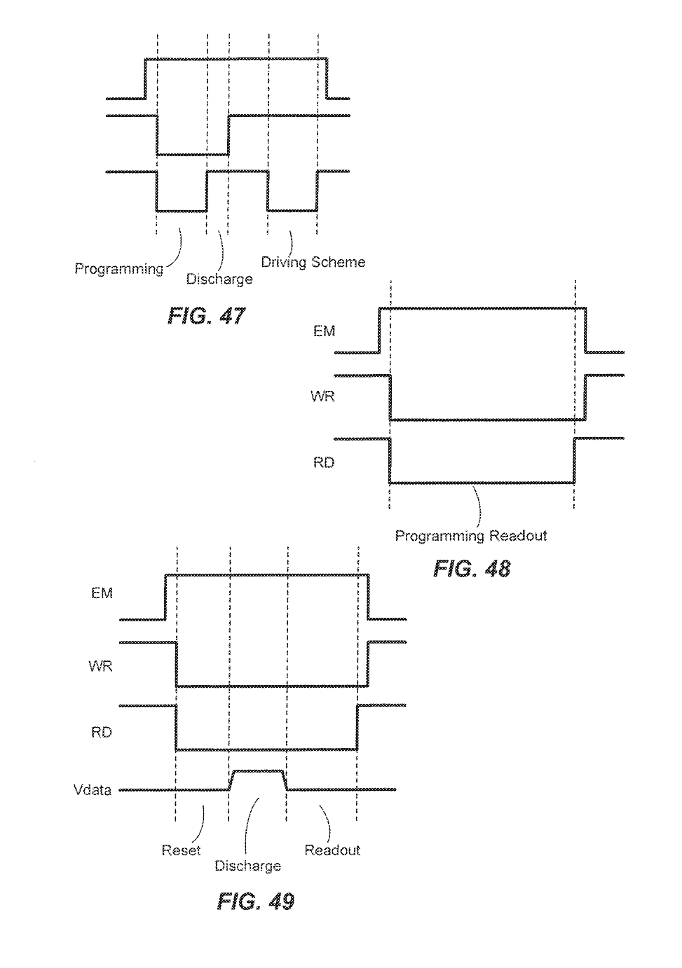

FIG. 47 is a timing diagram for operation of the circuit of FIG. 46A to produce a readout of the current and/or the voltage of the drive transistor T1. The pixel is programmed either with or without a discharge period. If there is a discharge period, it can be a short time to partially discharge the capacitor C_{S}, or it can be long enough to discharge the capacitor C_{S} until the drive transistor T1 is off. In the case of a short discharge time, the current of the drive transistor T1 can be read by applying a fixed voltage during the readout time, or the voltage created by the drive transistor T1 acting as an amplifier can be read by applying a fixed current from the line Monitor/Vref through the read transistor T3. In the case of a long discharge time, the voltage created at the node B as a result of discharge can be read back. This voltage is representative of the threshold voltage of the drive transistor T1.

FIG. 48 is a timing diagram for operation of the circuit of FIG. 46A to produce a readout of the OLED voltage. In the case depicted in FIG. 48, the pixel circuit is programmed so that the drive transistor T1 acts as a switch (with a high ON voltage), and the current or voltage of the OLED is measured through the transistors T1 and T3. In another case, several current/voltage points are measured by changing the voltage at node A and node B, and from the equation between the currents and voltages, the voltage of the OLED can be extracted. For example, the OLED voltage affects the current of the drive transistor T1 more if that transistor is operating in the linear regime; thus, by having current points in the linear and saturation operation regimes of the drive transistor T1, one can extract the OLED voltage from the voltage-current relationship of the transistor T1.

If two or more pixels share the same monitor lines, the pixels that are not selected for OLED measurement are turned OFF by applying an OFF voltage to their drive transistors T1.

FIG. 49 is a timing diagram for a modified operation of the circuit of FIG. 46A to produce a readout of the OLED voltage, as follows:
1. The OLED is charged with an ON voltage during a reset phase.
2. The signal Vdata turns off the drive transistor T1 during a discharge phase, and so the OLED voltage is discharged through the OLED to an OFF voltage.
3. The OFF voltage of the OLED is read back through the drive transistor T1 and the read transistor T3 during a readout phase.

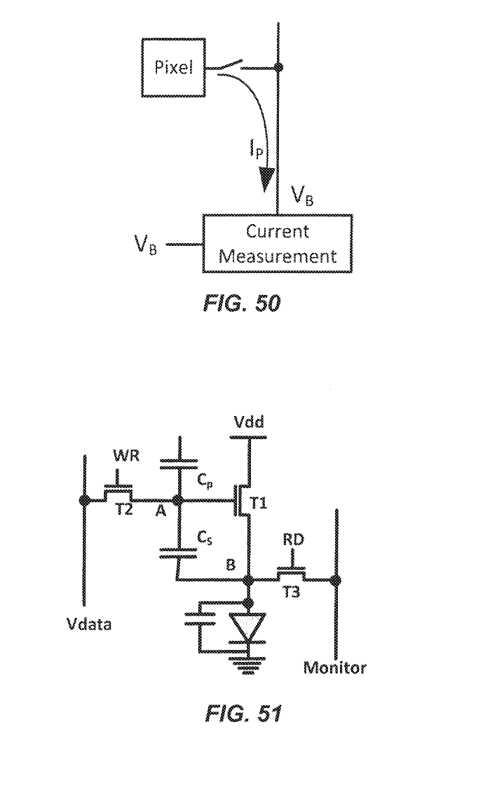

FIG. 50 illustrates a circuit for extracting the parasitic capacitance from a pixel circuit using external compensation. In most external compensation systems for OLED displays, the internal nodes of the pixels are different during the measurement and driving cycles. Therefore, the effect of parasitic capacitance will not be extracted properly.

The following is a procedure for compensating for a parasitic parameter:
1. Measure the pixel in state one with a set of voltages/currents (either external voltages/currents or internal voltages/currents).
2. Measure the pixel in state two with a different set of voltages/currents (either external voltages/currents or internal voltages/currents).
3. Based on a pixel model that includes the parasitic parameters, extract the parasitic parameters from the previous two measurements (if more measurements are needed for the model, repeat step 2 for different sets of voltages/currents).

Another technique is to extract the parasitic effect experimentally. For example, one can subtract the two set of measurements, and add the difference to other measurements by a gain. The gain can be extracted experimentally. For example, the scaled difference can be added to a measurement set done for a panel for a specific gray scale. The scaling factor can be adjusted experimentally until the image on the panel meets the specifications. This scaling factor can be used as a fixed parameter for all the other panels after that.

One method of external measurement of parasitic parameters is current readout. In this case, for extracting parasitic parameters, the external voltage set by a measurement circuit can be changed for two sets of measurements. FIG. 50 shows a pixel with a readout line for measuring the pixel current. The voltage of the readout line is controlled by a measurement unit bias voltage (V_{B}).

FIG. 51 illustrates a pixel circuit that can be used for current measurement. The pixel is programmed with a calibrated programming voltage V_{cal}, and a monitor line is set to a reference voltage V_{ref}. Then the current of a drive transistor T1 is measured by turning on a transistor T3 with a control signal RD. During the driving cycle, the voltage at node B is at V_{oled}, and the voltage at node A changes from V_{cal} to V_{cal}+(V_{oled}−V_{ref})C_{S}/(C_{P}+C_{S}), where V_{cal} is the calibrated programming voltage, C_{P} is the total parasitic capacitance at node A, and V_{ref} is the monitor voltage during programming. The gate-source voltage V_{GS} of the drive transistor is different during the programming cycle (V_{P}−V_{ref}) and the driving cycle [(V_{P}−V_{ref})C_{S}/(C_{P}+C_{S})−V_{oled}C_{P}/(C_{P}+C_{S})]. Therefore, the current during programming and measurement is different from the driving current due to parasitic capacitance which will affect the compensation, especially if there is significant mobility variation in the drive transistor T1.

To extract the parasitic effect during the measurement, one can have a different voltage V_{B} at the monitor line during measurement than it is during the programming cycle (V_{ref}). Thus, the gate-source voltage V_{GS} during measurement will be [(V_{P}−V_{ref})C_{S}/(C_{P}+C_{S})−V_{B}C_{P}/(C_{P}+C_{S})]. Two different V_{B}'s (V_{B1} and V_{B2}) can be used to extract the value of the parasitic capacitance C_{P}. In one case, the voltage V_{P} is the same and the current for the two cases will be different. One can use pixel current equations and extract the parasitic capacitance C_{P} from the difference in the two currents. In another case, one can adjust one of the V_{P}'s to get the same current as in the other case. In this condition, the difference will be (V_{B1}−V_{B2})C_{P}/(C_{P}+C_{S}). Thus, C_{P} can be extracted since all the parameters are known.

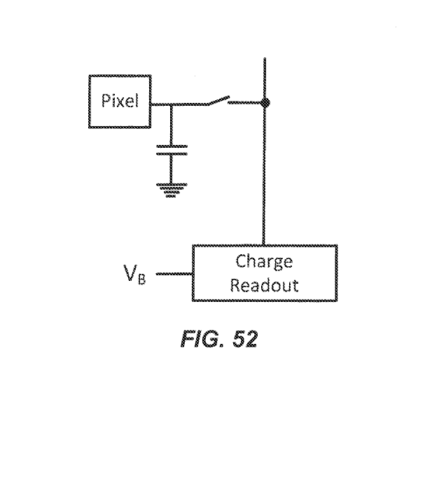

A pixel with charge readout capability is illustrated in FIG. 52. Here, either an internal capacitor is charged and then the charge is transferred to a charge integrator, or a current is integrated by a charge readout circuit. In the case of integrating the current, the method described above can be used to extract the parasitic capacitance.

When it is desired to read the charge integrated in an internal capacitor, two different integration times may be used to extract the parasitic capacitance, in addition to adjusting voltages directly. For example, in the pixel circuit shown in FIG. 51, the OLED capacitance can be used to integrate the pixel current internally, and then a charge-pump amplifier can be used to transfer it externally. To extract the parasitic parameters, the method described above can be used to change voltages. However, due to the nature of charge integration, one can use two different integration times when the current is integrated in the OLED capacitor.

As the voltage of node B increases, the effect of parasitic parameters on the pixel current becomes greater. Thus, the measurement with the longer integration time results in a larger voltage at node B, and thus is more affected by the parasitic parameters. The charge values and the pixel equations can be used to extract the parasitic parameters. Another method is to make sure the normalized measured charge with the integration time is the same for both cases by adjusting the programming voltage. The difference between the two voltages can then be used to extract the parasitic capacitances, as discussed above.

To eliminate the effect of the parasitic capacitance on the measurement, the measurement biasing is preferably very close to the driving condition. The process is as follows:
1) Measure or calculate the biasing voltages of the internal node during a driving cycle for a desired measurement level. For example, if the desired measurement value is 1 uA out of the drive TFT, the internal node voltages are calculated (measured or simulated) during the driving cycle where the drive TFT provides 1 uA.
2) Modify the voltages that are not affecting the measurement to eliminate the unwanted cross talk.
3) If needed, remove the unwanted signals that affecting the unwanted measurement signal by double sampling.

The above process can be repeated for any pixel circuits and any signals selected for measurement. For example, the above process can be performed to measure the drive TFT current on the pixel circuit depicted in FIG. 51 as follows:
1) Here, the biasing level of node A is defined by the data voltage, and the biasing condition of the node B is controlled by the OLED during the driving and by the monitor line during the measurement. So the OLED voltage is calculated or measured during the driving cycle for a given current. To calculate the OLED voltage, an OLED model can be used to extract the OLED voltage for a given current. To measure the OLED voltage, a known current is applied to each OLED, and the resulting voltage is measured, or reference samples can be used.
2) After the OLED voltage is obtained either by measurement or calculation, the monitor line can be set to that level during the measurement. In one method, one can raise the VSS to a higher voltage to assure the OLED is OFF during the measurement, so that the OLED will not turn ON and contaminate the TFT current.
3) In another method, the OLED current is measured while the TFT is off and then the contaminated TFT current is measured. The subtraction of the two can result in TFT current.

It has been observed that straight extraction of pixel I-V parameters (Vₜₕ, μ, and α) from the measurement points does not fully compensate areas of the display where there are huge variations. Thus, there is a need for a systematic method for full compensation of non-uniformity and aging caused by backplane variations across an AMOLED display.

The following is one example of the pixel circuits and measurement conditions used with such a systematic method. This work can be applied to different pixel circuits and different measurement conditions and points.

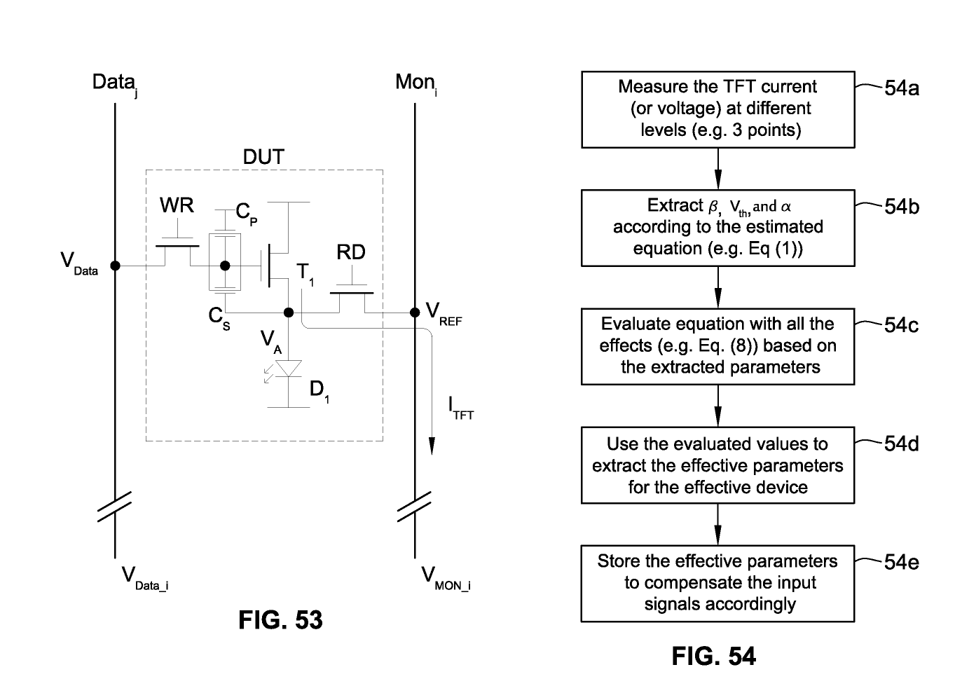

FIG. 53 illustrates an n-type 3T1C pixel circuit of an AMOLED display. The pixel circuit includes a drive TFT (τ₁), two switch TFT's (WR and RD), an OLED device (D₁), and a storage capacitor (C_{S}). C_{P} is the total lumped parasitic capacitance at the gate terminal of the drive TFT (τ₁).

During the programming phase, the WR and RD switches are turned on to precharge the store capacitor C_{S} to (V_{Data}−V_{REF}). At the end of the program phase, RD and WR are turned off in an appropriate sequence (e.g. IPC timing) to achieve a desired level of drive voltage across the storage capacitor.

Once the WR switch is turned off, the total charge (Q) captured on the top plate of C_{S} and C_{P} is conserved.

The pixel current is measured following a program phase. During a measurement, WR is turned off and RD is kept on. The voltage on the monitor line is forced to a reference voltage (V_{REF}) and the current that flows into the monitor line is measured by an external readout circuitry.

Here, to explain the process a typical IV characteristic is used. However, the invention works with other devices with different IV characteristic. One need to repeat the calculation based on the different IV characteristic. To the first order, the monitor current is modeled by

I_{Mon}=β(V_{GS}−Vₜₕ)^{α}

V_{GS}≈V_{Data}−V_{REF}−δ

where δ is to account for the effect of charge injection and clock-feed-through when RD and WR TFT's are switched off (assuming negligible signal dependent charge injection).

In the drive mode (emission), where WR and RD are switched off, the voltage across CS forces T1 to source a current into the OLED device. Accordingly, the voltage at the source terminal of T1 (VA) is determined by the anode voltage of the OLED device. In other words, the voltage at the bottom plate of CS shifts from VREF (during the program or measurement phase) to V_{A}=V_{OLED}+V_{SS} (during the drive mode).

However, due to the presence of parasitic capacitance (CP) at the gate terminal of T1 (top plate of CP), the conserved charge Q will be redistributed between CS and CP. Therefore, the new gate voltage of T1 is derived as:

$${\hat{V}}_{G} = {V}_{Data} - δ + \frac{{C}_{S}}{{C}_{P} + {C}_{S}} \cdot ( {V}_{OLED} + {V}_{SS} - {V}_{REF} )$$

The source drive voltage of the drive TFT T₁ during emission is given by:

$${\hat{V}}_{GS} = {V}_{Data} - δ - \frac{{C}_{S}}{{C}_{P} + {C}_{S}} {V}_{REF} - \frac{{C}_{P}}{{C}_{P} + {C}_{S}} ( {V}_{OLED} + {V}_{SS} )$$

This calculation can be carried out for different pixel structures and different programming, driving, and measurement conditions (current, charge, or voltage).

To explain the process a typical I-V characteristic is used. However, it will be understood that the process can also be used with other devices with different I-V characteristics. There is no need to repeat the calculation based on the different I-V characteristics. The OLED current, driven by the drive TFT, is expressed as:

I_{OLED}=β(\hat{V}_{GS}−Vₜₕ)^{α}

The OLED I-V behavior can be characterized by:

I_{OLED}=Iₒ(V_{OLED}−Vₒ)^{α}^{ₒ}

and the OLED voltage is extracted as:

$${V}_{OLED} = {V}_{o} + {( \frac{{I}_{OLED}}{{I}_{o}} )}^{\frac{1}{{a}_{o}}}$$

Using equations (7) and (4) in equation (5) results in:

$${I}_{OLED} = {β ( {V}_{Data} - δ - \frac{{C}_{S}}{{C}_{P} + {C}_{S}} {V}_{REF} - \frac{{C}_{P}}{{C}_{P} + {C}_{S}} [ {V}_{o} + {( \frac{{I}_{OLED}}{{I}_{o}} )}^{\frac{1}{{a}_{o}}} + {V}_{SS} ] - {V}_{th} )}^{a}$$

To simplify the equation, a new effective device (e.g., effective drive TFT) is defined that follows a defined function such as the following that includes the effective parameters:

I_{OLED}=\hat{β}(V_{Data}−\hat{V}ₜₕ)^{\hat{α}}

The effective I-V characteristic function can be extracted based on experimental data or modeling.

An I-V characteristic that is based on a model that includes all the secondary effects (e.g., parasitic component) can be used to extract the effective parameters of the effective device.

A modeling procedure is illustrated in FIG. 54. The first step 54a measures the TFT current (or voltage) at different levels (e.g., 3 points). Then step 54b extracts β, Vₜₕ and a according to the estimated equation (e.g., Equation (1). All the effects are evaluated (e.g., using Equation (8)) at step 54c, based on the extracted parameters. The evaluated values are used to extract the effective parameters for the effective device at step 54d, and the effective parameters are stored at step 54e for use in compensating the input signals accordingly.

One example is the following:

OLED and pixel parameters

| Parameter | Value | |
|---|---|---|
| aₒ (OLED) | 3.173 | |
| Iₒ (OLED) | 1031.5 | nA |
| Vₒ (OLED) | 2.8206 | V |
| C_{P} | 75 | fF |
| C_{S} | 482 | fF |
| V_{REF} | 3.0 | V |
| Vₜₕ | 0.0 | V |
| V_{SS} | 1.5 | V |

Simulated Monitor and OLED currents

| VdataB (V) | I_mon (nA) | I_oled (nA) |
|---|---|---|
| 3.7 | 8.65 | 5.41 |
| 4.2 | 28.56 | 20.13 |
| 4.7 | 68.83 | 51.76 |
| 5.2 | 133.72 | 105.25 |
| 5.7 | 227.55 | 185.29 |
| 6.2 | 350.81 | 293.01 |
| 6.7 | 505.94 | 431.20 |
| 7.2 | 692.20 | 599.81 |
| 7.7 | 907.03 | 796.75 |
| 8.2 | 1154.56 | 1026.22 |
| 8.7 | 1431.20 | 1285.16 |
| 9.2 | 1732.75 | 1569.82 |
| 9.7 | 2066.43 | 1887.05 |

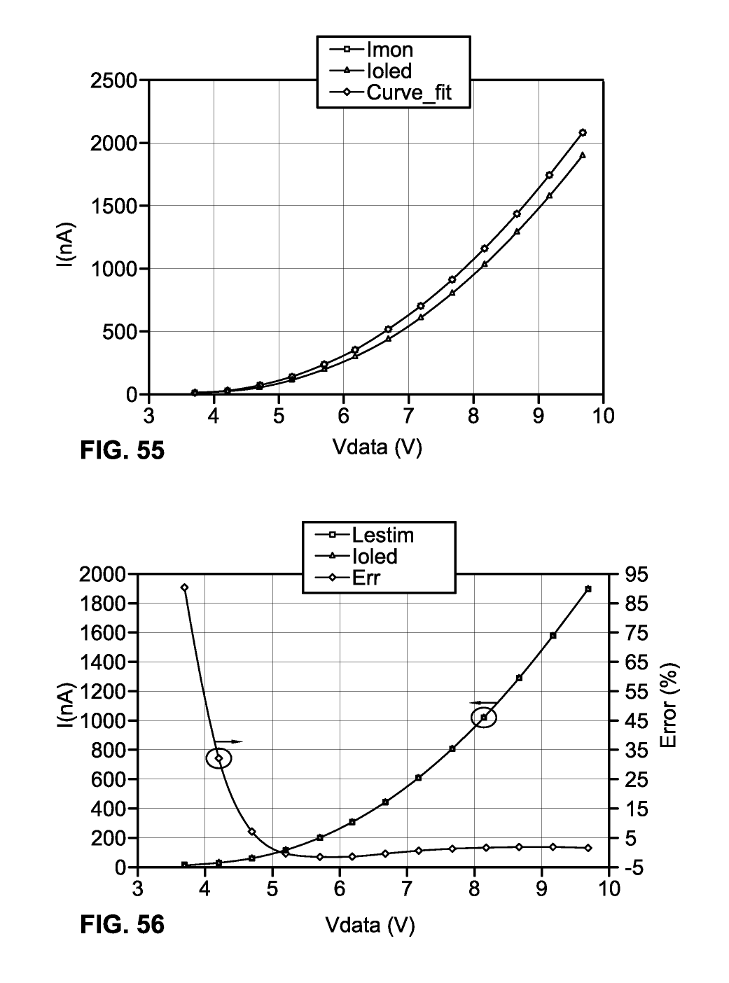

FIG. 55 is a pair of curves of Iₘₒₙ and I_{oled} along with a curve fitted for Iₘₒₙ. The curve fitting parameters for Iₘₒₙ, are as follows:

Curve fitting parameters for Iₘₒₙ

| Parameter | Value |
|---|---|
| α (Imon) | 2.16 |
| β (Imon) | 39.3817 nA |
| Vₜₕ (Imon) | 3.4311 V |

The following is an example of simulation results:

Simulated and estimated OLED current

| VdataB (V) | I_oled (nA) | I_estimate (nA) | Error (%) |
|---|---|---|---|
| 3.7 | 5.41 | 0.5355 | 90.10 |
| 4.2 | 20.13 | 13.7636 | 31.61 |
| 4.7 | 51.76 | 48.1874 | 6.90 |
| 5.2 | 105.25 | 106.2721 | −0.97 |
| 5.7 | 185.29 | 189.6274 | −2.34 |
| 6.2 | 293.01 | 299.4778 | −2.21 |
| 6.7 | 431.20 | 436.8205 | −1.30 |
| 7.2 | 599.81 | 602.5021 | −0.45 |
| 7.7 | 796.75 | 797.2605 | −0.06 |
| 8.2 | 1026.22 | 1021.7515 | 0.44 |
| 8.7 | 1285.16 | 1276.5667 | 0.67 |
| 9.2 | 1569.82 | 1562.2455 | 0.48 |
| 9.7 | 1887.05 | 1879.2843 | 0.41 |

FIG. 56 is a pair of curves representing the simulated and estimated OLED current.

While particular embodiments and applications of the present invention have been illustrated and described, it is to be understood that the invention is not limited to the precise construction and compositions disclosed herein and that various modifications, changes, and variations can be apparent from the foregoing descriptions without departing from the spirit and scope of the invention as defined in the appended claims.

What is claimed is:

1. A method of extracting effective parameters from a pixel circuit that includes a light emitting device, a drive device to provide a programmable drive current to the light emitting device, a programming input, and a storage device to store a programming signal, the method comprising:
measuring the value of at least one operating parameter of the pixel circuit at a plurality of levels,
extracting the value of at least one related parameter of the pixel circuit, based on the measured values of the at least one operating parameter,
translating the measured values of said operating parameter to effective values for driving the pixel circuit, based on the extracted value,
extracting effective parameters for driving effective devices in the pixel circuit, based on the translated values, and
storing the extracted effective parameters for use in compensating input signals to the pixel circuit.

2. The method of claim 1 in which said operating parameter is a current or voltage of the drive device.

3. The method of claim 1 in which said extracted value is a value for a parameter of the drive device.

4. The method of claim 1 in which the translated effective value is the voltage to be applied to the light emitting device.

5. The method of claim 1 in which the extracted effective parameter is the current to be supplied to the light emitting device.
